(19) United States
(12) Patent Application Publication
(10) Pub. No.: US 2018/0043656 A1
(43) Pub. Date: Feb. 15, 2018

(54) Oriented Multilayer Porous Film

(71) Applicants: Kwangjin Song, Charlotte, NC (US); Jennifer M. Song, Nashville, TN (US); Jane M. Song, Washington, DC (US)

(72) Inventors: Kwangjin Song, Charlotte, NC (US); Jennifer M. Song, Nashville, TN (US); Jane M. Song, Washington, DC (US)

(73) Assignee: Liso Plastics, L.L.C., Charlotte, NC (US)

(21) Appl. No.: 15/707,151

(22) Filed: Sep. 18, 2017

(51) Int. Cl. B32B 5/18; C08J 5/18; C08J 9/26; H01M 2/16; H01G 11/52; H01M 8/0245; B32B 27/08; B32B 27/20; H01G 9/02; C08J 9/28; H01M 8/0239

(52) U.S. Cl. CPC B32B 5/18; C08J 9/28; C08J 5/18; C08J 9/26; H01M 2/1653; H01M 2/1686; H01M 8/0239; H01M 8/0245; B32B 27/08; B32B 27/20; H01G 9/02; H01G 11/52; C08J 2300/00; C08J 2400/00; C08J 2201/0464; C08J 2203/08; C08J 2201/044; C08J 2201/0442; C08J 2201/0444; C08J 2203/182; C08J 2201/0422; C08J 2201/03

(57) ABSTRACT

Provided is an oriented multilayer porous film comprising at least one layer comprising: a heat, solvent, and degradation resistant matrix polymer; a plurality of interconnecting pores; and a porosity less than 90%. The film is made by a dry and/or wet method, with its multilayer structure constructed by coextrusion, lamination, and coating. The film of this disclosure finds a wide range of applications as a permselective medium for use in energy harvesting and storage, filtration, separation and purification of gases and fluids, CO₂ and volatile capture, electronics, devices, structural supports, packaging, labeling, printing, clothing, drug delivery systems, bioreactor, and the like. The film is preferably used as a separator of lithium-ion, lithium-sulfur, lithium-air, metal-air, and nonaqueous electrolyte batteries.

### FIELD OF THE INVENTION

This invention pertains to an oriented multilayer porous film made from a broad range of heat, solvent and degradation resistant matrix polymers, compositions and structures, and to an article or device comprising the porous film of this disclosure.

### BACKGROUND OF THE INVENTION

A porous polymeric film finds a wide range of applications as a permselective medium for use in energy harvesting and storage, filtration, separation and purification of gases and fluids, CO₂ and volatile capture, electronics, devices, structural supports, packaging, labeling, printing, clothing, drug delivery systems, bioreactor, and the like. Such film can be manufactured by various different techniques. A porous film can be isotropic or anisotropic, depending on layer arrangement, conditions and processes of manufacture. The isotropic film generally is uniform throughout in composition and structure. The anisotropic film, on the other hand, is asymmetric that consists often of a layered structure, e.g., a preformed film coated or laminated with a functional layer. In particular, the porous polymeric film has found widespread utility as a separator of primary and secondary batteries, lithium-ion batteries (LIB), capacitors, supercapacitors, energy storage devices, and the like. Of which, the LIB s are of special interest, since they are compact and yet deliver a high energy and power density; and thus, most widely used as power sources for a variety of devices, such as electronics, vehicles, transportation, power tools, grid storage systems, etc.

Typically, a porous separator film used for Li-ion batteries (LIBs) is manufactured by a dry or wet method. The dry method extrudes polymer melts via a flat-film die to produce a nonporous sheet, which is then stretched to result in a porous film. The dry process is advantageous in that no solvents are used. The wet method, on the other hand, extrudes a homogeneous or finely dispersed blend of polymer melts and extractables. The extrudate upon existing a flat-film die cools into a multiphase sheet; it is then stretched and extracted to create an open pore structure into the film. A typical wet porous film thus consists often of a monolayer, largely isotropic in structure and properties. The voiding mechanisms, as indicated, of these processes generally involve phase separation, extraction, failure at interfaces, and cavitation. See, e.g., van de Witte et al., J. Memb. Sci., 1996, 117, pp 1-31; Zhang, J. Power Sources, 2007, 164, pp 351-364; and Saffar et al. Ind. Eng. Chem. Res., 2014, 53 (36), pp 14014-14021. In the current state of the art, however, the dry and wet methods are limited primarily to production of polyolefin (PO)-based porous separator films. This is due mainly to failure of the methods in creating a properly high level of open pores into non-PO based polymeric films.

A separator is located between positive and negative electrodes in an electrochemical cell, to simultaneously provide electrical insulation and ion transport therebetween. The cell houses the separator to be immersed at least partially in electrolyte, while the electrodes each being attached to a negative and positive current collector. Although the cell components vary in shape and size over a wide range, the separator still plays a crucial role on performance and safety of the device. As aforesaid, the PO separator currently is predominantly used for LIBs; because it is not only readily available, but flexible and low cost over inorganic or nonwoven separators. The PO separator also provides other advantages, such as a low shutdown temperature and an excellent resistance to electrolyte and moisture. The trade-offs are, however, a poor resistance to heat, creep and degradation; and a nonwettability to electrolytes under the cell condition. The PO separator is thus susceptible to formation and penetration of Li dendrites, and requires further treatments. In addition, the PO resin can hardly be coextruded or laminated with a high melting temperature (Tm) polymer; due not only to poor properties of the resulting film but also to various processing issues, e.g., such as gels, buildup, thermal decomposition, film split, low recyclability, etc.

As demands for high capacity devices continue to grow recently, safety of the cell has become imperative. Common failures of separators and electrolytes represent notable hazards, such as short circuits, ignition, explosion, etc. Li-based cells start to melt at 181° C. and to thermally run away at 200° C. At abuse conditions, this low transition is further suppressed by the PO separator. See, e.g., C. Orendorff et al., “Advanced Inactive Materials for Improved Lithium-Ion Battery Safety”, SAND2012-9186, Sandia National Lab., 2012; and X. Zhang et al., Li-ion Battery Separators, Nature Scientific Reports 6:32578, 2016. The LIB separator film may thus require far enhanced safety performance, i.e., a high resistance to heat, creep and degradation under the harsh cell condition, along with a suitable level of transport properties. First and foremost, the separator film may have a Tm at least greater than 180° C., while retaining preferably a low shutdown temperature. The film should also provide a pore structure required by electrochemical cells, i.e., a proper level of pore size, volume, uniformity, interconnectivity, and tortuosity. The pore structure that controls critically an ionic conductivity, on the other hand, is determined in complex ways by several important parameters, such as film composition, layer structure, and conditions and processes of manufacture.

U.S. Pat. Nos. 3,738,904, 3,870,593, 3,844,865, 4,265,960, 5,008,296, and 9,676,131 disclose a porous PO film filled with inorganic particles. U.S. Pat. Nos. 4,377,616, 4,632,689; 8,557,919, and WO 2010/059448 disclose a porous polypropylene (PP) film made of immiscible blends, consisting largely of a closed pore structure. U.S. Pat. Nos. 3,426,754, 3,558,764, 3,679,538, 3,801,404, 3,839,240, 4,138,459, 5,565,281, and 5,691,077 disclose a porous PO film, made by laminating and annealing a precursor film followed by cold and hot uniaxial stretching. The high density polyethylene (HDPE)/PP laminate disclosed therein was claimed for low shutdown and high meltdown. U.S. Pat. Nos. 4,386,129, 4,975,469, 5,134,174, and 7,713,636 disclose a porous PP film containing a β-crystal nucleating agent (β-NA). All these prior art PO films were produced by the dry method.

The wet method, on the other hand, for making a polyethylene (PE) separator film was taught in many early patents including, e.g., U.S. Pat. Nos. 3,351,495, 4,247,498, 4,519,909, 4,539,256, 4,833,172, 4,867,881, and 5,051,183. The disclosed method generally included: extruding the PE/diluent mixture, casting and biaxially stretching a wet sheet; and then extracting the diluent from the stretched film. Again, the PE separator disclosed was low in crystalline melting temperature (Tm) below 135° C. A large body of subsequent arts were thus teaching a technique for improving the rupture temperature of PE separators. See, e.g., U.S. Pat. Nos. 7,618,743, 8,048,936, 8,262,973, 8,563,120, 8,920,913, 9,147,868, and 9,431,642. However, the methods disclosed were all limited to PE and PP, i.e., blending, laminating, or coextruding PE with PP. Therefore, the improvement at most was bound to the PP Tm of 165° C., which is far insufficient.

A PO separator film that was filled, coated or laminated with heat resistant inorganic particles was also disclosed as an alternative, e.g., in U.S. Pat. Nos. 2012/0145468, 6,432,586, 7,790,320, 8,512,610, 7,575,832, 8,470,468, 8,580,419, 8,795,826, 8,932,746, 9,029,002, 9,070,935, 9,312,527, and 9,496,535. Although the disclosed separators improved to some extents the meltdown temperature, they suffered yet from similar and/or additional drawbacks, i.e., brittle and low in Tm, confined essentially to properties of the PE matrix. Furthermore, the coatings were unusually thick in gage, weak at interfaces, and high cost due to additional processes. The tradeoffs may further include: pore clogging, film curling, particle falloff, delamination, crosslinking, etc. The coating process thus often employs a thin and highly porous film as a substrate, but at the cost of uniformity and strength which promotes adversely the formation and growth of Li dendrites. Alternatively, a ceramic-coated nonwoven separator was disclosed, e.g., in U.S. Pat. Nos. 7,575,832, 7,709,140, and 8,597,819. Yet the coatings on both sides of the web were substantially thick, brittle, and costly.

More recently, a large number of prior arts disclose a heat resistant separator of nonwoven fibers or solution castings made from aromatic polyamides (PA) and polyimides (PI). See, e.g., U.S. Pat. Nos. 7,112,389, 7,407,702, 7,866,487, 8,697,587, 8,852,808, 2015/0,325,831, 8,815,432, 8,815,384, 8,936,878, 9,142,815, 9,209,444, 9,293,749, 9,394,638, 9,419,265, 9,461,290, 9,577,235, and 2016/0,111,698. In general, a nonwoven web decreases a pore size with decreasing fiber diameter. Accordingly, the disclosed separators required nanofibers or extreme manufacture conditions that resulted in poor productivity. The separators as claimed may retain a superior heat resistance; however, they instead lack substantially stress-induced chain hardening or orientation. When used in an electrochemical cell, these unoriented separators were thus easily subject to dissolution and degradation, requiring further treatment or stabilized molecular structures. In addition, the nonwovens and castings generally are poor in such properties as strength, uniformity, surface topography, etc.; thus, prone yet to performance issues, short circuits and/or high cost despite the highly heat and solvent resistant matrix polymers.

### SUMMARY OF THE INVENTION

It is therefore an object of the present invention to provide a porous film having excellent ionic conductivity and electrical insulation for use as a separator of Li-ion, Li-sulfur, Li-air, metal-air and nonaqueous electrolyte batteries, alkaline batteries, capacitors, supercapacitors, fuel cells, energy storage devices, and the like. The film is biaxially stretched to significantly enhance stress-induced hardening and orientation, while at the same time thinning the gage to minimize materials consumption.

It is another object of the present invention to provide a porous film having a superior resistance to heat, solvents, puncture and degradation under an electrochemical condition, while simultaneously providing high performance in strength, uniformity, wettability, barrier, productivity, and convertibility. The film is to effectively prevent formation, growth and penetration of Li or metal dendrites causing often the failure of the electrochemical cell. It is yet another object of the present invention to provide a porous film having multiple transitions, capable of serving simultaneously as a low shutdown and high meltdown temperature.

It is yet another object of the present invention to provide a porous film made out of biopolymers having properties and cost, comparable to or better than corresponding petroleum-based polymers.

It is yet another object of the present invention to provide an electrochemical cell for use in energy storage devices, which comprises therein the porous film of this disclosure. The cell of this disclosure is to provide the hosting devices with high power and energy densities, rate capability, safety, reliability, and a long life cycle.

It is yet another object of the present invention is to provide a facile single-step method of manufacturing a porous film of a wide range of non-PO based high Tm or high glass transition temperature (Tg) polymers, compositions and structures, which are otherwise very difficult or impossible to produce commercially useful porous or separator film products.

Embodiments of the invention include:

(1) An oriented multilayer porous film comprising at least one layer comprising a first polymer, a plurality of interconnecting pores, and a porosity less than 90%; wherein each layer of the oriented multilayer porous film comprises 5 to 100 wt. % of a matrix polymer comprising: a) the first polymer or b) a second polymer having a crystalline melting temperature (Tm) or a glass transition temperature (Tg) less than 180° C.; the matrix polymer being selected from the group consisting of a petroleum-based polymer, a biopolymer and combinations thereof; and wherein the first polymer comprises a heat resistant polymer having a Tm or Tg greater than 180° C. or a polypropylene (β-PP) comprising a β-crystal nucleating agent (β-NA).

(2) The film of above (1), wherein the matrix polymer has a molecular weight characterized by a weight average molecular weight (Mw) of 5,000 to 50,000,000 g/mole and a unimodal or multimodal molecular weight distribution.

(3) The film of above (1) or (2), wherein the first polymer and/or the second polymer are the biopolymer.

(4) The film of any of above (1) to (3), wherein at least one of the outer surfaces of the film has an average pore size characterized by a size ratio of 0.001 to 1,000 relative to an average pore size of an inner layer of the film.

(5) The film of any of above (1) to (4), wherein one or more layers of the film are uniaxially or biaxially oriented.

(6) The film of any of above (1) to (5), wherein the each layer of the film further comprises a porogent material of 0 to 95 wt. %, a compatibilizer of 0 to 95 wt. %, and an additive of 0 to 20 wt. %; wherein: a) the porogent material is a sorbent material, a solid-state ionically conductive material, a polymer immiscible with the matrix polymer, a nucleating agent (NA), a diluent material, or combinations thereof; b) the compatibilizer is functional polymers, functionalized polymers, copolymers, particulate materials, or combinations thereof; and c) the additive is antioxidants, stabilizers, flame retardants, surfactants, viscosity modifiers, dispersing agents, solubility promoters, heat or current conductors, catalysts, crosslinking agents, anti-fouling agents, moisture barriers, pigments, or combinations thereof.

(7) The film of above (6), wherein the porogent material and the compatibilizer are solid particles, the solid particles having an average particle size of 1 nm to 1 μm, an average aspect ratio of length to thickness of 0.01 to 2,000, an average pore volume less than 6.0 cc/g, a Brunauer-Emmett-Teller surface area of 0.1 to 5,000 m²/g, or combinations thereof.

(8) The film of any of above (1) to (7), wherein one or more layers of the film comprise the porogent material other than the immiscible polymer.

(9) The film of any of above (1) to (8), wherein one or more layers of the film comprise the immiscible polymer as the porogent material.

(10) The film of any of above (1) to (9), wherein the immiscible polymer is selected in combination with the matrix polymer and the compatibilizer.

(11) The film of any of above (1) to (10), consisting essentially of one layer, two layers, three layers, four layers, or five layers.

(12) The film of any of above (1) to (11), having: a thickness of 3 to 30 μm, a porosity of 20 to 90%, an average pore size of 1 nm to 1 μm, a Gurley air permeability of 10 to 1,000 sec/100 cc at a film thickness of 25 μm, a MacMullin number of 1 to 15, a meltdown temperature greater than 180° C., a shutdown temperature less than 180° C., a tensile strength greater than 50 MPa in the machine direction (MD) and/or the transverse direction (TD), a puncture strength greater than 200 gf at a film thickness of 20 μm, or combinations thereof.

(13) The film of any of above (1) to (12), wherein the film is: a) a monolayer film consisting of the at least one layer (A), b) a two-layer film having a second layer (B) and a layer structure of B/A, c) a three-layer film having a symmetric layer structure of B/A/B or A/B/A, d) a four-layer film having a third layer (C) and a symmetric layer structure of B/A/C/B or A/B/C/A, or e) a five-layer film having a symmetric layer structure of B/C/A/C/B or A/C/B/C/A; wherein the A and B layers differ from each other in matrix polymer or composition.

(14) The film of any of above (1) to (13), wherein the film is the monolayer film comprising the matrix polymer selected from the group consisting of polyester, polyketone (PK), polyaryletherketone (PAEK), polyimide (PI)-type polymers, fluoropolymers, polyarylene sulfide (PAS), polyarylsulfone, vinyl polymers, cellulose esters, polyamide (PA), the β-PP, ionomers thereof, copolymers thereof, derivatives thereof, and combinations thereof.

(15) The film of above (13), wherein: a) the matrix polymer of the A layer is polyester; and b) the matrix polymer of the B layer is PK, PAEK, PI-type polymers, fluoropolymers, PAS, PA, PO, derivatives thereof, or copolymers thereof.

(16) The film of above (13), wherein the matrix polymers of the A and B layers are polyester.

(17) The film of any of above (1) or (16), wherein the polyester has a molecular weight characterized by an intrinsic viscosity (IV) of 0.1 to 5 dl/g and a unimodal or multimodal molecular weight distribution.

(18) The film of above (13), wherein: a) the matrix polymer of the A layer is PK; and b) the matrix polymer of the B layer is PAEK, PI-type polymers, PA, PO, or copolymers thereof.

(19) The film of above (13), wherein: a) the matrix polymer of the A layer is PAEK; and b) the matrix polymer of the B layer is PI-type polymers, PA, PO, derivatives thereof, or copolymers thereof.

(20) The film of above (13), wherein: a) the matrix polymer of the A layer is fluoropolymers; and b) the matrix polymer of the B layer is PK, PA, PO, derivatives thereof, or copolymers thereof.

(21) The film of above (13), wherein: a) the matrix polymer of the A layer is PA; and b) the matrix polymer of the B layer is PO, derivatives thereof, or copolymers thereof.

(22) The film of above (13), wherein the matrix polymers of the A and B layers are PA.

(23) The film of above (13), wherein: a) the matrix polymer of the A layer is the β-PP; and b) the matrix polymer of the B layer is PO comprising polyethylene (PE), ultrahigh molecular weight PE (UHMWPE), polypropylene (PP), UHMWPP, the β-PP, copolymers thereof, derivatives thereof, or combinations thereof.

(24) The film of any of above (1) to (23), wherein at least one of the matrix polymers is the biopolymer comprising PO, polyester, PA, PK, PAEK, PI-type polymers, derivatives thereof, or copolymers thereof.

(25) The film of any of above (1) to (24), wherein one or more layers of the film comprise the compatibilizer.

(26) The film of any of above (1) to (25), wherein at least one of the outer layers of the film comprises the solid particles less than 95 wt. %.

(27) The film of any of above (1) to (26), further comprising a porous layer of a coating and/or a laminate disposed on at least one of the outer surfaces of the film.

(28) An article, battery, capacitor, supercapacitor, fuel cell or energy storage device comprising the film of any of above (1) to (27) as a separator.

### BRIEF DESCRIPTION OF THE DRAWING

FIGS. 1A, 1B and 1C illustrate a schematic side view respectively of a two-layer film, a three-layer film and a five-layer film, according to some embodiments of the present disclosure.

FIGS. 2A and 2B are a surface micrograph of scanning electron microscope (SEM) respectively for a typical PO-based separator film and a filled Example separator film.

FIG. 3 is a schematic illustration of a multilayer coextrusion film process in accordance with some embodiments of the present disclosure.

FIG. 4 is a graph showing the meltdown temperature (Tmd) and shutdown temperature (Tsd) of the coextruded (Coex), coated (C), and laminated (L) Example films as a function of the higher Tm (Tm,h) of the matrix polymers.

FIG. 5 is a graph showing the shrinkage ratios (%) in the MD and TD of the unfilled PO Example films (U-PO), filled PO Example films (F-PO), and coated polyester Example films (C-PST) and coextruded Example films (Coex) as a function of aging temperatures.

### DETAILED DESCRIPTION OF THE INVENTION

Multilayer polymeric films made out of distinctly dissimilar polymers, e.g., polar and nonpolar polymers, are known in the art and manufactured typically by coextruding multiple layer-forming compositions through a flat-film die, as disclosed in great detail by the present inventors in their U.S. Pat. Nos. 7,713,636, 8,142,893, 8,557,919, and 8,906,510 and WO 2010/059448. As aforementioned, these prior art films are too low in air permeability for use as a separator of electrochemical cells. An aspect of this invention is thus to provide a porous separator film of an open pore structure made out of a wide variety of non-PO based or distinctly dissimilar polymers. Furthermore, each layer of the disclosed film can additionally provide, alone or in combination, various advantageous functions, e.g., such as permselectivity, conductivity, wettability, permittivity, barrier, sorption, adhesion, sealability, regenerability, separation, support, printability, protection, dissipation, compliance, transition, storage, and the like. The invention may further offer such benefits as facile manufacture, low cost, versatility of designing divergent porous film products, and the like.

Various specific embodiments, versions and examples of the invention are described, including preferred embodiments and definitions that are adopted herein and in the claims that follow for purposes of understanding the claimed invention. While the following detailed description gives specific embodiments, those skilled in the art will appreciate that these embodiments are exemplary only and that the invention can be practiced in other ways.

As used herein, the term “oriented” with reference to a film refers to an alignment of polymer chains within the film in a specific direction, e.g., the machine direction (MD), the transverse direction (TD), the in-plane of the film, or the out-of-plane of the film. The orientation can be obtained by stretching or compressing a precursor film, and measured with such techniques as birefringence, dichroism, and X-ray diffraction methods. See, e.g., K. Song, Structure Development of Polyesters and Their Blends in Film Formation Processes, Univ. of Akron, Ohio, 1998.

As used herein, the singular terms “a”, “an” and “the” include plural referents, unless specified otherwise. For example, “a matrix polymer” with reference to layer-forming compositions means one or more polymers forming the matrix of a layer or a film. Likewise, as used herein, the plural term “multilayer” includes a singular referent comprising monolithic, monolayer or single layer. As used herein, the plural term “coextrusion” includes a singular referent comprising extrusion carried out by one extruder, unless the content clearly dictates otherwise.

As used herein, the term “sheet” refers to a nonporous precursor film or to a nonporous thick film. As used herein, the term “film” is interchangeable with “membrane”. As used herein, unless specified otherwise, the term “layer-forming composition” refers to the composition of feedstock materials to form a nonporous layer of the precursor film. As used herein, the term “layer composition” refers to the composition of component materials forming a porous layer of the final, oriented porous film. As used herein, the terms “wet” and “dry” layer-forming compositions refer to the layer-forming compositions being used respectively in a “wet” and “dry” process.

As used herein, the terms “Tm” and “Tg” are abbreviations that refer respectively to a crystalline melting temperature and a glass transition temperature of polymers. As used herein, the term “β-PP” is an abbreviation that refers to a polypropylene (PP) containing a β-crystal nucleating agent (β-NA). As used herein, the term “optional” or “optionally” means that the subsequently described event or circumstance may or may not occur, and that the description includes instances where the event of circumstance occurs and instances where it does not.

As used herein, unless specified otherwise, the term “polymer” includes homopolymers, copolymers, terpolymers, or modifications thereof. As used herein, the term “biopolymer” includes biobased polymers, biodegradable polymers, or modifications thereof. As used herein, the term “copolymer” refers to a polymer formed by polymerization of at least two different monomers, comprising terpolymers and random, alternating, block, and graft copolymers. As used herein, the phrase “a thermoplastic polymer” refers to a melt processable polymer, including ultrahigh molecular weight (UHMW) polymers that are melt processable with the aid of plasticizers, diluents, compatible liquids, solvents, or the like. The term ‘melt processable’ as used herein refers to the property of a polymer that flows when it is heated around its melting or transition temperature.

As used herein, unless specified otherwise, the term “immiscible” refers to the property of a material that does not form in all proportions, when blended with others, a homogeneous single-phase solution on a molecular level. The phrase “an immiscible blend” thus refers to a polymer-polymer blend or a polymer-nonpolymer blend, which is “partially miscible”, “compatible”, “incompatible”, or the like. As used herein, the term “incompatible” refers to the property of a material that is incapable of forming a fine dispersion less than 1 μm in particle size within a continuous matrix of a second material. See, e.g., L. A. Utracki and C. A. Wilkie, Polymer Blends Handbook, 2nd ed., Springer, New York, 2014.

As used herein, unless specified otherwise, the term “shutdown” refers to closure of the pores present in a porous film by the flow of a molten polymer at an elevated temperature, i.e., a shutdown temperature (Tsd). As used herein, the term “meltdown” is interchangeable with “rupture”, which refers to loss of the structural integrity of a porous film at an elevated temperature, i.e., a meltdown temperature (Tmd).

As used herein, the recitation of numerical ranges by endpoints includes all numbers subsumed within that range. For example, the range of 1 to 4 includes 1, 1.5, 1.75, 2, 2.25, 3, 3.31, 3.75, and 4. As used herein, all numbers expressing quantities, sizes, properties and so forth are to be understood as being modified by the term “about” in all instances, unless specified to the contrary. Accordingly, the numerical parameters set forth herein are approximations that can vary with the desired properties to be obtained by those skilled in the art. At the very least, each numerical parameter should at least be construed in light of the number of reported significant digits and by applying ordinary rounding techniques.

As used herein, the terms “micropore”, “mesopore”, and “macropore” refer respectively to a pore with a size less than 2 nm, between 2 and 50 nm, and greater than 50 nm. As used herein, the term “nanopore” refers to a pore having at least one dimension less than 1,000 nm. The term “pore”, as used herein, includes micropore, mesopore, macropore, nanopore, or combinations thereof. The term “void”, as used herein, is interchangeable with pore.

As used herein, the term “particle size” or “size” refers to an average diameter for irregularly or spherically shaped particles or to an average thickness for sheets and fibers. As used herein, the phrase “nanosized material” or “nanomaterial” refers to a material having at least one dimension less than 1,000 nm. As used herein, the phrase “solid particles” or “solid materials” refer to a material that does not melt or flow at any elevated film coextrusion conditions. As used herein, the phrase “active material” refers to a material that can change properties by an external condition or can associate or react with other substances. As used herein, the term “sorbability” refers to a sorption ability of a sorbent material.

### 1. Layer-Forming Composition

The oriented porous film of this disclosure is made from one or more layer-forming compositions, each of which comprises a matrix polymer; a porogent material; and optionally, a compatibilizer and an additive. The matrix polymer is to form a continuous phase holding components together therewithin. The porogent material is to render pores; and optionally, desirable functionalities, into the matrix polymer. The compatibilizer is to promote adhesion between components or layers. The film of this disclosure is made by a dry and/or wet method, with its multilayer structure constructed by coextrusion, lamination, coating, or any combination thereof. Preferred is the dry coextrusion method.

As further described hereinafter, the materials and processes used or generated herein by this disclosure may have a lower and upper limit in quantities, sizes, concentrations, properties, conditions, and the like. These lower and upper limits were, unless specified otherwise, determined empirically by judiciously evaluating various key factors controlling manufacture and use of the disclosed porous film, e.g., such as availability of raw materials, processability, capabilities of manufacture processes, productivity and properties of products, and etc.

In a preferred embodiment, the dry layer-forming composition comprises: i) a matrix polymer less than 100, 95, 90, 80, 70, 60, 50, 40, 30, or 20 wt. %; and preferably in the range of 5 to 100, 15 to 100, and 30 to 100 wt. %; ii) a porogent material less than 95, 80, 70, 60, 50, 40, 30, 20, 10, 5, or 1 wt. %; or in the range of 0.001 to 1, 1 to 5, 5 to 10, 10 to 20, 20 to 30, 30 to 50, 50 to 70, or 70 to 95 wt. %; or in the range of 0.001 to 95 wt. %, preferably 0.01 to 80, 0.01 to 65, 0.01 to 50, and 0.01 to 35 wt. %; iii) a compatibilizer less than 95, 80, 70, 60, 50, 40, 30, 20, 10, 5 or 1 wt. %; or in the range of 0 to 1, 1 to 5, 5 to 10, 10 to 25, 25 to 40, 40 to 60, or 60 to 95 wt. %; or in the range of 0 to 95 wt. %, preferably 0 to 70, 0 to 50, and 0 to 30 wt. %; and iv) an additive less than 20, 15, 10, 5, 3, 1, or 0.1 wt. %; or in the range of 0 to 20 wt. %, preferably 0 to 10, 0 to 5, and 0 to 3 wt. %.

In a preferred embodiment, the wet layer-forming composition comprises: i) a matrix polymer less than 80, 70, 60, 50, 40, 30, 20, 10, or 5 wt. %; or in the range of 1 to 5, 5 to 30, 30 to 50, or 50 to 80 wt. %; or in the range of 1 to 80 wt. %, preferably 5 to 70, 10 to 60, and 15 to 50 wt. %; ii) a porogent material less than 95, 90, 80, 70, 60, 50, 40, 30, 20, or 10 wt. %; or in the range of 5 to 20, 20 to 40, 40 to 80, or 80 to 95 wt. %; or in the range of 5 to 95 wt. %, preferably 10 to 90, 20 to 85, and 30 to 80 wt. %; iii) a compatibilizer less than less than 70, 60, 50, 40, 30, 20, 10, 5 or 1 wt. %; or in the range of 0 to 70 wt. %, preferably 0 to 60, 0 to 50, 0 to 40, and 0 to 30 wt. %; and iv) an additive less than 10, 7, 5, 3, 2, 1, or 0.1 wt. %; or in the range of 0 to 10 wt. %, preferably 0 to 5, 0 to 3, 0 to 2, and 0 to 1 wt. %.

Flow properties of the layer-forming compositions, along with conditions of their mixing and cooling, are critically important in obtaining a stable film of desirable morphologies. The porogent material may form within the matrix a disperse phase at a low content, or a co-continuous or homogeneous single phase at a high content. As such, the porogent material may provide heterogeneous sites for nucleation, polymorph, and crystal growth, alignment and perfection. Preferred is a fine co-continuous phase morphology, capable of forming interconnecting nanopores in the resulting film. The blend morphology may be finely tuned to a target level by controlling several key parameters, such as rheology and interfacial tension of components, intensity of shear and elongational flow mixings, rate and degree of cooling, design of machines and processes, and the like.

In a preferred embodiment, the porogent material (P) during extrusion has a melt viscosity (η) characterized by a viscosity ratio (Rv) greater than 0.00001 relative to that of the matrix polymer (M) with which it is mixed, i.e., Rv=ηP/ηM≧0.00001. The Rv may preferably be greater than 0.0001, 0.001, 0.01, 0.1, 1, 10, 100, 1,000, or 10,000; or in the range of 0.00001 to 100,000, preferably 0.0001 to 10,000, 0.001 to 1,000, and 0.01 to 100. The Rv may be in the range of 0.1 to 10, or close to 1. In certain embodiments, the Rv is smaller than 1 or in the range of 0.001 to 1. Miscible blends, on the other hand, which include a homogeneous mixture of polymer melts and diluents, exhibit a single phase morphology. The viscosity ratio (Rv) of the porogens to polymers, as defined herein, may thus exist primarily in immiscible blends. For blends comprising multiple immiscible components, the Rv may be determined by using a viscosity of the main component or a mean viscosity of the components. Any component that does not melt or flow during extrusion, e.g., solid or inorganic particles, is defined herein to have no melt viscosity, unless specified otherwise.

Each of the layer-forming compositions may differ from one another in the level of melt viscosity during coextrusion. Preferably, in light of flow stability, an innermost layer (I) may have a higher viscosity than an outermost layer (O). In some embodiments, the viscosity ratio of the innermost to outermost layer of the film, i.e., ηI/ηO, is greater than 10,000, 5,000, 1,000, 500, 100, 50, 10, 1, 0.1, 0.01, or 0.001; or in the range of 10,000 to 0.001, preferably 5,000 to 0.01, and more preferably 1,000 to 0.1. A special coextrusion die may be designed and used, to enhance the flow stability or to broaden the viscosity difference between layer-forming melts.

The oriented porous film of this disclosure can be manufactured from a wide variety of raw materials comprising petroleum-based materials, biomaterials, or combinations thereof. In some embodiments, the feedstock materials are selected from petroleum-based materials. However, concerns over environment and sustainability have continuously grown hitherto due to fossil-based materials. In certain embodiments, the feedstock materials are thus selected from biomaterials comprising biobased or biodegradable materials, derivatives thereof, or combinations thereof with petroleum-based materials.

### 1-1 Matrix Polymer

The matrix polymer of this disclosure is a thermoplastic polymer comprising a petroleum-based polymer, a biopolymer, or combinations thereof. Preferred is a film-forming thermoplastic polymer having various good attributes, e.g., such as superior voiding efficiency, high resistance to heat and solvents, nonflammability, excellent strength and barrier, electrolyte wettability, intrinsic porosity, pore shutdown, etc. Any thermoplastic polymer known in the art or made by any suitable means can be used as the matrix polymer without restrictions by chemical or molecular structures, insofar as the polymer is capable of producing the oriented porous film according to this disclosure. For example, although preferred is a para (p)-substitution, such as p-polyetherimide (PEI) based on p-phenylene diamines and polyethylene terephthalate (PET), the matrix polymer may still include an aromatic polymer prepared from ortho (o)- or meta (m)-isomers. See, e.g., E. Saldivar-Guerra and E. Vivaldo-Lima, Handbook of Polymer Synthesis, Characterization and Processing, Wiley & Sons, N J, 2013.

The matrix polymer can be semicrystalline or amorphous. Preferred is a semicrystalline polymer, having a crystallinity (Xc) greater than 5, 10, 15, 20, 25, or 30% and preferably greater than 35%, measured with a differential scanning calorimeter (DSC) or a wide angle X-ray diffractometer (WAXS). The matrix polymer may preferably have a relatively high molecular weight (MW) or viscosity, thus providing a proper level of melt strength during casting of the extrudates. Although variable to some extents with type of polymers, a desirable range of MW and viscosity can be specified by measuring according to ASTM methods a number or weight average molecular weight (Mn or Mw), a melt flow rate (MFR), a solution viscosity, a melt viscosity (η), or the like.

The matrix polymer may have an Mw of 500 to 10,000, 10,000 to 100,000, 100,000 to 500,000, 500,000 to 1,000,000, or 1,000,000 to 1,000,000,000 g/mole; or preferably in the range of 1,000 to 1,000,000,000 g/mole. The Mw can be measured with gel permeation chromatography (GPC) according to ASTM D 6474 for PE and PP, ASTM D 5296 for polystyrene (PS) and polyester, or the like. In some embodiments, the matrix polymer has an Mw of 5,000 to 100,000,000 g/mole, and preferably 10,000 to 10,000,000 g/mole. The matrix polymer may have a narrow molecular weight distribution (MWD), defined as Mw/Mn, less than 50, 40, 30, 20, or 10; or in the range of 1.1 to 10, 10 to 20, 20 to 30, 30 to 40, or 40 to 50; or in the range of 1.1 to 50, preferably 1.1 to 30, 1.1 to 20, and more preferably 1.1 to 10. In certain embodiments, the MWD ranges from 1.1 to 10, 1.1 to 5, or 1.1 to 3. Alternatively, the matrix polymer may have a broad MWD less than 300, 200 or 100; or in the range of 50 to 300, preferably 50 to 200, and more preferably 50 to 100.

The matrix polymer may have an MFR, measured according to ASTM D 1238, less than 300, 250, 200, 150, 100, 50, 25, 20, 15, 10, 9, 8, 7, 6, 5, 4, 3, 2, 1, 0.5, 0.1, or 0.01 g/10 min. The MFR may range from 0 to 1, 1 to 5, 5 to 10, 10 to 15, 15 to 20, 20 to 30, 30 to 50, 50 to 100, 100 to 150, 150 to 200, or 200 to 300; or from 0 to 500 g/10 min, preferably 0.001 to 100 g/10 min, and more preferably 0.01 to 50 g/10 min. The matrix polymer may have an intrinsic viscosity (IV) greater than 0.01, 0.05, 0.1, 0.2, 0.3, 0.4, 0.5, 0.6, 0.7, 0.8, 0.9, 1, 1.2, 1.4, 1.6, 1.8, 2, 2.25, 2.5, 2.75, 3, 3.5, 4, 4.5, 5, 5.5, 6, 7, 8, 9, 10, 12, 15, 18, 20, 25, 30, 35, 40, or 50 dl/g. Although no upper limits are required, the IV may be less than 100 or 75 dl/g in view of productivity and processability. The IV can be measured according to ASTM D 2857, D 5225, and D 1601 for polyethylene, ASTM D 4603 and ASTM D 2857 for polyester, ASTM D 789 and ASTM D 2857 for polyamide, etc. The IV value of a polymer can be conveniently correlated to its viscosity average molecular weight (Mv) through the Mark-Houwink Equation, i.e., IV=kMv^{a}, wherein k and a are empirically determined constants.

The matrix polymer may have a melt viscosity (η) greater than 0.01, 0.1, 1, 10, 25, or 50 Pa·s, measured according to ASTM D 3835 at its extrusion conditions. The extrusion conditions may vary to some extents with type of polymers; but, generally comprise a shear rate less than 10,000 s⁻¹ and a temperature up to 100° C. above a Tm or flow temperature (Tf) of the matrix polymer. Although no upper limits are required, the melt viscosity (η) may not be too high to extrude the polymer or too low to lack the melt strength. In a preferred embodiment, the matrix polymer has a melt viscosity (η) of 0.01 to 10,000 Pa·s at a shear rate of 1 to 10,000 s⁻¹; 0.1 to 8,500 Pa·s at 20 to 10,000 s⁻¹; 1 to 7,000 Pa·s at 40 to 5,000 s⁻¹; or 10 to 5,000 Pa·s at 60 to 10,000 s⁻¹. As aforesaid, certain polymers, e.g., UHMW polymers, may not melt or flow at their extrusion conditions; thus, they are defined herein to have no melt viscosities.

The matrix polymer may have a unimodal or multimodal molecular weight distribution (MWD). The multimodal MWD polymer may comprise one or more components, and preferably less than 5 components, of the same polymer, a polymer of the same family, a miscible polymer, a copolymer, or combinations thereof. Each of the component polymers may differ from each other in MW or may have a unimodal, bimodal, or multimodal MWD. A preferred multimodal polymer may consist of the same polymers of different MWs. The multimodal MWD may be characterized by one or more peaks or inflection points in GPC, resulting respectively from the components of a low molecular weight (LMW), a high molecular weight (HMW), or an ultrahigh molecular weight (UHMW). The multimodal MWD polymer can be prepared by extruder or reactor blending or by any suitable means, as disclosed in, e.g., U.S. Pat. Nos. 4,461,873, 7,163,906, 8,101,687, 8,148,470, and 9,637,573.

In some embodiments, the matrix polymer has a unimodal or multimodal MWD comprising at least one of: i) an UHMW component of 0 to 70 wt. % having a weight average molecular weight (Mw) greater than 1,000,000 g/mole; ii) a HMW component of 30 to 100 wt. % having a Mw of 10,000 to 1,000,000 g/mole; or iii) a LMW component of 0 to 70 wt. % having a Mw less than 10,000 g/mole. In certain embodiments, the multimodal polymer comprises at least one HMW component in the amount of greater than 10, 30, 50, 60, 70, 80, or 90 wt. %; or in the range of 20 to 100 wt. %, preferably 30 to 100, 40 to 100, 50 to 100, 60 to 100, and 70 to 100 wt. %. In certain embodiments, the multimodal polymer comprises at least one UHMW component less than 80, 70, 60, 50, 40, or 30 wt. %; or in the range of 1 to 80 wt. %, preferably 1 to 70, 1 to 60, 1 to 50, 1 to 40, and 1 to 30 wt. %.

In some embodiments, the matrix polymer is polyolefin (PO) or polyketone (PK) characterized by: a) an Mw of 5,000 to 100,000,000 g/mole and b) a unimodal or multimodal MWD comprising at least one of: i) an UHMW component having an Mw greater than 1,000,000 g/mole in the amount of 0 to 70 wt. %; preferably 0 to 60, 0 to 50, 0 to 40, 0 to 30, and 0 to 20 wt. %; ii) a HMW component having an Mw of 100,000 to 1,000,000 g/mole in the amount of 30 to 100 wt. %, preferably 40 to 100, 50 to 100, 60 to 100, and 70 to 100 wt. %; or iii) a LMW component having an Mw less than 100,000 g/mole and preferably in the range of 1,000 to 100,000 g/mole, in the amount of 0 to 70 wt. %, preferably 0 to 60, 0 to 50, 0 to 40, 0 to 30, and 0 to 20 wt. %.

In some embodiments, the matrix polymer is polyester characterized by: a) an IV of 0.1 to 5 dl/g and b) a unimodal or multimodal MWD comprising at least one of: i) an UHMW component having an IV greater than 0.8, 0.9, 1, 1.1, 1.2, 1.3, 1.4, or 1.5 dl/g; or in the range of 0.8 to 5, 1.1 to 3, or 1.5 to 3 dl/g, in the amount of 0 to 70 wt. %, preferably 0 to 60, 0 to 50, 0 to 40, 0 to 30, and 0 to 20 wt. %; ii) a HMW component having an IV of 0.5 to 1.5 dl/g in the amount of 30 to 100 wt. %, preferably 40 to 100, 50 to 100, 60 to 100, and 70 to 100 wt. %; or iii) a LMW component having an IV less than 0.7, 0.6, 0.5, 0.4, or 0.3 dl/g; or in the range of 0.01 to 0.7, 0.05 to 0.6, or 0.1 to 0.5 dl/g, in the amount of 0 to 70 wt. %, preferably 0 to 60, 0 to 50, 0 to 40, 0 to 30, and 0 to 20 wt. %.

### First Polymer

The first polymer of this disclosure constitutes the matrix polymer of the at least one layer. The first polymer has a Tm or Tg greater than 180° C., measured by differential scanning calorimetry (DSC) per ASTM D 3418. A certain matrix polymer, e.g., such as polyketone (PK) and polylactic acid (PLA), may vary its Tm or Tg to a certain degree, depending on its composition or structure. The first polymer may preferably possess a superior resistance to heat, flame, solvent and degradation, along with excellent mechanical strengths; it may comprise a broad range of high polymers, such as engineering polymers, high temperature polymers, heat and solvent resistant polymers, high performance polymers, or combinations thereof. See, e.g., J. K. Fink, High Performance Polymers, 2nd Ed., Elsevier, M A, 2014. A preferred first polymer may include, but not limited to, polyester, polyketone (PK), polyaryletherketone (PAEK), polyimide (PI)-type polymers, fluoropolymers, polyarylene sulfide (PAS), polyarylsulfone, vinyl polymers, cellulose esters, polyamide (PA), ionomers thereof, copolymers thereof, derivatives thereof, or combinations thereof.

In a preferred embodiment, the first polymer has a Tm or Tg greater than 180, 185, 190, 195, 200, 205, 210, 215, 220, 225, 230, 235, 240, 245, 250, 260, 270, 280, 290, 300, 315, 330, 350, or 400° C. The first polymer may have no Tm or Tg, due to a substantially high heat resistance. The Tm or Tg may preferably be lower than 500° C. in view of processability; it may range from 180 to 220, 220 to 250, 250 to 300, 300 to 350, 350 to 400, 400 to 450, or 450 to 500° C.; or from 180 to 500° C. The Tm or Tg may preferably range from 180 to 400° C., more preferably 190 to 375° C., and more preferably 200 to 350° C.

In a preferred embodiment, the first polymer is polyester selected from the group consisting of aliphatic polyesters, semi-aromatic polyesters, aromatic polyesters, copolymers thereof, and combinations thereof. The polyester may be synthesized in the melt state from diacids and diols or from lactones. A solid state polymerization may follow to further increase MW. See, e.g., J. Scheirs and T. E. Long, Modern Polyesters, John Wiley & Sons, London, 2003. The aromatic polyesters may comprise polyarylates and thermotropic liquid crystal polymers (LCP). In one embodiment, the aromatic polyesters are a rod-like LCP comprising repeating aromatic esters, such as hydroxycarboxylic, dicarboxylic and/or diol units. The LCP can be prepared by any method suitable or known in the art, e.g., U.S. Pat. Nos. 4,161,470, 5,616,680, 6,114,492, and 6,514,611. Examples of suitable LCPs may comprise a repeating structure of Formulas (1) to (3) below, wherein n and m are integers:

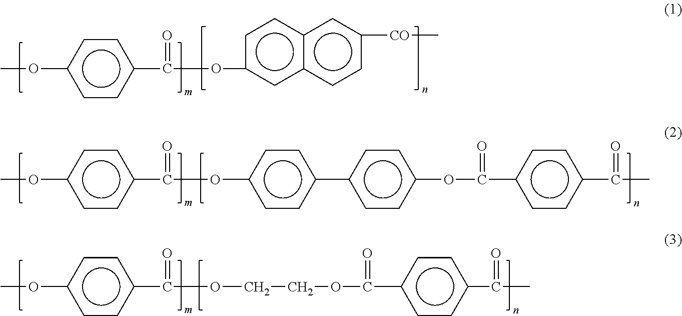

Nonlimiting examples of suitable polyester include polyethylene terephthalate (PET), polytrimethylene terephthalate (PTT), polybutylene terephthalate (PBT), polyethylene naphthalate (PEN), polytrimethylene naphthalate (PTN), polybutylene naphthalate (PBN), polyethylene furanoate or poly(ethylene-2,5-furandicarboxylate) (PEF), polytrimethylene furanoate (PTF), polybutylene furanoate (PBF), polycyclohexylenedimethylene terephthalate (PCT), poly(ethylene glycol-co-cyclohexane-1,4-dimethanol terephthalate) (PETG), poly(ethylene terephthalate-co-1,4-cyclohexylene dimethylene terephthalate) (PET-co-CT), polycarbonates (PC), polyesteramide (PEA), polyarylate (PAr), poly-p-hydroxybenzoate, polybisphenol-A terephthalate, LCP, and combinations thereof. Preferred is a polyester homopolymer of rapid crystallization or high crystallinity.

A preferred polyester includes PET, PTT, PBT, PEN, PTN, PBN, PEF, PTF, PBF, PCT, PET-co-CT, PC, or combinations thereof. A more preferred polyester includes PET, PTT, PBT PEN, PTN, PBN, PEF, PTF, PBF, PCT, or combinations thereof. A more preferred polyester includes PET, PTT, PBT, PEN, PBN, PEF, PCT, or combinations thereof. A more preferred polyester includes PET, PBT, PBN, PEF, PCT or combinations thereof. A more preferred polyester includes PET, PBN, PEF, PCT, or combinations thereof. A more preferred polyester includes PET, PEF, PCT, or combinations thereof. A more preferred polyester includes PET, PEF, or combinations thereof. The most preferred polyester is PET.

In a preferred embodiment, the first polymer is polyketone (PK). The PK is a linear alternating copolymer of carbon monoxide (CO) and one or more olefins comprising: a copolymer of CO and ethylene; a terpolymer of CO, ethylene and a second olefin of at least 3 carbon atoms; or combinations thereof, as disclosed in, e.g., U.S. Pat. Nos. 3,694,412, 3,835,123, 4,880,903, 5,073,327, 5,229,343, and 5,229,445. The second olefin may comprise: i) aliphatic, such as α-olefins of propylene, 1-butene, isobutylene, 1-hexene or 1-decene; ii) arylaliphatic, such as styrene or ring-alkylated styrenes; or iii) combinations thereof. The PK contains substantially one CO molecule per each molecule of ethylenically unsaturated hydrocarbon. A preferred PK is a copolymer, a terpolymer, or mixtures thereof, represented by Formula (4) below:

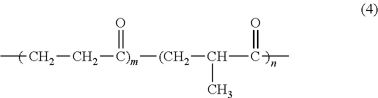

wherein m is an integer greater than 1; n is an integer greater than 0; and the second olefin is propylene in the amount of 0.1 to 10 mole %, preferably 0.2 to 7 mole %, and more preferably 0.3 to 5 mole %.

In a preferred embodiment, the first polymer is polyaryletherketone (PAEK) referred also to polyaryl ketone. The PAEK is composed essentially of an ether linkage —R—O—R— and a keto linkage —R—CO—R— in different sequences, wherein R is a divalent aromatic group and preferably, a substituted or unsubstituted phenylene of Formula (5) below:

wherein X is independently hydrogen, a C₁₋₄ alkyl or a halogen in each occurrence, and preferably hydrogen, methyl, ethyl, chlorine, bromine or fluorine; and wherein n is an integer of 0 to 4.

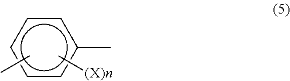

The PAEK may comprise homopolymers, copolymers, derivatives thereof or combinations thereof; it can be synthesized by a nucleophilic or electrophilic route disclosed in, e.g., U.S. Pat. Nos. 3,065,205, 3,928,295, 4,175,175, 4,320,224, 4,331,798, 4,396,755, 4,398,020, 4,717,761, 6,566,484, and 9,243,101. The nucleophilic route may react aromatic dihalides with aromatic diols using a base catalyst in solvents, such as N-methyl-2-pyrrolidione, sulfolane or diphenyl sulfone. The electrophilic route may involve a Friedel-Crafts catalyzed reaction of aromatic diacyl halides and unsubstituted aromatic compounds. A preferred PAEK may have a keto linkage greater than 15, 20, or 25 mole %. Nonlimiting examples of suitable PAEKs include polyether ether ether ketone (PEEEK), polyether ether ketone (PEEK), polyether ketone (PEK), polyether ether ketone ether ketone (PEEKEK), polyether ether ketone ketone (PEEKK), polyether ketone ketone (PEKK), polyether ketone ether ketone ketone (PEKEKK), copolymers thereof with a varying ratio of terephthaloyl (T)/isophthaloyl (I), and combinations thereof. The PAEK copolymers may have a T/I ratio of 50/50 to 95/5 mole %. A preferred PAEK is PEEK.

In a preferred embodiment, the first polymer is polyimide (PI)-type polymers. Suitable PI-type polymers may include PI, PEI, polysulfone etherimide (PSEI), polyamide imide (PAI), polybenzimidazole (PBI), or combinations thereof. The PI type polymers may be prepared by reacting an aromatic dianhydride with an aromatic diamine or a diisocyanate as disclosed in, e.g., U.S. Pat. Nos. 3,179,633, 3,342,774, 3,546,175, 4,098,800, 4,197,396, 4,221,897, 4,358,581, 4,417,044, 4,443,591, 4,835,249, 4,847,311, 4,908,409, 5,149,761, 6,103,806, 6,355,723, 6,458,912, 6,498,224, 6,881,815, 6,919,422, etc. A dianhydride may include oxydiphthalic anhydride, pyromellitic dianhydride, biphenyltetracarboxylic dianhydride, benzophenonetetracarboxylic dianhydrides, bisphenol-A dianhydride, derivatives thereof, or mixtures thereof. A diamine or diisocyanate may be selected from the group of oxydianiline, bisaminophenoxy biphenyl, bisaminophenoxy benzene, bisaminophenoxy benzophenone, phenylenediamine, diaminodiphenylsulfone, methylene diphenyl diisocyanate (MDI), toluene diisocyanate (TDI), derivatives thereof, and mixtures thereof. Preferred is a para (p)-phenylene diamine. Optionally, an end-capper, e.g., monoanhydrides and their derivatives functionalized with acetylene, vinyl, ester, epoxide or nitrile, may be incorporated at any stage during polymerization to stabilize the polymers.

Examples of preferred PI and PEI may have a repeating unit of Formulas (6) to (9) below. A more preferred PI-type polymer is PEI.

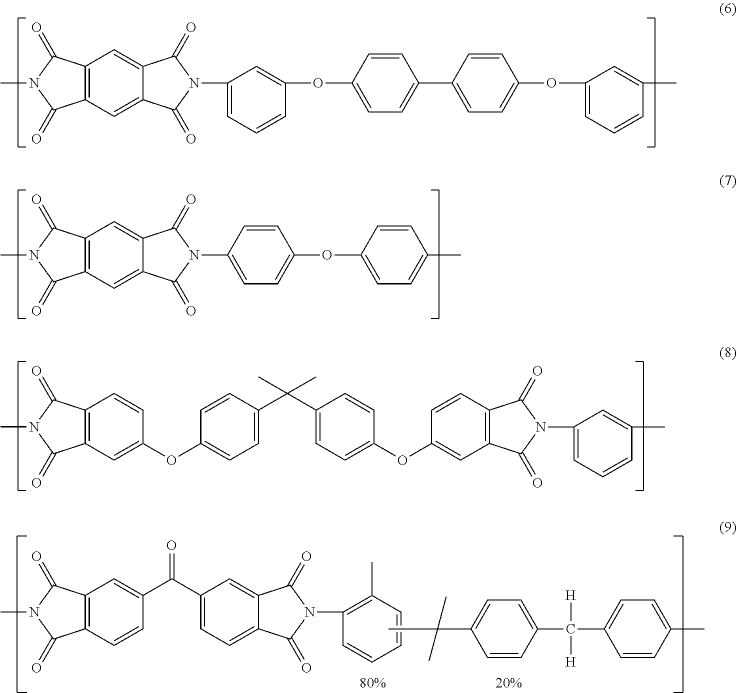

In a preferred embodiment, the first polymer is fluoropolymers. Nonlimiting examples of suitable fluoropolymers include polytetrafluoroethylene (PTFE), polychlorotrifluoroethylene (PCTFE), polyethylenechlorotrifluoroethylene (ECTFE), copolymers of tetrafluoroethylene and ethylene (ETFE), perfluorinated ethylene-propylene copolymer (FEP), tetrafluoroethylene-perfluorovinyl ether copolymer (PFA), polyvinyl fluoride (PVF), tetrafluoroethylene-hexafluoropropylene-perfluoroalkyl vinyl ether copolymer, copolymers thereof, and combinations thereof. A preferred fluoropolymer includes PCTFE, ECTFE, ETFE, FEP, PFA, copolymers thereof, or combinations thereof. A more preferred fluoropolymer includes PCTFE, ECTFE, ETFE, copolymers thereof, or combinations thereof. A more preferred fluoropolymer includes PCTFE, ECTFE, copolymers thereof, or combinations thereof.

In a preferred embodiment, the first polymer is polyarylene sulfide (PAS) comprising polyphenylene sulfide (PPS) or substituted PPS. The PAS contains arylene groups separated by sulfur atoms, which may be prepared by any known method disclosed in, e.g., U.S. Pat. Nos. 3,354,129 and 3,919,177. The PAS may be functionalized, or treated to remove contaminating ions. The PAS may preferably have, after burning, an ash content less than 1, 0.5, or 0.1 wt. %. A preferred PAS is PPS.

In a preferred embodiment, the first polymer is ionomers comprising a backbone polymer and a pendant sulfonate or carboxylate. The backbone polymer may be selected from the group of the first and second polymers comprising fluoropolymers, polyphenylene, PAEK, PI, PBI, PPS, and polyarylene ether (PAE). See, e.g., H. Pu, Polymers for PEM Fuel Cell, Wiley and Sons, N J, 2014. A preferred ionomer may be a single ion conductor comprising pendant sulfonates or perfluorosulfonates, which has a Li-ion transference number of 0.01 to 1.0, preferably 0.1 to 1.0, and more preferably 0.2 to 1.0. The Li-ion transference number is defined as a ratio of current carried by Li+ to the total current transported in a cell. A preferred ionomer may include ionomers of fluoropolymers, polyphenylenes, PAEK, or PI-type polymers.

In a preferred embodiment, the first polymer is polyarylsulfone comprising polysulfone, polyethersulfone, polyphenyl sulfone, polyetherimide sulfone (PEIS), or combinations thereof. A preferred polyarylsulfone is PEIS.

In a preferred embodiment, the first polymer is vinyl polymers selected from the group of syndiotactic polystyrene (sPS), polymethylpentene (PMP), polyacrylonitrile (PAN), polyvinyl chloride (PVC), polyvinyl alcohol (PVOH), ethylene vinyl alcohol copolymer (EVOH), polycyclopentene, polynorbornene, and combinations thereof. A preferred vinyl polymer may include sPS, PMP, PAN, PVC, or combinations thereof. A more preferred vinyl polymer may include PMP or PAN.

In a preferred embodiment, the first polymer is cellulose esters comprising cellulose acetate, cellulose triacetate, or combinations thereof.

In a preferred embodiment, the first polymer is polyamide (PA) selected from the group of aliphatic PA, semi-aromatic PA, aromatic PA, copolymers thereof, and combinations thereof. Polyphthalamide (PPA), according to ASTM D 5336, is a semi-aromatic PA comprising the residues of terephthalic (T) and isophthalic (I) acids greater than 55 mole % in the dicarboxylic acid portion of the repeating structural unit. The PA may be synthesized by any method, known or suitable, including the polymerization of: i) a monoamino monocarboxylic acid or a lactam thereof having at least two carbon atoms between the amino and carboxylic acid groups, ii) substantially equimolar proportions of a diamine containing at least two carbon atoms between the amino and dicarboxylic groups, iii) a monoaminocarboxylic acid or a lactam thereof as defined above, or iv) substantially equimolar portions of a diamine and a dicarboxylic acid. The dicarboxylic acid may be a functional derivative, e.g., a salt, an ester or acid chloride. A monofunctional compound may be used to block the amino or carboxyl terminal group. See, e.g., M. I Kohan, Nylon Plastics Handbook, Hanser, Munich, 1995; and U.S. Pat. Nos. 5,416,189; 5,665,854; 5,686,556; 6,011,134; 8,785,590; and 9,073,867.

Nonlimiting examples of suitable PA include PA6, PA11, PA46, PA66, PA69, PA410, PA610, PA612, PA1010, PA1012, poly(m-xylylene adipamide) (PA MXD6), PA4T, PA6T, PA6I, PA9T, PA10T, PA12T, PPA, PA6T/6, PA6T/66, PA6T/6I, PA6T/DT (D: 2-methyl pentamethylene diamine), PA6T/6I/66, copolymers thereof, and combinations thereof. A preferred PA includes PA6, PA11, PA46, PA66, PA410, PA610, PA612, PA1010, PA1012, PA MXD6, PA6T, PA9T, PA10T, PA12T, PA6T/DT, PA6T/66, or combinations thereof. A more preferred PA includes PA6, PA46, PA66, PA410, PA612, PA1012, PA MXD6, PA9T, PA10T, PA6T/DT, PA6T/66, or combinations thereof. A more preferred PA includes PA66, PA410, PA612, PA1012, PA MXD6, PA9T, PA6T/DT, or combinations thereof. A more preferred PA includes PA66, PA410, PA MXD6, PA9T, or combinations thereof. A more preferred PA includes PA410, PA9T, or combinations thereof.

### Second Polymer

The second polymer of this disclosure is a film-forming thermoplastic polymer other than the first polymer. In a preferred embodiment, the second polymer has a Tm or Tg lower than 180, 175, 170, 165, 160, 155, 150, 145, 140, 135, 130, 125, 120, 115, 110, 105, or 100° C., and preferably in the range of 120 to 180° C. and more preferably 130 to 180° C. A preferred second polymer is miscible or compatible with the first polymer. An incompatible second polymer may incorporate a compatibilizer within or between layers. Nonlimiting examples of suitable second polymers include PO, vinyl polymers, polyacrylate (PAc), polyether, fluoropolymers, aliphatic polyester, aliphatic polyamide, cellulose esters, polysiloxane, copolymers thereof, derivatives thereof, ionomers thereof, and combinations thereof.

A preferred second polymer may include PO, EVOH, PS, PVC, polyethylene oxide (PEO), polypropylene oxide (PPO), polytetrahydrofuran, polyvinylpyrrolidone (PVP), polyoxymethylene (POM), polyacrylic acid (PAA), polyvinyl acetate (PVA), polymethyl methacrylate (PMMA), polyacrylonitrile-co-methacrylate (PAN-PMMA), polyvinylidene fluoride (PVDF), polyvinylidene fluoride-co-hexafluoropropylene (PVDF-HFP), polylactic acid (PLA), polyhydroxyalkanoates (PHA), polyesteramide (PEA), cellulose esters, thermoplastic elastomers (TPE), polydimethylsiloxane (PDMS), ionomers of poly(ethylene-co-acrylate), copolymers thereof, derivatives thereof, or combinations thereof

In a preferred embodiment, the second polymer is polyolefin (PO). The PO may be produced by Ziegler-Natta catalysts, metallocene catalysts, or any other suitable means, as described in detail by the present inventors, e.g., in their U.S. Pat. Nos. 7,713,636 and 8,142,893. Nonlimiting examples of suitable PO include polyethylene (PE), polypropylene (PP), polybutene-1 (PB-1), polyisobutylene (PIB), propylene-based thermoplastic elastomers (PBE), copolymers thereof, derivatives thereof, and combinations thereof. A suitable PE may include high density PE (HDPE), ultrahigh molecular weight PE (UHMWPE), medium density PE (MDPE), low density PE (LDPE), linear low density PE (LLDPE), branched low density PE (BLDPE), ultralow density PE (ULDPE), or combinations thereof. A preferred PE includes HDPE, UHMWPE, or combinations thereof.

A suitable PP may include isotactic PP (iPP), syndiotactic PP (sPP), UHMWPP, β-crystal nucleated PP (β-PP), β-UHMWPP, high crystalline PP (HCPP), high melt strength PP (HMS-PP), mini-random PP (mr-PP) comprising ethylene less than 1 mole %, impact modified co-PP (ICP), copolymers thereof, or combinations thereof. The β-PP and β-UHMWPP can be made by incorporating an effective amount of a β-crystal nucleating agent (β-NA) into any of PP or UHMWPP, as further described hereinafter. A preferred PP includes iPP, UHMWPP, β-PP, β-UHMWPP, HCPP, HMS-PP, mr-PP, or combinations thereof. A more preferred PP includes iPP, UHMWPP, β-PP, β-UHMWPP, or combinations thereof. A preferred PO comprises HDPE, UHMWPE, iPP, UHMWPP, β-PP, β-UHMWPP, or combinations thereof.

In a preferred embodiment, the second polymer is fluoropolymers comprising PVDF, PVDF-HFP, or combinations thereof. The fluoropolymers may be prepared by any known or suitable method.

### Biopolymer

Polymers are abundant in nature. However, as aforementioned, the porous separator films are currently produced exclusively from fossil-based PO or raw materials. There thus are growing interests in renewable feedstocks, due to concerns over sustainability and environment issues caused by the fossil-based materials. The biopolymer may include biobased polymers, biodegradable polymers, or derivatives or combinations thereof. A biobased polymer can be made, in whole or parts, from renewable carbon resources, such as carbohydrate, lignin, plant oils, fats, polysaccharides, fermentation products, etc. A minimum content of biobased feedstocks required for biobased polymers has been established by The U.S. Department of Agriculture (USDA), and ASTM D 6866 provides a test method for measuring the biobased feedstock content in polymers. Biodegradable polymers, on the other hand, can be made either from renewable or fossil resources; both polymers are however converted similarly to CO₂, methane, water and biomass under the natural environment, e.g., soil, air or compost. See, e.g., J. K. Fink, The Chemistry of Bio-based Polymers, Wiley, N J, 2014.

In one embodiment, the first and second polymers are selected from the group of biopolymers comprising polyolefin (PO), vinyl polymers, cellulose esters, polyester, PA, PK, PAEK, PI-type polymers, furan-based polymers, glycopolymers, thermoplastic starches, derivatives thereof, or combinations thereof. A preferred biopolymer may comprise a renewable resource content greater than 20, 30, 40, 50, 60, 70, 80, or 90 mole %, and more preferably of 100 mole %. The preferred biopolymer may be identical essentially to or better than its petrochemical counterpart in chemical, physical and mechanical properties.

In one embodiment, the biopolymer is PO. The PO biopolymer may be produced through fermentation of renewable feedstocks, e.g., such as sugarcane, sugar beet, starch crops, etc. Nonlimiting examples of the PO biopolymer include PE, PP, PB-1, thermoplastic PO elastomers, copolymers thereof, derivatives thereof, and combinations thereof. A preferred PE biopolymer may comprise HDPE, UHMWPE, MDPE, LDPE, LLDPE, BLDPE, ULDPE, or combinations thereof. A preferred PP biopolymer may comprise UHMWPP, iPP, sPP, β-PP, β-UHMWPP, HCPP, HMS-PP, mr-PP, ICP, or combinations thereof. A more preferred PO biopolymer is selected from the group consisting of HDPE, UHMWPE, PP, UHMWPP, β-PP, β-UHMWPP, ICP, and combinations thereof.

In one embodiment, the biopolymer is vinyl polymers comprising PS; PVC; PVOH; polyvinyl butyral (PVB); polyalkylene oxide (PAO) comprising PEO or PPO; or copolymers, derivatives or combinations thereof. Preferred may include PS, PAO, block copolymers thereof, or combinations thereof.

In one embodiment, the biopolymer is polyester. The bio-polyester may be produced by polymerizing a biobased monomer or by ring-opening polymerization of carbohydrate lactones. For example, a furan-based polyester may be synthesized from: i) 2,5-furandicarboxylic acid (FDCA) prepared from mono-, oligo- or polysaccharides, and ii) fossil-based or renewable diols. Nonlimiting examples of suitable bio-polyesters include PET, PTT, PBT, PEN, PTN, PBN, PEF, PTF, PBF, PC, PEA, PLA, polyethylene isosorbide terephthalate (PEIT), polyglycolic acid, polyhydroxyalkanoates (PHA), poly(3-hydroxybutyrate) (P-3HB), poly(3-hydroxyvalerate), polybutylene succinate, polybutylene succinate terephthalate, polybutylene adipate-co-terephthalate, polycaprolactone (PCL), polyacrylates, polyvinylacetate, thermoplastic polyester elastomers, poly(ester-b-ether) (PEBE), aliphatic-aromatic copolyesters, copolymers thereof, derivatives thereof, and combinations thereof. A preferred bio-polyester may include PET, PTT, PBT, PBN, PEF, PEA, PLA, PEIT, PHA, or P-3HB. A more preferred polyester biopolymer includes PET, PTT, PEF, or PLA. A more preferred polyester biopolymer includes PET or PEF. The most preferred polyester biopolymer is PEF.

In one embodiment, the biopolymer is cellulose esters (CE) comprising cellulose acetates (CA), cellulose triacetates (CTA), cellulose acetate propionates, cellulose acetate butylrates, carboxymethyl celluloses, ethyl celluloses, derivatives thereof, or combinations thereof. A preferred CE includes CA, CTA, or combinations thereof.

In one embodiment, the biopolymer is a PA biopolymer comprising PA11, PA12, PA52, PA56, PA510, PA69, PA410, PA610, PA612, PA1010, PA1012, PPA, poly(amide-b-ether) (PABE), copolymers thereof, or combinations thereof. The PA biopolymer can be made by any method suitable or known in the art. A preferred PA biopolymer may include PA11, PA12, PA52, PA410, PA610, PA612, PA1010, PA1012, PPA, or combinations thereof.

### 1-2 Porogent Material

A porogent material may also be termed as a porogen, a voiding agent, a cavitating agent or a foaming agent, which involves creating pores into the matrix polymer. The porogent material may void the film directly, e.g., via interfacial failure and extraction, or indirectly, e.g., via lowering ductility of the matrix polymer. A porogen may be stable, highly stretchable, and compatible or miscible with the matrix polymer at elevated temperatures to form a homogeneous, finely dispersed, or co-continuous phase therewithin. It may preferably be immiscible at room temperature with the matrix polymer. The porogent material, before or after processing, may assume a variety of shapes, e.g., such as fluid comprising liquid; particulate comprising powder, particle, granule, bead, sphere, pellet, chip, or the like; sheet comprising plate, platelet, flake, lamellar, layer, or the like; and fiber comprising wire, whisker, thread, filament, tube, or the like. In principle, the fiber is a particle of a larger aspect ratio and termed differently depending on its dimensions. The porogent material may assume a variety of characteristics, e.g., natural or synthesized, porous or substantially nonporous, inorganic or organic, active or inactive, polarizable or nonpolarizable, crystalline or amorphous, nano- or micron-sized, hydrophilic or hydrophobic, ion exchangeable or neutralized, surface modified, doped and/or coated, or any combination thereof.

The porogent material of this disclosure comprises a sorbent material, a solid-state ionically conductive material, a diluent material, a polymer immiscible with its matrix polymer, a nucleating agent (NA), or preferably, combinations thereof. Any filler material known in the art or made by any convenient means may also be used as porogens, as long as it produces the porous film according to this disclosure. In one embodiment, the porogent material is the sorbent or ionically conductive material, capable of voiding the film while rendering a desirable functionality, e.g., such as intrinsic porosity, conductivity, permittivity, stability, wettability, sorbability, compatibility, nucleation and crystallization, low coefficient of friction (COF), etc. In one embodiment, the porogent material is the diluent material comprising liquids, low MW species, oligomers or combinations thereof, capable of dissolving the matrix polymer at elevated extrusion conditions. In one embodiment, the prorgent material is the immiscible polymer, capable of forming a finely dispersed or co-continuous phase within the matrix polymer. In one embodiment, the porogent material is the NA, capable of creating a desirable crystalline structure into the matrix polymer.

In some embodiments, the porogent material is inorganic and/or organic solid particles having: i) a bulk density (dB) less than 5 g/cc; ii) an average particle size (D50) less than 20 μm; iii) an average aspect ratio (Ra), i.e., a ratio of length (L) to thickness (t), less than 5,000; iv) an average pore volume (Vp) less than 7.0 cc/g; v) a Brunauer-Emmett-Teller (BET) surface area (S_{BET}) less than 7,000 m²/g, or vi) combinations thereof. As aforementioned, the solid particles do not melt or flow at any elevated film coextrusion conditions. The porogent material may preferably be mesoporous, macroporous, porous, nonreactive to electrolytes, incapable of ion exchange, inflammable, and/or highly resistant to heat, solvent and degradation under a harsh electrochemical condition. The porogent material may preferably be surface-modified with polar or nonpolar species, as further described hereinafter.

The dB may range from 0.001 to 0.01, 0.01 to 0.1, 0.1 to 1, 1 to 2,2 to 3,3 to 4, or 4 to 5; or from 0.001 to 5, preferably 0.01 to 3, and 0.01 to 2 g/cc. The D50 may range from 0.1 to 100 nm, 100 to 500 nm, 500 to 1,000 nm, 1 to 2 μm, 2 to 3 μm, 3 to 5 μm, 5 to 10 μm, or 10 to 20 μm; or from 0.1 nm to 20 μm, preferably 1 nm to 10 μm, 10 nm to 5 m, 20 nm to 2 μm, and 30 nm to 1 μm. The Ra may range from 0.001 to 10, 10 to 100, 100 to 1,000, or 1,000 to 2,000, 2,000 to 5,000; or from 0.001 to 5,000 and preferably 0.01 to 2,000. The Vp may range from 0.001 to 0.1, 0.1 to 0.5, 0.5 to 1, 1 to 1.5, 1.5 to 2,2 to 2.5, 2.5 to 3.5, 3.5 to 5, or 5 to 7 g/cc; or from 0.001 to 6 and preferably 0.01 to 5 g/cc. The S_{BET} may range from 0.001 to 1, 1 to 50, 50 to 100, 100 to 1,000, 1,000 to 2,000, 2,000 to 3,000, 3,000 to 4,000, 4,000 to 5,000, or 5,000 to 7,000 m²/g; or from 0.001 to 7,000 and preferably 0.01 to 5,000 m²/g.

In some embodiments, the porogent material is porous having a D50 of 1 nm to 10 μm, a Vp of 0.1 to 3.5 cc/g, a S_{BET} of 0.1 to 5,000 m²/g, or any combination thereof. In certain embodiments, the porogent material has a D50 of 1 nm to 5 μm, 50 nm to 4 μm, 100 nm to 3 μm, 200 nm to 2 μm, or 300 nm to 1 μm; and preferably in the range of 1 to 1,000 nm. The porous porogen may have a broad particle size distribution, a large Vp, a large S_{BET}, or combinations thereof. Alternatively, the porous porogen may have a narrow particle size distribution. A preferred porogen may comprise interconnected pores, or a hollow core-porous shell nanostructure with a varying core-to-shell diameter ratio. The porogent material may soak, when used together, a diluent less than 10 wt. % of its own weight. In certain embodiments, the porogent material is substantially nonporous having: i) a Vp less than 0.5, 0.4, 0.3, 0.2, or 0.1 cc/g; ii) a S_{BET} less than 500, 400, 300, 200, 100, 50, or 20 m²/g; or in the range of 1 to 20, 20 to 100, 100 to 200, 200 to 300, 300 to 500, or 1 to 500 m²/g; or iii) any combination thereof.

Not all of the porogent materials described hereinbefore or hereinafter are equally effective in voiding or functionalizing the film specified in the embodiments. One of ordinary skill in the art can readily select empirically the best porogen for a specific polymer.

### Sorbent Material

The sorbent material may include absorbents, adsorbents or combinations thereof, which may effectively retain or separate certain substances present in solid, liquid and/or gas streams. The sorbed substances may include ion, element, molecule, moisture, vapor, gas, liquid, solid, particle, metal, impurity, contaminant, or the like. Properties of the sorbent material, such as sorption kinetics and capacity, permselectivity, polarizability, compatibility, regenerability, etc., may vary over a wide range, depending on its composition, size, morphology, surface chemistry, and etc. The sorbent may preferably be wettable to electrolytes and promote ion mobility through the medium of a porous film. The sorbent may be highly polarizable. In certain embodiments, the sorbent material is substantially non-sorbent or inactive, providing aforesaid porogent functionalities other than sorbability.

Nonlimiting examples of suitable inorganic sorbent materials may include inorganic carbonates and sulfates, metal oxides and hydroxides, metalloid oxides and hydroxides, siliceous materials, zeolites, zeotypes, xerogels, aerogels, and combinations thereof. The inorganic sorbents may be used in a hydrated or anhydrous state. The inorganic carbonates and sulfates may include CaCO₃, Li₂CO₃, K₂CO₃, limestone, BaSO₄, MgSO₄, or the like. The metal and metalloid compounds may include Li₂O, CaO, MgO, MnO, ZnO, NiO, CuO, MnO₂, Ag₂O, TiO₂, ZrO₂, SbO₂, RuO₂, CeO₂, Al₂O₃, AlOx (1≦x≦3), La₂O₃, Bi₂O₃, Y₂O₃, B₂O₃, Fe₃O₄, V₂O₅, Nb₂O₅, Ta₂O₅, BaTiO₃, γ-AlO(OH) (Boehmite), NaOH, LiOH, KOH, Ca(OH)₂, or combinations thereof. The siliceous materials may include silica or silicates selected from the group consisting of fumed and precipitated silica; SiOx (1≦x≦3); colloidal silica; organosilica; silica gel; boro-silicate porous glass; aerogel; silica nanotube; mesoporous silicates, such as MCM-41, MCM-48, SBA-1, SBA-15, SBA-16, NFM-1, FDU-1, FDU-12, AMS-6 and AMS-8; phyllosilicate and clay, such as kaolinite, serpentine, pyrophyllite, talc, mica, illite, vermiculite, smectite, montmorillonite, chlorite, sepiolite, palygorskite, rectorite, allophan, and mogolite; organosilicates; and combinations thereof.

The zeolites and zeotypes may include zeolite A, such as 4A or 5A; zeolite D; zeolite L; zeolite P; zeolite X, such as 10× or 13×; zeolite Y; zeolite β; ZSM-5; ETS-4; ETS-10; zorite; silicoalumino phosphates; aluminophosphate (AlPO₄); analcime; chabazite; clinoptilolite; erionite; ferrierite; heulandite; laumonitte; mordenite; mesolite; scolecite; stilbite; derivatives thereof; or combinations thereof.

Nonlimiting examples of suitable organic sorbent materials may include carbonaceous materials, celluloses, organic-inorganic hybrids, porous polymers, sorbent polymers, and combinations thereof. The carbonaceous materials may preferably comprise activated carbon, carbon black, carbon molecular sieve, carbon fiber, carbide-derived carbon, fullerene, carbon nanotube, graphene, graphene oxide, graphite, carbon coke, mesoporous carbon, polyacene, or mixtures thereof. The celluloses may preferably include cellulose crystals, cellulose nanocrystals (CNC), whiskers, fibers, cellulose nanofibers (CNF), microfibrillated celluloses, derivatives thereof, or combinations thereof. The celluloses can be isolated from a variety of renewable sources including wood, plants, algae, bacteria, tunicates, etc.; they are biocompatible, low in density, high in mechanical strength, and inexpensive. The organic-inorganic hybrids may include polyhedral oligomeric silsesquioxanes (POSS); metal-organic frameworks (MOF) comprising zeolitic imidazolate frameworks (ZIF), Zn₄O(1,4-benzenedicarboxylate)₃, Zr₆O₄(OH)₄(1,4-benzenedicarboxylate)₆, Al(OH)(1,4-benzenedicarboxylate), Cu₃(1,3,5-benzenetriscarboxylate)₂, Cu₂(3,3′,5,5′-biphenyltetracarboxylic acid), Cu₂(PF₆)(NO₃)(4,4′-bipyridine)₄.2PF₆.32H₂O, or Cu(1,4-benzenedicarboxylate); or combinations thereof.

The porous polymers may comprise hyper-crosslinked polymers, such as crosslinked PS or crosslinked polyethylenimines; polymers of intrinsic microporosity (PIMs); conjugated polymers, such as polyacetylene, polyphenylene vinylene, polyaniline, polysilane, polytriazine or polyphenylene butadiynylene; fluorinated polymers; polynorbornane; polyarylene ethynylene; poly(l-trimethylsilyl-1-propyne) (PTMSP); copolymers thereof; or combinations thereof. A preferred porous polymer is melt or solvent processable at elevated temperatures and highly stretchable under the orientation conditions.

In a preferred embodiment, the sorbent material comprises sorbent polymers, Li₂O, CaO, ZnO, TiO₂, BaSO₄, ZrO₂, SbO₂, Al₂O₃, CaCO₃, AlOx (1≦x≦3), SiO₂, SiOx (1≦x≦3), Nb₂O₅, Ta₂O₅, organosilica, mesoporous silicates, montmorillonite, organosilicates, zeolite A, zeolite X, ZSM, ETS, aerogels, activated carbon, carbon molecular sieve, carbon fiber, carbon nanotube, graphene, graphene oxide, graphite, mesocarbon, nanocrystalline cellulose, ZIF, Cu-BTC MOFs, hyper-crosslinked polymers, PIMs, conjugated polymers, PTMSP, derivatives thereof, or combinations thereof. A more preferred sorbent material may include TiO₂, BaSO₄, Al₂O₃, CaCO₃, SiO₂, mesoporous silicates, organosilicates, ZSM, activated carbon, carbon nanofiber, graphene, nanocrystalline cellulose, ZIF, PIMs, or combinations thereof. In a preferred embodiment, the sorbent material is mesoporous, porous, or combinations thereof.

### Ionically Conductive Material

A solid-state ionically conductive material may also be referred to “ion conductor”, “fast ion conductor”, “superionic conductor” or “solid electrolyte”, capable intrinsically of transporting ions. It is distinct chemically from electroactive or electroconductive materials. The ion conductor may be inorganic or organic, and comprise a lithium superionic conductor (LISICON), a sodium superionic conductor (NASICON), argyrodites, garnets, perovskites, lithium nitrides, lithium hydrides, lithium halides, polymer electrolytes, or combinations thereof. The inorganic ion conductor may consist essentially of mobile metal and nonmetal ions that form polyhedra with ligands to create the skeleton of the crystal structure. A preferred ion conductor is stable at elevated manufacture and use conditions of the film, crystalline, monovalent or mesoporous, and has an ion conductivity at room temperature greater than 10⁻⁵, 10⁻³, 10⁻¹, 1, or 10 mS/cm and preferably in the range of 10⁻³ to 10³ mS/cm.

Nonlimiting examples of the inorganic ion conductors include Li—Ti—PO₄ (LTP), Li—Al—M-PO₄ (LAMP, M=Ti, Ge), Li-M-P—S(LMPS, M=Si, Ge, Sn), Li—Al—Ti—Si—PO₄ (LATSP), Na₃PO₄, Na—Zr—Si—PO₄ (NZSP), Li₃PO₄, Li₂PO₂N (LIPON), lithium lanthanum titanate La—Li—TiO₃; β-alumina, silica, stabilized zirconia, Li hydrides (LiH), Li iodides (LiI), Li sulfides (LiS), Li nitrides (Li₃N), Li phosphides (Li₃P), derivatives thereof, and combinations thereof. Preferred may include LISICON, perovskites, argyrodites or combinations thereof. The LISICON may not be stable when contacts directly with Li metal. Nonlimiting examples of the polymer electrolytes may include poly(ethylene oxide) (PEO), PEO salts, and PEO block copolymers such as PEO-b-PS; polyethers; polyacrylates (PAc) comprising polyacrylonitrile (PAN), polyacrylic acid (PAA) or poly(methyl methacrylate) (PMMA); lithium, sodium or fluorinated ionomers; PVC; PVDF; polysaccharides; polyacrylamides; derivatives thereof; and combinations thereof.

### Diluent Material

A diluent may be termed as “process oil”, “solvent”, or “plasticizer” being used primarily as extractables in the wet layer-forming composition. In one embodiment, the dry layer-forming composition comprises no diluents. The diluent may be a solid, a liquid or their combinations, comprising: polar or nonpolar solvents, monomers, oligomers, polymers, or combinations thereof. Properties of the diluent, such as chemical structure, polarity, melting and boiling points, viscosity, molecular weight, stability, etc., may have a profound impact on structure of the resultant film. The diluent is preferably miscible with the matrix polymer at elevated temperatures, forming a homogeneous melt solution and then upon cooling, phase separating into liquid and liquid or liquid and solid. Polar and nonpolar polymers may thus employ respectively a polar and nonpolar diluent. The diluent may have at least one aromatic or cyclic ring structure and a solubility close to that of the matrix polymer. The diluent may be incompatible with other components of the composition. The diluent may further contain an effective amount less than 50 wt. % of a cosolvent, a nonsolvent, an inorganic salt, an additive or the like, to promote dissolution and phase separation of the matrix polymer.

A preferred diluent is a nonsolvent liquid at room conditions, having a kinematic viscosity less than 100,000, 50,000, 10,000, 5,000, 3,000, 1,000, 500, 100, 50, 20, or 10 cSt.; or in the range of 1 to 100,000 cSt., preferably 1 to 10,000 cSt., and more preferably 5 to 1,000 cSt. The viscosity can be measured at 25° C. according to ASTM D 445. The diluent may preferably have a boiling point of 100 to 600, 150 to 550 or 200 to 500° C., measured according to ASTM D 7169. The diluent may be present in one or more layer-forming compositions in the amount of 10 to 95, 20 to 90, 25 to 85, or 30 to 80 wt. % based on the total weight of the composition.

The nonpolar diluent may comprise aliphatic, alicyclic or aromatic hydrocarbons, halogenated hydrocarbons, derivatives thereof, or mixtures thereof. Nonlimiting examples of suitable nonpolar diluents may include, but not limited to, mineral oils, mineral spirits, liquid paraffin, naphthenic oil, aromatic oil, paraffin waxes, waxes, petrolatum, silicone oils, nonane, decane, decalin, undecane, dodecane, terpene, terpenoid, biphenyl, terphenyl, naphthalene, 1-chloronaphthalene, pyrene, fluoranthene, and combinations thereof.

The polar diluent may comprise esters, ethers, amides, sulfones, alcohols, ketones, aldehydes, renewable oils, oligomers and polymers thereof, derivatives thereof, or combinations thereof. Nonlimiting examples of suitable esters include alkyl, alicyclic and aromatic esters comprising: i) phthalic acid esters comprising dialkyl phthalate, diethyl phthalate, dibutyl phthalate, dioctyl phthalate, diisodecyl phthalate, ditridecyl phthalate, diisononyl phthalate, diundecyl phthalate, dipropylheptyl phthalate, butylbenzyl phthalate, diphenyl phthalate, polyester phthalate, etc.; ii) terephthalic acid esters comprising dialkyl terephthalates, dioctyl terephthalate, diphenyl terephthalate, etc.; iii) citric acid esters comprising triethyl citrate, acetyltriethyl citrate, tri-n-butyl citrate, acetyltri-n-butyl citrate, acetyltri-n-hexyl citrate, n-butyryltri-n-hexyl citrate, etc.; iv) glutaric acid esters comprising dialkylether glutarate, polyester glutarate, etc.; v) adipic acid esters comprising dibutoxyethoxyethoxyethyl adipate, dibutoxyethoxyethoxyethyl adipate, dioxtyl adipate, polyester adipate, etc.; vi) sebatic acid esters comprising dimethyl sebacate, dibutyl sebacates, dibutoxyethyl sebacate, dibutoxyethoxyethyl substitute sebacate, polyester sebacate, etc.; vii) carbonic acid esters comprising ethylene carbonate, propylene carbonate, benzylphenyl carbonate, diphenyl carbonate, etc.; viii) trimellitic acid esters comprising tributyl, trihexyl, trioctyl, triisononyl, or triisodecyl trimellitates, etc.; ix) phosphoric acid esters comprising triethyl phosphate, trisbutoxyethyl phosphate, triphenyl phosphate, etc.; x) lactones comprising γ-butyrolactone, polycaprolactone, etc.; xi) glycol esters comprising polyethylene glycol (PEG) 200 monooleate, PEG 400 ester, triethylene glycol (TEG) carprate-carprylate, TEG di(2-ethylhexoate), TEG ester, triacetin, etc.; xii) maleic acid esters comprising dioctyl maleate; xiii) benzoic acid esters comprising 2,2,4-trimethyl-1,3-pentanediol dibenzoate, neopentyl glycol dibenzoate, triethylene glycol dibenzoate, glyceryl tribenzoate, trimethylolethane tribenzoate, pentaerythritol tetrabenzoate, diethylene glycol (DEG) dibenzoates, dipropylene glycol dibenzoates, benzoate esters, etc.; xiv) fatty acid esters comprising fatty acids methyl esters (FAMEs), octyl oleate, etc.; or xv) derivatives or combinations thereof.

Nonlimiting examples of suitable ethers include DEG, TEG, dibenzyl and diphenyl ethers, polyphenyl ether, polyphenyl oxide, glycol and polyglycol ethers, ethylene glycol n-butyl ether, tripropylene glycol n-butyl ether, tri- and tetraglymes, polyethylene and polypropylene glycols, methoxytriglycol, ethoxytriglycol, butoxytriglycol, polytetrahydrofuran, halogenated ethers, perfluoropolyether, polyvinyl ether, derivatives thereof, and combinations thereof. Nonlimiting examples of suitable amides include 1-methyl-2-pyrrolidone, N-vinylpyrrolidone, dimethyl acetamide, dimethyl formamide, tetramethylurea, dimethyl sulfoxide, N,N-dimethyl-9-decenamide, pyrrolidone, diethanolamine, aromatic sulfonamides, N-butylbenzene sulfonamide, derivatives thereof, and combinations thereof.

Nonlimiting examples of suitable sulfones include dialkyl sulfones, diphenyl sulfone, sulfolane, derivatives thereof, and combinations thereof. Nonlimiting examples of suitable alcohols include stearyl, oleyl, decyl, dodecyl, hexadecyl, and nonyl alcohols, hexafluoroisopropanol, 1,2 dihydroxy alkanes, glycerine, phenols, cresols, xylenol, mequinol, benzenediol, polycaprolactone diol and triol, derivatives thereof, and combinations thereof. Nonlimiting examples of suitable ketones and aldehydes include aliphatic, cyclic and aromatic ketones, methyl nonyl ketone, isophorone, acetophenone, benzophenone, benzoquinone, cyclohexanone, fluorenone, dihydrolevoglucosenone, aromatic hydroxyketones, derivatives thereof, and combinations thereof.

Nonlimiting examples of suitable renewable oils include a lipid include vegetable oils, animal oils, fats, waxes, derivatives thereof and combinations thereof, which comprise soybean oil, corn oil, olive oil, castor oil, canola oil, rapeseed oil, sunflower oil, linseed oil, palm oil, palm kernel oil, coconut oil, safflower oil, peanut oil, cottonseed oil, tall oil, tung oil, babassu oil, hemp oil, fish oil, whale oil, tallow, tallow amine, lard, and the like.

A preferred renewable oil has: i) an iodine value (IV) less than 150 g I₂/100 g and preferably 100 g I₂/100 g, measured according to ASTM D 1959 or AOCS Method Cd1d-92; ii) an oxidation stability index (OSI) greater than 5 hours, preferably 10 hours and more preferably 15 hours, measured at 110° C. according to AOCS Method Cd12b-92; and/or iii) an oleic content greater than 40% and preferably 50% based on the fatty acid content of the oil, measured according to AOCS method Ca5α-40.

The renewable oil can be prepared from various sources, e.g., such as renewable resources, genetically modified organisms, modification of natural renewable oils, or combinations thereof. The methods for modifying natural renewable oils may include hydrolysis, transesterification, hydrogenation, epoxidation, hydroformylation, ozonolysis, thiol-ene coupling, amidation, catalytic deoxygenation, pyrolysis, electrolysis, hydrotreatment, or combinations thereof.

Nonlimiting examples of the preferred renewable oils include genetically modified soybean oils, high oleic soybean oils, hydrogenated soybean oils, soy-based polyols, polymerized soybean oils, soyates, soybean oils, epoxidized soybean oil fatty acid esters, genetically modified vegetable oils, high oleic vegetable oils, hydrogenated vegetable oils, polymerized vegetable oils, epoxidized vegetable oils, epoxidized tall oils, epoxidized vegetable oil fatty acid esters, vegetable oil-based polyols, biopolyols, high oleic sunflower oils, sunflower oil, palm oil, palm kernel oil, castor oil, coconut oil, babassu oil, olive oil, coconut oil, canola oil, peanut oil, cottonseed oil, corn oil, lard, tallow, derivatives thereof, and combinations thereof. A more preferred renewable oil may include genetically modified soybean oils, high oleic soybean oils, genetically modified vegetable oils, high oleic vegetable oils, or combinations thereof.

In a preferred embodiment, the matrix polymer and the diluent material are selected from the group consisting of: i) PO and the diluent comprising hydrocarbons, mineral oils, liquid paraffin, paraffin waxes, esters, renewable oils, or mixtures thereof; ii) polyester and the diluent comprising esters, ethers, sulfones, renewable oils, or mixtures thereof; iii) the matrix polymer comprising PK, PEAK, PPS, or PI type polymers and the diluent comprising ketones, aldehydes, alcohols, esters, amides, sulfones, ethers, renewable oils, or mixtures thereof; iv) PA and the diluent comprising amides, sulfones, esters, ethers, renewable oils, or mixtures thereof; v) fluoropolymers and the diluent comprising mineral oils, halogenated hydrocarbons, halogenated ethers, silicone oils, esters, renewable oils, or mixtures thereof; and vi) the matrix polymer and the diluent comprising oligomers of the matrix polymer, renewable oils, or mixtures thereof.

### Immiscible Polymer

Polymer blends are dominated by immiscibility, characterized by weak interface or phase separation leading to poor mechanical properties of the resulting product. Despite such disadvantages, the immiscible blends have been widely used in various commercial products, including a dry porous film invented uniquely by the present inventors as disclosed in detail in their U.S. Pat. Nos. 7,713,636 and 8,557,919, and W.O. Pat. Pub. No. 2010/059448.

In one embodiment, the porogent material of this disclosure is a thermoplastic polymer immiscible with the matrix polymer to be blended. The immiscible polymer is selected preferably from the group of the matrix polymers. A polar polymer may employ a nonpolar polymer as an immiscible polymer, or vice versa. The first polymer may employ the second polymer as an immiscible polymer, or vice versa. A preferred immiscible polymer is a partially miscible or compatible polymer, distinct in chemical or crystalline structure from the matrix polymer and yet capable of forming a compatibilized blend therewith. The blend may be prepared by mixing immiscible polymers with or without incorporating a compatibilizer therein. In one embodiment, one or more layer-forming compositions of the film comprise the immiscible polymer of 5 to 95 wt. %, preferably 10 to 80 wt. %, and more preferably 20 to 60 wt. %, based on the total weight of the layer thereto it is added.

The immiscible polymer may form within the matrix polymer a dispersed or co-continuous phase of droplets, rods, sheets or fibers, depending on such parameters as a viscosity ratio of components, a blend ratio, interfacial tension, process conditions, and etc. The immiscible polymer may have an Mw of 500 to 50,000,000 g/mole; or 500 to 5,000, 5,000 to 10,000, 10,000 to 100,000, 100,000 to 1,000,000, or 1,000,000 to 50,000,000 g/mole. In certain embodiments, the immiscible polymer is a wax having an Mw less than 10,000, 8,000, 5,000, 3,000, 2,000, 1,000, or 500 g/mole; and preferably in the range of 300 to 10,000, 500 to 8,000, or 1,000 to 5,000 g/mole.

In a preferred embodiment, the immiscible polymer (I) during extrusion has a melt viscosity (η) characterized by a viscosity ratio (Rv) greater than 0.00001 relative to a melt viscosity of the matrix polymer (M) with which it is mixed, i.e., Rv=ηI/ηM≧0.00001. The Rv may preferably be greater than 0.00001, 0.0001, 0.001, 0.01, 0.1, 1, 10, 100, 1,000, or 10,000; or in the range of 0.00001 to 100,000, preferably 0.0001, to 10,000, and more preferably 0.001 to 1,000. The Rv may preferably be close to or less than 1. In certain embodiments, the Rv is less than 1; or in the range of 0.0001 to 1, 0.001 to 1, or 0.01 to 1.

The dimension and uniformity of blend morphology can be critically important in obtaining a desirable pore structure. The dispersed phase may have an average domain size less than 5, 4, 3, 2, 1, 0.5, 0.1, 0.01, or 0.001 μm; or in the range of 1 nm to 5 μm, 5 nm to 3 μm, or 10 nm to 1 μm, measured by transmission electron microscopy (TEM). Preferred is a co-continuous phase morphology consisting dominantly of finely dispersed thin fibrils below 1 μm in diameter. The immiscible blend may undergo changes with processing in phase morphology and interaction.

### Nucleating Agent

The nucleating agent (NA) of this disclosure is capable of creating polymorphs, e.g., α- and β-crystals in PP, or increasing the crystallization site, rate, amount or temperature (Tcc) of the matrix polymer upon cooling from the molten state. The Tcc is commonly termed a cold crystallization temperature; it is measured by DSC. The NA can be organic or inorganic, being selected from any nucleator known in the art or made by any convenient means. See, e.g., G. Wypych, Handbook of Nucleating Agents, ChemTech, Toronto, 2016. The NA may be added to the matrix polymer at any stage during synthesis or processing via a dry or master batch blend, or by any known or suitable means. A preferred method is to use the master batch.

In one embodiment, one or more matrix polymers of the film comprise a NA of 0.001 to 5, 5 to 20, 20 to 40, or 40 to 60 wt. %; or in the range of 0.001 to 60 wt. %, preferably 0.01 to 50 wt. %. In certain embodiments, the matrix polymer comprises an organic NA of 0.001 to 5 wt. %, preferably 0.005 to 3.5 wt. %, and more preferably 0.01 to 2 wt. %. In one embodiment, a nucleated matrix polymer has ΔTcc greater 0, 1, 2, 3, 4, 5 or 10° C.; or in the range of 0 to 30, 0.5 to 20, or 1 to 10° C. The ΔTcc is a difference of Tcc between a nucleated (N) and pristine (P) polymer, i.e., ΔTcc=Tcc (N)−Tcc (P). In certain embodiments, the ΔTcc is negative in the range of −5 to 0° C., due presumably without being bound to any theory to the induction time of certain NAs that create simultaneously a large amount of crystal nuclei.

Nonlimiting examples of suitable NAs include inorganic and organic particles; amides; imides; esters of a diol; pigments; nanocrystalline celluloses (NCC); alkali waxes; alkaline earth metal salts of phosphinates, phosphonates, phosphates, sulfinates, sulfonates, sulfates, hydroxides, and aliphatic and aromatic mono- or polycarboxylates; derivatives thereof; and combinations thereof. A preferred salt may have cations and anions selected from the group consisting of Li, Na, K, Ca, phosphate, sulfate, acetate, propionate, adipate, pimelate, suberate, phthalate, terephthalate, isophthalate, naphthalate, and the like.

In one embodiment, the NA for the first polymer is selected from the group consisting of the porogent material and Janus particles described herein before and after, glasses, micas, talcs, kaolinites, clays, wollastonites, TiO₂, POSS, NCCs, dibenzylidine sorbitol, carbonates, adipates, Na and Li benzoates, citrates, acetals of sorbitol and xylitiol, ethylene bis-stearamide, disodium bicyclo[2.2.1]heptanedicarboxylate, PEG esters, PEG bis(2-ethylhexanoate), PEG dilaurate, monosodium terephthalates and naphthalates, trisodium phosphate (Na₃PO₄), alkyl aryl phosphates, cyclic bis-phenol phosphates, sodium acetate (NaOAc), sodium montanate, sodium and calcium stearates, anthraquinones, perylenes, quinacridones, ionomers of ethylene and ester, polar and nonpolar waxes, rapidly crystallizing or UHMW polymers, LCP, fluoropolymers, and combinations thereof. A preferred NA comprises inorganic nanoparticles, benzoates, monosodium terephthalates and naphthalates, disodium bicyclo[2.2.1]heptanedicarboxylate, Na₃PO₄, NaOAc, montanates, stearates, ionomers, PBT, PBN, fluoropolymers, or combinations thereof.

In one embodiment, the NA for PE, the α-crystal of PP and nonpolar polymers is selected from the group consisting of salts of mono- and polycarboxylic acids, e.g., sodium benzoate, aluminum tert-butyl benzoate, disodium bicyclo[2,2,1]heptane-2,3-dicarboxylate and calcium 1,2-cyclohexanedicarboxylate; dibenzylidene sorbitols and derivatives, e.g., 1,3:2,4-dibenzylidene, methyldibenzylidene, ethyldibenzylidene and dimethyldibenzylidene sorbitols, and 1,2,3-trideoxy-4,6:5,7-bis-O-[(4-propylphenyl)methylene]-nonitol; salts of phosphate diesters, e.g., sodium 2,2′-methylenebis (4,6-di-tert-butylphenyl)-phosphate and aluminum hydroxy-bis[2,2′-methylene-bis(4,6-di-tert-butylphenyl)-phosphate]; benzene trisamides, e.g., N,N′,N″-tris-tert-butyl-1,3,5-benzenetricarboxamide and N,N′,N″-tris-cyclohexyl-1,3,5-benzenetricarboxamide; vinylalkane and vinylcycloalkane polymers; NCCs; waxes; and combinations thereof.

In one embodiment, the NA for the β-crystal of PP is selected from the group consisting of amide compounds, e.g., dicarboxamides and N,N′-dicyclohexyl-2,6-naphthalene dicarboxyamide; alkali and alkaline earth metal salts of mono-, di- and polycarboxylates comprising potassium 1,2-hydroxystearate, magnesium benzoate, magnesium phthalate, magnesium succinate, calcium salts of pimelic, suberic, phthalic and terephthalic acids, and calcium salts of N-phthaloyl glycine; esters of dibasic and tribasic carboxylic acids; tetraoxaspiro compounds, e.g., 3,9-bis[4-(N-cyclohexylcarbamoyl)phenyl]-2,4,8,10-tetraoxaspiro[5.5]undecane; salts of aromatic sulfonate, e.g., sodium benzenesulfonates and naphthalenesulfonates; pigments, e.g., quinacridones, quinacridones, quinones, dihydroquinacridones and phthalocyanine blues; mixtures of magnesium and cyclic phosphorus compounds; nanosized irons and metal oxides; and combinations thereof.

As aforesaid, a β-PP refers to any PP, bio- or petroleum-based, comprising a β-NA. In one embodiment, a β-nucleated layer of the unoriented cast sheet comprises a relative amount (Xβ) of β-crystallinity greater than 20, 30, 40, 50, or 60%; or in the range of 20 to 100%, preferably 30 to 100%, more preferably 40 to 100%, and more preferably 50 to 100%. The Xβ can be measured with DSC or WAXS, as further described hereinafter. The β-crystals present in the unoriened sheet undergo a transition during orientation into the α-crystals; thus, leaving behind pores but little or no β-crystal residues in the oriented film. However, yet the porous layer retains the β-NAs therewithin, exhibiting a β-crystallinity when measured with the second DSC heating scan. The β-NAs, on the other hand, present in the wet layer can be removed substantially all out of the oriented film by the extraction process. In certain embodiments, the oriented porous film comprises no β-NAs and thus, no β-crystallinity.

In a preferred embodiment, the PP matrix comprises 0.001 to 10, 0.005 to 5, or 0.01 to 3 wt. % of α- or β-crystal NAs. A preferred α-NA may include sodium benzoate, disodium bicyclo[2,2,1]heptane-2,3-dicarboxylate, 1,3:2,4-bis-(3,4-dimethyl-benzylidene) sorbitol, sodium 2,2′-methylenebis-(4,6-di-tert-butyl-phenyl) phosphate, hydroxybis-(2,4,8,10-tetra-tert-butyl-6-hydroxy-12h-dibenzo-(d,g)(1,3,2)-dioxaphosphocin-oxidato) aluminum, 1,2,3-trideoxy-4,6:5,7-bis-O-[(4-propylphenyl)methylene]-nonitol, N,N′,N″-tris-tert-butyl-1,3,5-benzenetricarboxamide, or combinations thereof. A preferred β-NA may include N,N′-dicyclohexyl-2,6-naphthalene dicarboxyamide, γ-quinacridones, calcium pimelates, calcium suberates, calcium phthalates, calcium salts of, 3,9-bis[4-(N-cyclohexylcarbamoyl)phenyl]-2,4,8,10-tetraoxaspiro[5.5]undecane, calcium dicarboxylates, nanosized salts of dicarboxylic acids, or combinations thereof.

### 1-3 Compatibilizer

A compatibilizer is an interfacial modifier, termed also as an adhesion promoter or a dispersing agent, being incorporated into or produced in-situ during processing within an immiscible blend in order to promote adhesion, dispersion and stabilization of the components or phases. The compatibilizer of this disclosure is also to serve as an immiscible polymer for voiding or a matrix polymer of the functional or tie layer. In one embodiment, one or more layer-forming compositions of the film comprise a compatibilizer of 0.1 to 5, 5 to 10, 10 to 20, 20 to 30, 30 to 50, 50 to 70, or 70 to 100 wt. %; or in the range of 0.1 to 100, 1 to 80, or 5 to 60 wt. %, based on the total weight of the component polymers present in the composition, as taught in great detail by the present inventors in their U.S. Pat. Nos. 7,713,636 and 8,142,893.

Nonlimiting examples of suitable compatibilizers include copolymers, functional and functionalized polymers, particulate materials, coupling agents, and combinations thereof. The compatibilizing polymers, such as copolymers, functional and functionalized polymers, refer to polymers that bear functional groups in the backbone or as a pendant, to interact with other polymers, components, surfaces, fillers, ions, solvents, and the like. Nonlimiting examples of suitable coupling agents include silanes, titanates, zirconates, silicates, and combinations thereof.

### Copolymers

The copolymers may include random, alternating, block or graft copolymers, composed of distinct segments that are miscible with the respective phases of immiscible blends. The copolymers may be selected from the group consisting of acrylic copolymers; copolyolefins; copolyesters; copolyamides; block copolymers (BCP) of diblocks, triblocks, multiblocks or starblocks; and combinations thereof.

The BCP may consist of hard and soft segments, e.g., thermoplastic elastomers (TPE), hard and hard segments, or soft and soft segments; it may be synthesized by anionic, cationic, radical or ring-opening polymerizations. A preferred BCP is TPE. The hard segment may have a Tm of 100 to 400° C. and preferably 150 to 350° C., selected preferably from the semicrystalline first or second polymers. The soft segment may have a Tg of −200 to 300° C. and preferably −100 to 200° C., selected preferably from an amorphous or nonpolar polymer comprising copolymers of ethylene and α-olefin, rubbers, polyethers, or combinations thereof. The BCP may contain the hard or soft block in a molecule in the amount of 1 to 99, 5 to 95, 10 to 90, 15 to 85, 20 to 80, 25 to 75, 30 to 70, 35 to 65, 40 to 60, or 45 to 55 mole %; and preferably 1 to 75 mole %, more preferably 10 to 65 mole %.

Nonlimiting examples of suitable copolyesters and copolyamides may include polyesteramides (PEA); poly(ester-b-amide) (PEBA); PAEK-b-polyester; PAEK-b-PA; PEI-b-PA; poly(ester-b-ether) (PEBE), such as PBT-b-polyether, PTT-b-polyether, PBN-b-polyether, PTN-b-polyether and PCT-b-polyether; poly(amide-b-ether) (PABE); ionomers thereof; sulfonates thereof; and combinations thereof. Nonlimiting examples of suitable olefin block copolymers (OBC) may comprise ethylene-based elastomer (EBE), such as poly(ethylene-b-butene) (E-b-B), poly(ethylene-b-hexene) (E-b-H) and poly(ethylene-b-octene) (E-b-O), and propylene-based elastomers (PBE), such as poly(propylene-b-ethylene) (P-b-E) and poly(propylene-b-butene) (P-b-B). Nonlimiting examples of suitable styrenic block copolymers (SBC) may comprise poly(styrene-b-butadiene-b-styrene) (SBS), poly(styrene-b-isoprene-b-styrene) (SIS), poly(styrene-b-ethylene-b-butadiene-b-styrene) (SEBS), poly(styrene-b-ethylene-b-propylene) (SEP), SEPS, PS-b-PEO, and hydrogenated SBCs (HSBC). Nonlimiting examples of suitable acrylic block copolymers (AcBC) may comprise poly(MMA-b-butyl acrylate-b-MMA) and S-b-B-b-MMA.

### Functional and Functionalized Polymers

In one embodiment, the functional and functionalized polymers include: i) a co-solvent polymer that is miscible with each component of immiscible polymers and comprises polyalkylene oxides (PAO), polyhydroxyethers (PHE), polyethers, polycaprolactones (PCL), or PI-type polymers; ii) polar modified or grafted polymers; or iii) combinations thereof.

In one embodiment, the functionalized polymers are graft polymers grafted with at least one functional compound onto a backbone of polymers comprising PO, vinyl polymers, fluoropolymers, or copolymers thereof. The graft reaction can be carried out in solution, a fluidized bed reactor, an extruder, or by any means suitable or known in the art. A preferred method is melt grafting in a twin screw extruder in the presence of functional compounds and catalysts. In one embodiment, two or more grafting reactions are carried out in-situ in a continuous manner, comprising maleation followed by amination. The grafted compound concentration may be less than 30, 20 or 10 wt. % based on the total weight of the backbone polymer; or in the range of 0.1 to 30 wt. %, preferably 0.5 to 20 wt. %, more preferably 1 to 10 wt. %, and more preferably 1.5 to 6 wt. %.

Nonlimiting examples of suitable functional compounds may include an ethylenically unsaturated carboxylic acid, an acid anhydride, a sulfonic acid, amine, hydroxyl, epoxy, ester, amide, imide, isocynate, urethane, derivatives thereof, and combinations thereof. The acid compounds may include acrylic acid, methacrylic acid, maleic acid, fumaric acid, itaconic acid, citraconic acid, mesaconic acid, maleic anhydride, 4-methyl cyclohex-4-ene-1,2-dicarboxylic acid anhydride, bicyclo(2.2.2)oct-5-ene-2,3-dicarboxylic acid anhydride, 1,2,3,4,5,8,9,10-octahydronaphthalene-2,3-dicarboxylic acid anhydride, 2-oxa-1,3-diketospiro(4.4)non-7-ene, bicyclo(2.2.1)hept-5-ene-2,3-dicarboxylic acid anhydride, maleopimaric acid, tetrahydrophtalic anhydride, norborn-5-ene-2,3-dicarboxylic acid anhydride, nadic anhydride, methyl nadic anhydride, himic anhydride, methyl himic anhydride, x-methylbicyclo(2.2.1)hept-5-ene-2,3-dicarboxylic acid anhydride, or combinations thereof. Preferred is maleic anhydride, methyl methacrylate, acrylic acid, methacrylic acid, hydroxyethyl methacrylate, hydroxypropyl methacrylate, glycidyl methacrylate (GMA), or combinations thereof. More preferred is maleic anhydride (MAH).

Nonlimiting examples of suitable amine compounds may include primary and secondary diamines, alkanolamines, polyetheramines, and combinations thereof; which comprise mono-, di- and triamines of polyethers, N-ethylethylenediamine, N-phenylethylenediamine, N-phenyl-1,2-phenylenediamine, N-phenyl-1,4-phenylenediamine, 4-aminomethyl piperidine, 2-aminoethanol, 2-amino-1-propanol, 3-amino-1-propanol, 2-amino-1-butanol, 2-(2-aminoethoxy)ethanol, 2-aminobenzyl alcohol, or the like. A preferred amine compound may include polyether monoamines, polyether diamines, primary and secondary diamines, alkanolamines, derivatives thereof, or combinations thereof. The amine compounds may have an Mw of 50 to 20,000, 100 to 15,000, or 150 to 10,000 g/mole.

Nonlimiting examples of suitable functionalized polymers may include: a) polar modified PO (p-m-PO) comprising p-m-PE, MAH-grafted PE (MAH-g-PE), GMA-grafted PE (GMA-g-PE), p-m-PP, MAH-g-PP, GMA-g-PP, p-m-OBCs, MAH-g-OBCs, GMA-g-OBCs, and combinations thereof; b) polar modified SBCs (p-m-SBCs) comprising p-m-SBCs, MAH-g-SBCs, GMA-g-SBCs, and combinations thereof; and c) polar modified fluoropolymers (p-m-FPs) comprising p-m-FPs, MAH-g-FPs, GMA-g-FPs, MAH-g-PVDF, GMA-g-PVDF, MAH-g-PVDF-HFP, GMA-g-PVDF-HFP, and combinations thereof.

### Particulate Materials

The particulate materials may include particles and/or fibers, being selected from the group consisting of the porogent material described hereinbefore, Janus particles, and combinations thereof. The particulate materials may be inorganic and/or organic. The Janus particles may consist of two or more polymers or organic-inorganic hybrids, synthesized by any known or suitable method, e.g., such as masking, self-assembly, phase separation, and etc. The masking method is common, wherein a mono-functional precursor is selectively decorated with a second material. The porogent material acting also as a compatibilizer may comprise the sorbent material, the ion conductor, the NA, or combinations thereof. In one embodiment, the particulate compatibilizer is inorganic nanoparticles. In one embodiment, the particulate compatibilizer is porous.

In a preferred embodiment, the porous film comprises at least one nanomaterial as a compatibilizer. In a preferred embodiment, the particulate materials are solid particles having: a bulk density (dB) less than 5 g/cc; an average particle size (D50) of 1 to 1,000 nm; an average aspect ratio (Ra), i.e., a ratio of length (L) to thickness (t), less than 2,000; an average pore volume (Vp) less than 6.0 cc/g; a Brunauer-Emmett-Teller (BET) surface area (S_{BET}) less than 7,000 m²/g; or combinations thereof. As aforesaid, the solid particles comprise any inorganic or organic material, which does not melt or flow at any elevated film coextrusion conditions.

### 1-4 Coating

The oriented porous film may comprise a porous layer coated on one or both sides of the outer surfaces, to provide a desirable function, e.g., such as low shutdown, high meltdown, resistance to creep and puncture, flame retardancy, permittivity, adhesion, low friction, protection, conversion, conductivity, transition, etc. Preferred is low shutdown, high meltdown, resistance to creep and puncture, flame retardancy, permittivity, or combinations thereof. The coating can be carried out inline during or offline after manufacture of the porous film. The outer surfaces are preferably treated physically or chemically prior to coating. The wet coating may comprise a binder, solid particles and an optional additive, dispersed uniformly in a solvent. The binder may be selected from the first or second polymer; the solvent from the diluent; and the solid particles from the group consisting of the sorbent material, the solid-state ionically conductive material, the NA, the compatibilizer, and combinations thereof. The additive may include coalescents, defoamers, dispersants, wetting agents, pH regulator, or combinations thereof.

The wet coating may have: i) a solid content of 10 to 80 wt. %, preferably 15 to 70 wt. %, and more preferably 20 to 60 wt. %; ii) a viscosity less than 5,000, 3,000, 1,000, or 500 cP at 25° C. and preferably in the range of 1 to 1,000 cP; and iii) a pH of 3 to 12 and preferably 4 to 11 at 25° C. A preferred coating is waterborne or crosslinkable, wherein a latex binder may have an average particle size less than 5, 3, 1, or 0.5 μm; or in the range of 1 nm to 5 μm, preferably 10 nm to 3 μm, and more preferably 50 nm to 1 μm. A uniform dispersion may be obtained by any suitable or known method, e.g., such as mechanical dispersion or emulsion polymerization, disclosed, e.g., in U.S. Pat. Nos. 6,777,096, 8,063,128, 8,779,053, 9,169,406, 9,290,625, 9,416,291, and 9,422,444.

The dry coating may contain the solid particles less than 99, 90, 80, 70, 60, 50, 40, 30, 20, 10, or 1 wt. %; or in the range of 0 to 10, 10 to 30, 30 to 50, 50 to 70, 70 to 90, or 90 to 99 wt. %; or in the range of 0 to 99 wt. % and preferably 1 to 95 wt. %. The solid particles may have an average size less than 10, 5, or 1 μm; or in the range of 1 nm to 1 μm, 1 to 5 μm, or 5 to 10 μm; or in the range of 1 nm to 10 μm; and preferably 10 nm to 5 μm, and more preferably 20 nm to 1 μm. As described hereinbefore, the preferred solid particles are inorganic and/or organic, having a bulk density (dB) less than 5 g/cc; an average particle size (D50) of 1 to 1,000 nm; an average aspect ratio (Ra), i.e., a ratio of length (L) to thickness (t), less than 2,000; an average pore volume (Vp) less than 6.0 cc/g; a Brunauer-Emmett-Teller (BET) surface area (S_{BET}) less than 7,000 m²/g; or combinations thereof.

In some embodiments, the oriented porous film comprises at least one outer layer coated with a polymeric binder of 50 to 100 wt. %. The dry coating may preferably comprise the solid particles less than 50, 30, 10, 5, or 1 wt. %; or in the range of 0 to 50 wt. %. In other embodiments, the dry coating comprises the solid particles greater than 50, 70, 90, or 95 wt. %; or in the range of 50 to 100 wt. %. A preferred binder may include polyolefin (PO), polar modified PO (p-m-PO), olefin copolymers (co-PO), BCPs, p-m-BCPs, celluloses, carboxymethyl celluloses, PVOH, PVDF, PVDF-HFP, PVDF-co-chlorotrifluoroethylene (PVDF-CTFE), PA, polyacrylate (PAc), polyvinyl acetate (PVA), epoxy resins, ionomers, polydimethylsiloxane (PDMS), polyphosphazenes, porous polymers, PIMs, derivatives thereof, or copolymers thereof.

In one embodiment, the binder is PO comprising PE, PP, co-PO, OBCs, polar and chlorinated derivatives thereof, or combinations thereof. In one embodiment, the binder is non-PO based polymers. In one embodiment, the solid particles comprise SiO₂, SiOx (1≦x≦3), Al₂O₃, AlOx (1≦x≦3), TiO₂, SnO₂, CaCO₃, MgO, ZnO, ZrO₂, B₂O₃, Nb₂O₅, Ta₂O₅, BaTiO₃, BaSO₄, kaolinites, silicates, zeolites, graphene, metal oxides, organic-inorganic hybrids, MOF, LISICON, argyrodites, garnets, perovskites, or combinations thereof.

### 1-5 Additive

An additive can optionally be present in one or more layer-forming compositions of the film as taught in U.S. Pat. Nos. 7,713,636 and 8,142,893. An effective amount of the additive may vary, depending upon desired properties of the film; but, generally less than 20, 15, 10, or 5 wt. % based on the total weight of the component polymers. Suitable additives may include antioxidants (AO), stabilizers, flame retardants capable of reducing the amount and rate of heat release, smoke suppressants, viscosity modifiers, surfactants, dispersing agents, antistatic agents, solubility promoters, thermally or electronically conductive materials, catalysts, crosslinking agents, anti-fouling agents, moisture barriers, pigments, dyes, UV absorbers, or combinations thereof. The stabilizers may include heat, chemical, voltage, light, hydrolysis, or degradation stabilizers.

Suitable AOs may include phenolic, phosphite, amine or sulfate AOs, in the amount of 0.01 to 5 wt. % based on the total weight of the component polymers. Examples of such AOs may include pentaerythrityl tetrakis-3(3,5-di-tert-butyl-4-hydroxyphenyl)proplonate; octadecyl-3-(3,5-di-tert-butyl-4-hydroxy phenyl)propionate; 1,3,5-tris(4-t-butyl-3-hydroxy-2,6-dimethylbenzyl)isocyanuric acid; N,N′-(hexane-1,6-diyl)bis-3-(3,5-di-tert-butyl-4-hydroxyphenyl)propione amide; (3,9-bis[2-{3-(3-t-butyl-4-hydroxy-5-methylphenyl)propionyloxy}-1,1-dimethylethyl]-2,4,8,10-tetraoxaspiro[5.5]undecane; tris(2,4-di-tert-butylphenyl)phosphite; 6,6′,6″-[nitrilotris(ethyleneoxy)]tris(2,4,8,10-tetra-tert-butyldibenzo[d,f][1,3,2]dioxaphosphepine; bis(2,4-bis(1,1-dimethylethyl)-6-methylphenyl)ethyl ester phosphorous acid; tris(mono-dinonylphenyl)phosphite; bis(2,4-di-t-butylphenyl)pentaerythritol diphosphate; bis(2,6-di-tert-butyl-4-methylphenyl)pentaerythritol diphosphite; tetrakis(2,4-di-tert-butylphenyl)-4,4′-biphenylene diphosphonite; tetrakis(2,4-di-tert-butyl-5-methylphenyl)-4,4′-biphenylene diphosphonite; 6-[3-(3-tert-butyl-4-hydroxy-5-methylphenyl)propoxy]-2,4,8,10-tetra-tert-butyldibenz[d,f][1,3,2]dioxaphosphepin; 2-ethyl-2′-ethoy-oxal anilide; distearyl thiodipropionate; pentaerythritol tetrakis-(3-dodecylthiopropionate); lauryl stearyl thiodipropionate; 2-tert-butyl-6-(3-tert-butyl-2-hydroxy-5-methylbenzyl)-4-methylphenyl acrylate; 2-[1-(2-hydroxy-3,5-di-tert-pentylphenyl)ethyl]-4,6-di-tert-pentylphenyl acrylate; and combinations thereof.

Nonlimiting examples of suitable flame retardants may include the aforementioned porogens of metal oxides comprising TiO₂, ZnO, B₂O₃, transition metal oxides, or etc.; aryl and alkyl phosphates/phosphinates and their salts; halogenated aromatic compounds; brominated phenoxy resins; halogenated polystyrenes; halogenated imides; brominated polycarbonates; brominated epoxy resins; melamine compounds; and mixtures thereof. A preferred flame retardant comprises metal oxides that are free essentially of halogen atoms. Suitable smoke suppressants may include metal borate salts or boron containing compounds, such as zinc borate, alkali metal or alkaline earth metal borate, boron nitrides, boric acid, borate esters, boron oxides, etc. Suitable catalysts may include manganese oxides, copper oxides, hopcalites or precious metals, to accelerate an oxidation reaction of contaminants. A variety of surfactants may be used, alone or in combination, to promote dispersion of the components into the matrix and to increase wettability of a fluid onto the film surface.

### 1-6 Extractant

An extractant is to remove the porogens, especially diluents or any of forming minor phases, from the processed film; thus, it can be a good solvent for the extractables but a nonsolvent for the other components. The extractant may be a mixture of water soluble and insoluble solvents to facilitate extraction of polar and nonpolar analytes. The extractant may have: i) a low boiling point less than 300, 250, 200, or 150° C.; ii) a low viscosity less than 10, 5, 1, or 0.1 mm²/s, iii) a low surface tension energy, less than 100, 90, 80, 70, 60, or 50 mN/m at 25° C.; or in the range of 1 to 100 mN/m and preferably 10 to 60 mN/m; iv) a non-flammability, v) a low toxicity, etc. In one embodiment, the extractant has a surface tension less than 10, 5, 1, or 0.5 mN/m; or in the range of 0 to 10, 0 to 5, or 0 to 1 mN/m. In one embodiment, the extractant has a surface tension of 0 mN/m.

Nonlimiting examples of suitable extractants may include subcritical and supercritical fluids (SCFs) based on CO₂, CHF₃, N₂O, H₂O, methane, ethane, propane, ethylene, propylene, butane, isobutane, dimethyl ether, sulphur hexafluoride, ammonia, fluorocarbon, methanol, ethanol and the like; liquid CO₂; water; n-propyl bromide; aqueous alkalines of NaOH, KOH and the like; ionic liquids; N,N-dimethylformamide; chlorinated hydrocarbons, such as methylene chloride (CH₂Cl₂), chloroform, dichloroethylene (DCE), trichloroethylene (TCE), perchloroethylene, dichloroethane and trichloroethane; alcohols, such as methanol, ethanol and isopropanol; acids, such as aqueous hydrochloric and sulfuric acids; ketones, such as acetone, N-methyl-2-pyrrolidone and methyl ethyl ketone; ethers, such as diethyl ether, dimethoxyethane, tetrahydrofuran, dioxane, dioxolane and polyethylene glycol (PEG); esters, such as methyl ester, ethyl acetate and dimethyl carbonate (DMC); 2-methyl tetrahydrofuran (2-MeTHF); methyl siloxane; hydrocarbons, such as pentane, hexane, cyclohexane, heptane, toluene, decane and terpene; halogenated hydrocarbons; halogenated ethers; azeotropes comprising halogenated hydrocarbons, halogenated ethers, hydrofluoroethers and mixtures thereof; derivatives thereof; and combinations thereof.

In one embodiment, the extractant is the chlorinated hydrocarbon selected from the group of CH₂Cl₂, DCE, TCE, perchloroethylene, dichloroethane, trichloroethane and combinations thereof. In one embodiment, the extractant is the green solvent selected from the group of water, DMC, ethyl acetate, 2-MeTHF, methyl ester, SCFs, derivatives thereof, and combinations thereof. In one embodiment, the extractant is an aqueous acid. In one embodiment, the diluent is the subcritical fluids (SCF) comprising CO₂, or a mixture thereof with a polar solvent. A supercritical CO₂ (SC—CO₂) can be an excellent solvent for nonpolar or small polar molecules owing to its weak polarity. The polar solvent may preferably include water, alcohols, ionic liquids, fluorocarbons, siloxanes or combinations thereof. In one embodiment, the diluent is the azeotrope.

### 2. Film Structure and Property

The oriented porous film of this disclosure may consist of up to 3,000, 2,000, 1,000, 500, or 100 layers; or in the range of 1 to 5, 5 to 10, 10 to 20, 20 to 50, 50 to 100, 100 to 500, 500 to 1,000, or 2,000 to 3,000 layers; or in the range of 1 to 3,000 layers, preferably 1 to 1,000, 1 to 500, 1 to 100, 1 to 50, 1 to 20, 1 to 10, and 1 to 5 layers. The multilayer structure may be constructed by any suitable means, e.g., such as a monolayer die, a coextrusion die, a layer multiplying die, a suitable combination of feedblocks and dies, or combinations thereof. The film may have a total thickness less than 1,000 μm; or in the range of 1 to 30, 30 to 60, 60 to 100, 100 to 300, 300 to 500, or 500 to 1,000 μm; or in the range of 1 to 1,000 μm, preferably 1 to 500, 2 to 300, 3 to 100, 4 to 50, 4 to 30, and 5 to 15 μm. In some embodiments, the film has a thickness of 3 to 20 μm, 4 to 15 μm, or 5 to 10 μm. In some embodiments, the film has a thickness of 20 to 30, 30 to 50, or 50 to 500 μm.

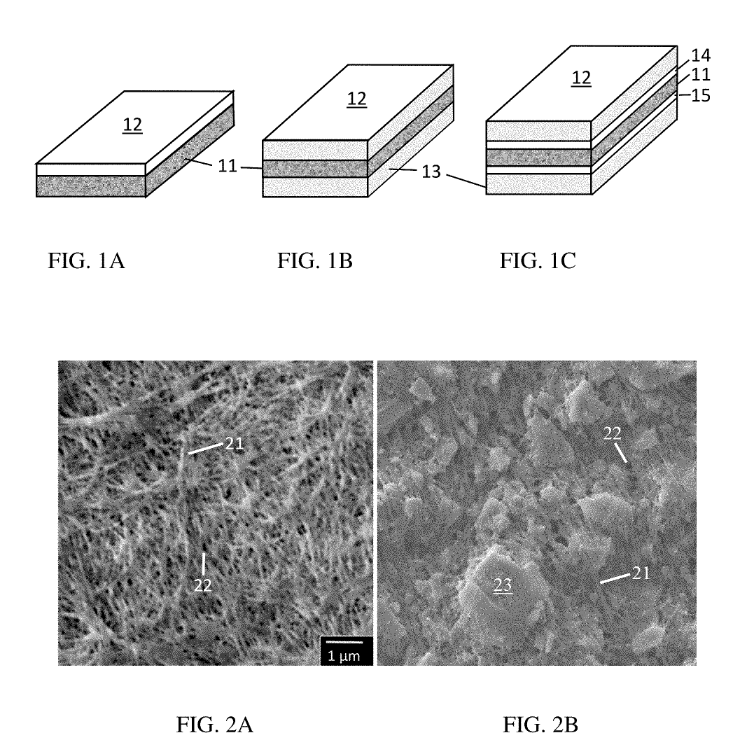

FIG. 1A shows an example of a two-layer film, consisting of a first layer 11 and a second layer 12 disposed on a side of the first layer 11. The two-layer structure may be depicted as B/A or A/B, i.e., the second layer 12 (B)/the first layer 11 (A). FIG. 1B shows an example of a three-layer film, further comprising a third layer 13 disposed on a side of the first layer 11 opposite the second layer 12, i.e., a three-layer structure of B/A/C. FIG. 1C shows an example of a five-layer film, further comprising a fourth layer 14 disposed between the first layer 11 and the second layer 12 and a fifth layer 15 disposed between the first layer 11 and the third layer 13, i.e., a five-layer structure of B/D/A/E/C. In some embodiments, the film has 3,000 layers or less constructed by alternately incorporating a recurring multilayer structure, e.g., . . . /(B/A)/(B/A)/(B/A)/ . . . or . . . /(B/A/C)/(B/A/C)/(B/A/C)/ . . . . The recurring multilayer structure may consist preferably of 9 layers or less, comprising further: A/B/A, B/A/B, B/C/A/B, A/C/B/A, B/C/A/C/B, A/C/B/C/A, B/C/A/D/E, or the like.

The innermost layer 11 is often termed as a core layer. The core layer may provide the foundation of a multilayer film structure, or serve as a monolayer film consisting essentially of the at least one layer. The core layer may have a thickness less than 1,000, 750, 500, 300, 100, 90, 80, 70, 60, 50, 40, 30, 20, 10, 5, or 3 μm; or in the range of 1 to 30, 30 to 60, 60 to 100, 100 to 300, 300 to 500, 500 to 750, or 750 to 1,000 μm; or in the range of 1 to 1,000 μm, preferably 1 to 500 μm, 1 to 300 μm, 1 to 100 μm, 1 to 50 μm, 1 to 30 μm, and 1 to 20 μm. The core layer may have a thickness of 1 to 100%, preferably 10 to 100%, 20 to 100%, and 30 to 100% of the total film thickness. A preferred core layer is highly resistant to heat, flame, solvent, puncture and degradation; ionically conductive; electronically insulative; or wettable to electrolytes. The core layer may provide high modulus and strength, low shutdown, adhesion, etc. The core layer may support adjacent layers, separate substrates, store species, or block permeating molecules.

The outermost layer, e.g., layer 12 or 13, is often termed as a skin layer. The skin layer may provide a desired function to the film. It may have the same matrix polymer as the core layer but differ in composition. The two skins may be the same or different in structure and composition. The skin layer may have a thickness of 0.01 to 99%, preferably 0.1 to 90%, 1 to 70%, and 1 to 50% of the total film thickness; or less than 0.1, 0.5, 1, 2, 3, 4, 5, 6, 7, 8, 9, 10, 15, 20, 30, 50, 100, or 200 μm; or in the range of 1 nm to 200 μm, preferably 10 nm to 100 μm, 50 nm to 50 μm, 100 nm to 25 μm, and 500 nm to 10 μm. Preferably, the skin layer is highly resistant to heat, flame, solvent, puncture and degradation; highly conductive to ion or current; highly polarizable, wettable; insulative; sorptive; adhesive; sealable; or the like. The skin layer may provide a high meltdown or low shutdown feature and a high modulus to suppress growth and penetration of Li or metal dendrites.

The intermediate layer, e.g., layer 14 or 15, is often termed as a tie layer. The tie layer may bond adjacent layers together. It may be composed of the same components, but at different ratios, as the core or skin layer, or preferably comprise at least one compatibilizer. The two tie layers may be symmetric or asymmetric in structure and composition. The tie layer may have a thickness of 0.01 to 99%, preferably 0.05 to 70%, 0.1 to 50%, and 1 to 30% of the total film thickness; or less than 0.1, 0.5, 1, 2, 3, 4, 5, 6, 7, 8, 9, 10, 15, 20, 30, 40, 50, 100, or 200 μm; or in the range of 0.01 to 200 μm, preferably 0.01 to 100 μm, 0.05 to 50 μm, 0.1 to 25 μm, and 0.1 to 10 μm. The tie layer may provide a low shutdown or high meltdown feature, a transition between layers, yield elastically, seal defects of the adjacent layers, or dissipate the applied stress. Preferably, the tie layer is highly resistant to heat, flame, solvent, puncture and degradation; conductive to ion or current; wettable; insulative, highly permeable, selective; highly polarizable; or etc.

FIGS. 2A and 2B show the SEM surface micrographs of an interconnecting pore structure for a typical wet PE separator film and a filled porous Example film. The surface layers of the films reveal a finely dispersed co-continuous multiphase morphology, characterized by a fibrous matrix 21 interconnected with a plurality of open pores 22; a dispersed particulate porogent 23; and a porosity of 40 to 70%.

### 2-1 Layer Composition

As defined hereinbefore, the terms “layer-forming composition” and “layer composition”, as used herein, refer to the composition of component materials to form: respectively, a nonporous layer of the precursor film and a porous layer of the final film. As also defined hereinbefore, the terms “wet and dry layer compositions” refer to the composition of the porous layer of the final film produced respectively from a “wet” and “dry” layer-forming composition. While the dry process may cause little changes in composition before and after processing, the wet process may yield substantial changes since the porogens and extractables are removed from the film during extraction.

In a preferred embodiment, each layer of the oriented porous film comprises: i) a matrix polymer of 5 to 100 wt. %; or less than 100, 95, 90, 80, 70, 60, 50, 40, 30, or 20 wt. %; and preferably in the range of 5 to 100 wt. %, more preferably 15 to 100 wt. %, and more preferably 30 to 100 wt. %; ii) a porogent material of 0 to 95 wt. %; or less than 95, 90, 80, 70, 60, 50, 40, 30, 20, 10, 5, or 1 wt. %; and preferably in the range of 0 to 5, 5 to 25, 25 to 50, 50 to 80, or 80 to 95 wt. %; iii) a compatibilizer of 0 to 95 wt. %; or less than 95, 90, 80, 70, 60, 50, 40, 30, 20, 10, 5, or 1 wt. %; and preferably in the range of 0 to 5, 5 to 25, 25 to 50, 50 to 80, or 80 to 95 wt. %; and iv) an additive of 0 to 20 wt. %; or less than 20, 15, 10, 5, 3, 2, or 1 wt. %; and preferably in the range of 0 to 15 wt. %, more preferably 0 to 10 wt. %, and more preferably 0 to 5 wt. %.

In certain embodiments, the core or inner layer of the film comprises the porogent material less than 50, 40, 30, 20, 10, 5, or 1 wt. %; and preferably in the range of 0 to 30 wt. %. In certain embodiments, at least one of the outer layers comprises the porogent material greater than 1, 5, 10, 20, 30, 40 or 50 wt. %; and preferably in the range of 1 to 95 wt. % and more preferably 30 to 95 wt. %. In certain embodiments, at least one of the outer layers comprises solid particles of 30 to 100 wt. %, preferably 40 to 100 wt. %, and more preferably 50 to 95 wt. %, the solid particles being inorganic and/or organic and characterized by a bulk density (dB) less than 5 g/cc; an average particle size (D50) of 1 to 1,000 nm; an average aspect ratio (Ra), i.e., a ratio of length (L) to thickness (t), less than 2,000; an average pore volume (Vp) less than 6.0 cc/g; a Brunauer-Emmett-Teller (BET) surface area (S_{BET}) less than 7,000 m²/g; or combinations thereof. The solid particles may be selected from the group consisting of the nanomaterials of sorbents, ionic conductors, NAs, compatibilizers, and combinations thereof.

In certain embodiments, at least one porous layer of the film comprises at least one porogen other than the immiscible polymer. In certain embodiments, the porogen and compatibilizer are the aforementioned solid particles. In certain embodiments, at least one porous layer of the film comprises at least one immiscible polymer selected in combination with the matrix polymer and the compatibilizer.

In some embodiments, at least one porous layer of the film comprises: a) the matrix polymer comprising polyester, PK or PA; b) the immiscible polymer comprising PP, COC, EVOH, PMP, PK, sPS, polyester, PA, PAEK, PAS, waxes, derivatives thereof, or combinations thereof; and c) the compatibilizer comprising the aforesaid copolymers or functionalized polymers, PI-type polymers, poly(ester-b-ether) (PEBE), poly(amide-b-ether) (PABE), the aforesaid solid particles, or combinations thereof. Preferred PI-type polymers are PEI.

In some embodiments, at least one porous layer of the film comprises: a) the matrix polymer of PAEK, PI-type polymers, or combinations thereof; b) the immiscible polymer comprising COC, PPS, PCT, LCP, PPA, derivatives thereof, or combinations thereof; and c) the compatibilizer comprising the aforesaid copolyesters or copolyamides, PI-type polymers, the aforesaid solid particles, or combinations thereof. A preferred PAEK is PEEK. Preferred PI-type polymers are PEI.

In some embodiments, at least one porous layer of the film comprises: a) the matrix polymer comprising fluoropolymers or PO; b) the immiscible polymer comprising PP, COC, EVOH, PMP, PK, sPS, polyoxymethylene (POM), polyester, waxes, derivatives thereof, or combinations thereof; and c) the compatibilizer comprising the aforesaid copolymers or functionalized polymers, the aforesaid solid particles, or combinations thereof.

### 2-2 Layer Structure

The oriented porous film may consist essentially of: i) a monolayer of the at least one layer, termed herein as an “A” layer; ii) two layers, i.e., B/A or A/B, comprising the A layer and a second layer (B); iii) three layers comprising a core layer and two skin layers, wherein a preferred layer structure is B/A/B or A/B/A having the two skin layers of the same composition; iv) four layers comprising a core layer, a tie layer (C) and two skin layers, wherein a preferred layer structure is B/C/A/B or A/C/B/A; or v) five layers comprising a core layer, two tie layers and two skin layers, wherein a preferred layer structure is B/C/A/C/B or A/C/B/C/A. A preferred multilayer structure may comprise the A layer as a skin layer.

The A layer constitutes the at least one layer of the film comprising the first polymer. The B and C layers comprise a matrix polymer selected from the group of the first and second polymers, the compatibilizer, and combinations thereof. The A and B layers differ preferably from each other in chemical and/or molecular structure of the matrix polymer or in layer composition. The C layer may preferably comprise at least one compatibilizer. The two skin or tie layers are preferably symmetric or identical in composition.

In some embodiments, the film is a monolayer consisting essentially of the A layer comprising the matrix polymer selected from the group consisting of polyester, PK, PAEK, polyimide (PI)-type polymers, fluoropolymers, polyarylene sulfide (PAS), polyarylsulfone, vinyl polymers, cellulose esters, polyamide (PA), β-PP, ionomers thereof, copolymers thereof, derivatives thereof, and combinations thereof. In a preferred embodiment, the matrix polymer of the monolayer film is the polyester, comprising polyethylene terephthalate (PET), polybutylene terephthalate (PBT), polytrimethylene terephthalate (PTT), polyethylene naphthalate (PEN), polybutylene naphthalate (PBN), polyethylene furanoate (PEF), polycyclohexylenedimethylene terephthalate (PCT), polycarbonates (PC), or combinations thereof.

In some embodiments, the A and B layers comprise the matrix polymer of polyester. The polyester present in one layer may be more crystalline, lower in Tm, higher in voiding efficiency, or comprises more porogens. In a preferred embodiment, the A layer comprises PTT, PBT, PTF, PBF, PTN, PBN, PCT, LCP, copolymers thereof, or combinations thereof; and more preferably PTT, PBT, PBN, PCT, copolymers thereof, or combinations thereof; while the B layer comprises PET, PEN, PEF, PETG, PET-co-CT, PC, copolymers thereof, or combinations thereof; and more preferably PET, PEN, PEF, copolymers thereof, or combinations thereof. In a preferred embodiment, the A layer comprises PET, PEN, PCT, LCP, copolymers thereof, or combinations thereof; more preferably PET, PCT, copolymers thereof, or combinations thereof; and the B layer comprises PLA, PTT, PBT, PEF, PTF, PBF, PTN, PBN, copolymers thereof, or combinations thereof; more preferably PTT, PBT, PEF, PBN, copolymers thereof, or combinations thereof.

In some embodiments, the A layer comprises the matrix polymer of polyester; and the B layer comprises the matrix polymer selected from the group consisting of PK, PAEK, PI-type polymers, PAS, fluoropolymers, PA, PO, and copolymers thereof. A preferred polyester is PET, PTT, PBT, PEN, PBN, PEF, PC, copolymers thereof, or combinations thereof. A preferred PO is PE, HDPE, UHMWPE, PP, iPP, β-PP, UHMWPP, β-UHMWPP, copolymers thereof, or combinations thereof. In a preferred embodiment, the A layer comprises PET, PTT, PBT, PEF, PEN, PBN, copolymers thereof, or combinations thereof; and the B layer comprises PK. In a preferred embodiment, the A layer comprises PET, PEN, PCT, copolymers thereof, or combinations thereof; and the B layer comprises PEEK, PEI, PPS, copolymers thereof, or combinations thereof; more preferably PEEK, PEI, copolymers thereof, or combinations thereof. In a preferred embodiment, the A layer comprises PET, PTT, PBT, PEF, PEN, PBN, copolymers thereof, or combinations thereof; and the B layer comprises PO comprising PP, UHMWPP, β-PP, copolymers thereof, or combinations thereof. In a preferred embodiment, the A layer comprises PET, PTT, PBT, PEF, PEN, PBN, copolymers thereof, or combinations thereof; and the B layer comprises PA comprising PA6, PA11, PA12, PA46, PA66, PA410, PA610, PA612, PA1010, PA1012, PA MXD6, PA9T, PA10T, PPA, PA6T/66, PA6T/DT, copolymers thereof, or combinations thereof. A more preferred PA is a long chain, renewable or less hygroscopic PA comprising PA11, PA12, PA410, PA610, PA612, PA1010, PA1012, PA MXD6, PA9T, PA6T/DT, copolymers thereof, or combinations thereof. In a preferred embodiment, the A layer comprises PET, PTT, PBT, PEF, PEN, PBN, copolymers thereof, or combinations thereof; and the B layer comprises fluoropolymers comprising PCTFE, ECTFE, ETFE, FEP, PFA, copolymers thereof, or combinations thereof; more preferably PCTFE, ECTFE, copolymers thereof, or combinations thereof.

In some embodiments, the A layer comprises the matrix polymer of PK; and the B layer comprises the matrix polymer selected from the group of PAEK, PI-type polymers, PAS, fluoropolymers, PA, PO, and copolymers thereof. In a preferred embodiment, the B layer comprises PEEK, PEI, PPS, copolymers thereof, or combinations thereof. In a preferred embodiment, the B layer comprises fluoropolymers comprising PCTFE, ECTFE, ETFE, FEP, PFA, copolymers thereof, or combinations thereof. In a preferred embodiment, the B layer comprises PA comprising PA6, PA11, PA12, PA46, PA66, PA410, PA610, PA612, PA1010, PA1012, PA MXD6, PA9T, PA10T, PPA, PA6T/DT, copolymers thereof, or combinations thereof; and more preferably PA12, PA612, PA1010, PA1012, PA MXD6, PA9T, PA6T/DT, copolymers thereof, or combinations thereof. In a preferred embodiment, the B layer comprises PO comprising HDPE, UHMWPE, PP, UHMWPP, β-PP, copolymers thereof, or combinations thereof.

In some embodiments, the A layer comprises the matrix polymer of PAEK; and the B layer comprises the matrix polymer selected from the group of PI-type polymers, PPS, PA, and PO. A preferred PAEK is PEEK. Preferred PI-type polymers are PEI. A preferred PA is PA46, PA66, PA9T, PA10T, PPA, PA6T/66, PA6T/DT, copolymers thereof, or combinations thereof. In a preferred embodiment, the A layer comprises PEEK; and the B layer comprises PEI, PPA, PA9T, PA6T/DT, copolymers thereof, or combinations thereof; and more preferably PEI.

In some embodiments, the A layer comprises the matrix polymer of PI-type polymers and preferably PEI, PI or combinations thereof; and the B layer comprises the matrix polymer selected from the group of PPS, fluoropolymers, PA, PO, and copolymers thereof. A preferred fluoropolymer is PCTFE, ECTFE, ETFE, FEP, PFA, copolymers thereof, or combinations thereof; and more preferably ETFE, FEP, PFA, or combinations thereof. A preferred PA is PA46, PA66, PA9T, PA10T, PPA, PA6T/66, PA6T/DT, copolymers thereof, or combinations thereof. In a preferred embodiment, the A layer comprises PEI; and the B layer comprises FEP, PFA, or combinations thereof.

In some embodiments, the A layer comprises the matrix polymer of PPS; and the B layer comprises the matrix polymer selected from the group of fluoropolymers, PA, PO, and copolymers thereof. A preferred PA comprises PA46, PA9T, PA10T, PPA, PA6T/66, PA6T/DT, copolymers thereof, or combinations thereof. A preferred fluoropolymer comprises FEP, PFA, or combinations thereof.

In some embodiments, the A layer comprises the matrix polymer of fluoropolymers comprising PCTFE, ECTFE, ETFE, FEP, PFA, copolymers thereof, or combinations thereof; and the B layer comprises the matrix polymer of PA, PO, or copolymers thereof. In a preferred embodiment, the A layer comprises PCTFE, ECTFE, or combinations thereof; and the B layer comprises HDPE, UHMWPE, PP, UHMWPP, β-PP, copolymers thereof, or combinations thereof. In a preferred embodiment, the A layer comprises ETFE, FEP, PFA, or combinations thereof; and the B layer comprises PA46, PA9T, PPA, PA6T/DT, or combinations thereof.

In some embodiments, the A layer comprises the matrix polymer of PA comprising PA6, PA11, PA46, PA66, PA410, PA610, PA612, PA1010, PA1012, PA MXD6, PA9T, PA10T, PPA, PA6T/66, PA6T/DT, copolymers thereof, or combinations thereof; and the B layer comprises the matrix polymer of PO comprising HDPE, UHMWPE, PP, UHMWPP, β-PP, copolymers thereof, or combinations thereof. A preferred PA includes PA11, PA410, PA610, PA612, PA1010, PA1012, PA MXD6, PA9T, copolymers thereof, and combinations thereof.

In some embodiments, the A and B layers comprise the matrix polymer of PA. The PA in one layer may be more crystalline, higher in Tm, less hygroscopic, or comprise more porogent materials. In a preferred embodiment the A layer comprises PA46, PA66, PA9T, PA10T, PPA, PA6T/66, PA6T/DT, copolymers thereof, or combinations thereof; more preferably PA9T, PPA, PA6T/DT, or combinations thereof; and the B layer comprises PA6, PA11, PA12, PA410, PA610, PA612, PA1010, PA1012, PA MXD6, copolymers thereof, or combinations thereof; more preferably PA11, PA12, PA410, PA612, PA1012, PA MXD6, or combinations thereof.

### 2-3 Film Properties

The oriented porous film of this disclosure may have a desirable range of properties, measured according to ASTM or test methods described hereinafter.

In some embodiments, the film has: i) a porosity 4) of 10 to 95%; or in the range of 10 to 30, 30 to 70, or 70 to 95%; and preferably in the range of 20 to 90, 25 to 85, or 30 to 80%; ii) an average pore diameter (dA) less than 5, 3, 2 or 1 μm; or in the range of 1 to 30, 30 to 100, 100 to 500, 500 to 1,000 nm, 1 to 2 μm, or 2 to 5 μm; or in the range of 1 nm to 5 μm, preferably 10 nm to 2 μm, and more preferably 20 nm to 1 μm; and iii) a Gurley air permeability (NG) less than 2,000, 1,500, 1,000, 900, 800, 700, 600, 500, 400, 300, 200, 100, or 50 sec/100 cc; and preferably in the range of 1 to 1,000 sec/100 cc, more preferably 5 to 750 sec/100 cc, and more preferably 10 to 500 sec/100 cc. The film may preferably have a greater 0.1), a smaller dA, a narrower pore size distribution and a lower NG, without adversely affecting the strength and overall performance.

In some embodiments, the oriented porous film comprises an asymmetric pore structure wherein at least one of the outer surfaces or layers has an average pore size characterized by a size ratio of 0.001 to 1,000 relative to that of an inner layer therein. The ratio (Rs) of the pore size, i.e., Rs=pore size (outer)/pore size (inner), may preferably range from 0.01 to 500, 0.05 to 100, and 0.1 to 10. A preferred outer surface may comprise smaller pores having the Rs less than 1, 0.1, or 0.01; or in the range of 0.001 to 1, preferably 0.01 to 1, and 0.1 to 1. The outer surface of small pores, when used as a separator of the cell, may preferably be disposed toward a negative electrode, in order to effectively suppress penetration of metal dendrites. In one embodiment, the outer surface has an average pore size of 1 to 500 nm, 5 to 100 nm, or 10 to 50 nm. The outer surface may be an outer skin layer, or a thin surface layer of the skin layer having a depth less than 5, 4, 3, 2, or 1 μm in the thickness direction. The thin surface layer may preferably have the depth or thickness of 0.1 to 1 μm. The inner layer can be an immediate inner layer, a core layer, or any layer formed therein due to the pore size difference in the thickness direction beyond the outer surface layer; and preferably it is the immediate inner or core layer.

In some embodiments, the oriented porous film has: i) a MacMullin number (N_{M}) less than 20, 15, 10, 8, 6, 5, 4, 3 or 2; or in the range of 1 to 20, 1 to 15, or 1 to 10; ii) a meltdown temperature (Tmd) greater than 180, 190, 200, 210, 220, 230, 240 or 250° C.; and preferably in the range of 180 to 400° C.; iii) optionally, a shutdown temperature (Tsd) less than 200, 180, 160, 150, 140, 130 or 120° C.; and preferably in the range of 100 to 180° C.; and iv) a thermal shrinkage ratio in the MD and/or TD less than 10, 7, 5, 4, 3, 2 or 1%; and preferably in the range of 0 to 10%, more preferably 0 to 5% and more preferably 0 to 3%, measured after aging the film at 150° C. for 1 hr. A lower N_{M} may indicate a higher ionic conductivity. A shrinkage ratio measured at 105° C.×8 hrs may be less than 5, 3 or 1%, and preferably 0 to 2%. The film may shrink less than 5% at temperatures up to 200° C.

In some embodiments, the oriented porous film has mechanical properties in the MD and/or TD: i) a tensile strength (S_{T}) at break greater than 10, 20, 30, 50, 60, 70, 80, 90, 100, 110, 120 or 150 MPa; or in the range of 10 to 30, 30 to 50, 50 to 70, 70 to 100, 100 to 150, 150 to 200, or 200 to 300 MPa; or in the range of 10 to 450 MPa, preferably 20 to 400 MPa, more preferably 30 to 350 MPa, and more preferably 50 to 300 MPa; ii) an elongation at break greater than 10, 20, 30, 50, 70, 90, 100, 120 or 150%; and preferably in the range of 10 to 500% and more preferably 20 to 300%; iii) an elastic modulus (Ey) greater than 0.1, 0.2, 0.3, 0.5, 1, 1.5, 2, 3, or 5 GPa; and preferably in the range of 0.1 to 10 GPa, more preferably 0.3 to 7 GPa, and more preferably 0.5 to 5 GPa; and iv) a puncture strength (S_{P}) greater than 100, 200, 300, 400, 500, 600, or 1,000 gf; or in the range of 100 to 3,000 gf, preferably 150 to 2,000 gf, 200 to 1,500 gf, and 300 to 1000 gf. The film may have a S_{T} ratio of the MD to the TD in the range of 0.1 to 10, preferably 0.3 to 7, more preferably 0.5 to 5, and more preferably 0.7 to 3.

In some embodiments, the oriented porous film retains the initial activities or functionalities, such as intrinsic porosity, ionic conductivity, nucleability, sorbability, wettability, polarizability, reactivity and etc., of the solid particles inclusions in the range greater than 30, 40, 50, 60, 70, 80, 90, or 95%; and preferably in the range of 50 to 100, 60 to 100, 65 to 100, 70 to 100, 80 to 100, 85 to 100, 90 to 100, and 95 to 100%. For example, as described hereinafter, the recovery (Rφ) of particles' intrinsic porosity present in the film may be computed by measuring porosity changes before and after processing.

### 3. Process of Film Manufacture

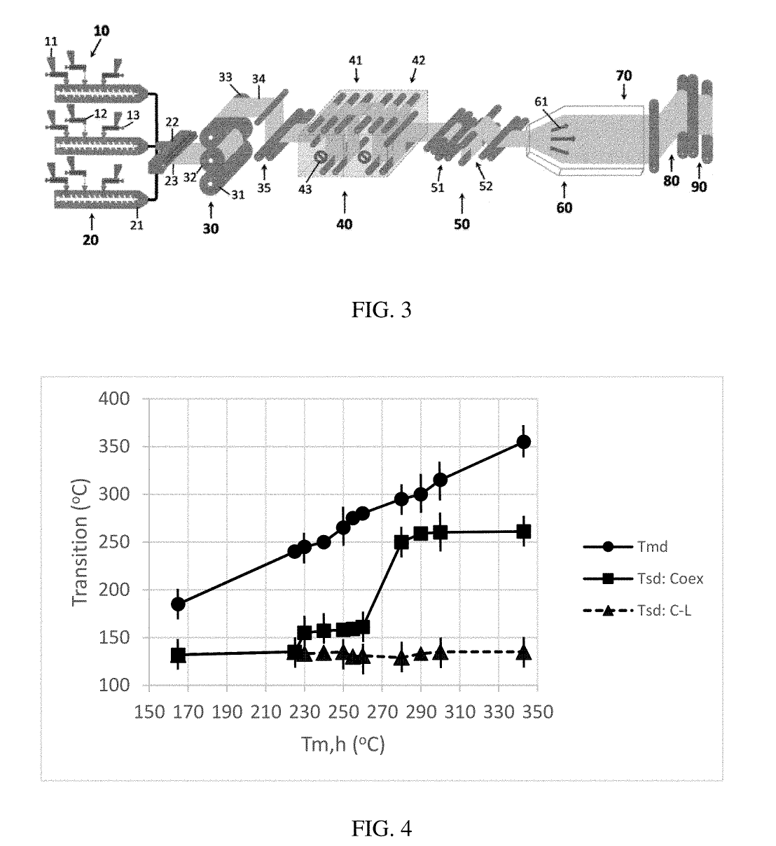

FIG. 3 illustrates one embodiment of a wet coextrusion film process, comprising: a feeding system 10, to feed raw materials into extruders; a coextrusion process 20 consisting of one main and two satellite extruders 21, to mix homogeneously the fed materials; a casting unit 30, to form a sheet of desirable thickness and morphology; an extractor 40, to remove diluents out of the sheet and to dry an extracted sheet; orienters 50 and 60, to stretch the dried sheet in the MD and TD; and a heating zone 70, to anneal and relax the stretched film. Alternatively, the extraction 40 can be carried out after the MD orientation (MDO) 50 or the TD orientation (TDO) 60. The stretched film may further be stretched 70 in the MD and/or TD; then annealed while relaxing; wound 90; and then, slit into a desirable dimension. A dry process is essentially the same as the wet process, except that the former has no extraction units 40. Although not shown in FIG. 3, the film line may further comprise in-line treaters, coaters, laminators, thin film deposition processes and the like, as taught by the present inventors in their U.S. Pat. Nos. 7,713,636, 8,142,893, and 8,557,919.

The production line speed may have a significant impact on stability, structure and properties of the resulting film. The film line may run up to 1,000 m/min. A higher line speed is preferred for higher productivity. The wet and dry processes may preferably run at a speed less than 200 and 500 m/min, respectively. A preferred wet process is to biaxially stretch the sheet simultaneously in the MD and TD; then extract and dry the stretched film; further stretch the dried film in the MD and/or TD; and then anneal the film while relaxing in the MD and/or TD. A preferred dry process is to biaxially stretch the sheet sequentially in the MD and TD; and then anneal the film while relaxing in the MD and/or TD.

### 3-1 Feeding of Raw Materials

Before being fed into extruders 21, hygroscopic raw materials may be dried to a proper level of moisture, preferably below 100 ppm of moisture. The raw materials may be pre-blended in a group and then fed into the extruders with multiple feeders 11-13. The raw materials may also be compounded into master batches prior to the feeding. Solid feedstocks may be fed into the extruders with a main feeder 11. Liquid feedstocks can be pre-heated and then injected downstream into a kneading section with a second feed 12, a third feeder 13, or both. The second and third feeding systems may preferably have a side feeding unit.

### 3-2 Coextrusion

The fed raw materials are dissolved at elevated temperatures and mixed homogeneously within an extruder. The melt is then extruded through a flat-film or tubular die. Preferred is to convey the melt into a flat-film die 22, such as a T-die or a coathanger die, through a manifold, multimanifolds, a feedblock, or combinations thereof. A coextrudate consisting of multiple thousand microlayers can be produced via a layer multiplying die or a suitable feedblock/die system. Extrusion conditions are set in a way of ensuring a homogeneous mixing of fed materials, while not excessively degrading any component. A monolithic or monolayer extrudate can be produced with a single extruder or by coextruding the same composition with multiple extruders. Preferably, the multilayer structure is constructed in a continuous manner with coextrusion, in-line coating, in-line lamination, or combinations thereof. Alternatively, offline lamination and coatings may be employed.

The extruders may be a single or multiple screw extruder having multiple feed ports downstream along the machine. A twin screw extruder is preferred, having a length (L) to diameter (D) ratio (L/D) greater than 20, 30 or 40; or in the range of 20 to 100 and preferably 30 to 70. The twin screw extruder may have co- or counter rotating screws, having a series of intense mixing and kneading sections downstream along the screws. The coextrusion process may adopt a tandem extruder, consisting of two or more single and/or twin screw extruders. A preferred extruder may readily yield a homogeneously mixed melt at a high output rate.

### 3-3 Sheet Casting

A coextrudate 23 issuing out of the flat-film die is cast onto a roll 32 to cool the melt into a multilayer sheet 34. In general, the rate and degree of cooling play an important role on formation of the sheet morphology. For a given composition, the cooling rate may be controlled primarily by sheet profile, process conditions, and intimacy of contact between sheet and roll. The cooling system 30 may employ a series of roll stacks 31-33, an air knife, a wet bath, an underwater cast, and/or any additional means, for a better control of sheet temperature and thickness. A calendar stack 35, consisting of multiple rolls configured to have a gap decreasing with each successive pass, may be separately installed after the casting unit 31-33, to facilitate the forming and densifying processes.

The cast roll 32 may be set chill or hot, below or above 100° C., depending on types and target properties of the extrudate. A lower roll temperature may create smaller crystals or pores, i.e., a denser skin, on the roll than opposite side; it may also help prevent liquid components oozing out of the extrudate. In one embodiment, the cast roll is set to a temperature below 100, 80, 60, 40, 20, 10, or 0° C.; or in the range of −20 to 100° C. A higher roll temperature, on the other hand, may create bigger crystals and polymorphs, i.e., a coarser skin, on the roll side. In another embodiment, the cast roll is set to a temperature greater than 100, 110, 120, 130, 150, or 170° C.; but less than 250° C. The extrudate may reside on the cast roll for a period of 1 sec to 10 min, 2 sec to 5 min, and preferably 5 to 100 sec. A preferred cast condition for a PP sheet comprising a β-NA (β-PP) is the residence time of 2 sec to 10 min, preferably 5 sec to 5 min, and the roll temperature of 100 to 150° C., preferably 110 to 140° C., to facilitate β-crystal nucleation. The cast duration may be adjusted with dimension and array of the rolls, line speed, or any other suitable means.

The extrudate upon exiting the die may be immersed into a wet bath containing a liquid or its mixtures to promote cooling or phase separation. In one embodiment, the cast unit is equipped with one or more wet baths. A preferred liquid is low in solubility of the matrix polymer, comprising water, alcohol, ethylene glycol, glycerol, ketone, hydrocarbon, ether, amide, pyrrolidone, ester, or combinations thereof. More preferred are water, and its mixtures comprising water less than 99 wt. %. The wet bath may further contain an effective amount of a swelling agent or an organic salt. The bath may keep at a temperature below 100° C.

### 3-4 Extraction

For a wet film, extraction of the porogens can be carried out at any stage after cooling of the extrudate, e.g., immediately after the casting 30, the MDO 50, the TDO 60, or the simultaneous biaxial orientation 60. Preferably, the extraction is carried out after the MDO 50 or TDO 60 but prior to winding 90. The extractables may comprise diluents, solid particles, or polymeric porogens. In one embodiment, the extractables are the diluents. The porogens may be extracted at a temperature lower than the Tm or Tf of the matrix polymer, by passing the film onto a series of guide rolls located in the washing 41 and rinsing stage 42 inside the extractor 40 that is filled with an extractant. Any extraction method suitable or known in the art can be employed, e.g., such as evaporation, dipping, countercurrent flow, showering, washing or combinations thereof. The spent diluents, porogens, or extractants may be recycled similarly to those described in U.S. Pat. Nos. 4,648,417 and 5,772,935.

In some embodiments, the extractor 40 is a countercurrent flow apparatus, comparted into washing and rinsing sections into which a fresh extractant enters counter to the MD to strip off the diluent from the film surface. In some embodiments, the extractor 40 is equipped with an ultrasonic extraction unit (USE) comprising a high-power sonicator 43. The sonicator may produce an ultrasonic frequency of 10 kHz to 1 GHz and preferably 20 kHz to 20 MHz. The sonic horn 43 may employ a piezoelectrically activated ultrasonic transducer, to be located on the top area of the extractor 40. In some embodiments, the extractor 40 consists essentially of a supercritical fluid extractor (SFE) that runs around or beyond the supercritical conditions of an extractant, wherein the extractant is in a subcritical, supercritical, or liquid state. A preferred supercritical extractant is carbon dioxide (CO₂) under or above 31.3° C. and 7.38 MPa.

In a preferred embodiment, the extractor 40 is equipped with both USE and SFE that employ a supercritical CO₂ extractant. The extraction may be carried out by a batch or semi-continuous manner that enables a substantial increase of the film line speed. The batch or semi-continuous extractor may be equipped with USE, SFE, or both.

### 3-5 Film Stretching

The cast sheet is stretched sequentially in the MD 50 with a series of slow and fast rolls 51-52 and in the TD 61 with a tenter frame 60; or simultaneously in the MD and TD 60. The simultaneous process may not need the MDO unit 50. The stretching can be carried out in a single or multiple steps at any desirable ratio and rate in each step. The stretched film is then annealed, relaxed, cooled, or can be further stretched 70 in the MD, TD or both. The MDO unit 50 may consist of preheating, stretching, annealing and cooling zones. An in-line coating or lamination may be applied onto the MDO film 50. Similarly, the TDO unit 60-70 may consist of preheating, stretching, cooling, annealing, and drying zones. The MDO and TDO temperatures may be controlled by heated rolls, hot air, electric and infrared heaters, or combinations thereof. Preferred include the infrared heaters, which may be installed at a distance of 5 to 50 mm above and/or below the film in the MDO and/or TDO units. The stretching processes and conditions are critically important in controlling not only structure and interconnectivity of the pores but also the overall productivity and performance of the final film.

The MDO and TDO temperatures may range anywhere from room temperature to Tm or a flow temperature (TO of the matrix polymer. A lower stretch temperature may create more interconnecting pores. A large difference in stretch temperature across the film may accordingly create an asymmetric pore structure, e.g., a denser skin on one side than the other side. Preferred is an asymmetric pore structure. Preferred is a denser skin on one or both sides of the oriented film. The MDO and TDO ratios each may be less than 15 or 10, defined as MDX=La/Lb and TDX=Wa/Wb, wherein L and W are respectively the film length and width, and a and b denote respectively after and before stretching. The MDO and TDO rates may range anywhere from 50 to 500,000%/min; or 50 to 1,000, 1,000 to 5,000, 5,000 to 10,000, 10,000 to 50,000, or 50,000 to 500,000%/min. The stretch rates can be calculated with Eq. 1 and Eq. 2 below:

$$\begin{matrix}MDO Rate ( \% \text{/} min ) = \frac{MDX - 1}{\sum \frac{d}{{S}_{F}}} 100 & ( Eq . 1 ) \\ TDO Rate ( \% \text{/} min ) = \frac{TDX - 1}{L / {S}_{L}} 100 & ( Eq . 2 )\end{matrix}$$

wherein d is the gap of stretching rolls; S_{F} is the speed of a fast speed roll (m/min); L is the TDO zone length; and S_{L} is the line speed. A lower stretch rate may increase a mean pore size and porosity at the cost of productivity. The stretch rates may be adjusted by controlling the roll gap and the speed and width of the film line.

The stretched film may be annealed around the stretch temperature or higher by up to 200° C., while being relaxed in the MD and/or TD. The relaxation can be done more than once at any stage during or after stretching, to improve dimensional stability; but it may adversely affect tensile modulus and strength of the resultant film. The film may thus be relaxed preferably around the annealing temperature once in the MD after MDO and once in the TD after TDO, both at a relaxation ratio less than 30, 20, or 10%. The relaxation ratio (ε, %) is defined: £ (MD)=100×(Sb−Sa)/Sb and ε (TD)=100×(Wb−Wa)/Wb, wherein S and W is respectively the film speed and width, and a and b denote respectively after and before relaxation. In a preferred embodiment, the MDO and TDO are carried out in two or more steps at conditions comprising a lower temperature, a higher ratio, a higher rate or combinations thereof, in light of productivity, structure, and properties of the resultant film.

### 3-6 Residual Removal

The extracted film can be dried by passing it through a forced air dryer. Although not shown in FIG. 3, the air dryer can be installed immediately after the extractor 40. The drying can remove substantially all residual diluents and extractants out of the film. The drying may be carried out, alternatively or additionally, inside the tenter frame using part 70 of the heating zone. The drying temperature can be set to around or below Tm or Tf of the matrix polymer. For multicomponent matrix polymers, the drying temperature may be determined by the lower Tm of the component polymers or the Tm of the major component. The dried film may be re-dried or activated prior to use.

In one embodiment, the oriented porous film contains substantially no residual diluents and extractants. The residual diluent may be present in the film less than 3, 2, 1, 0.1, 0.01, 0.001, or 0.0001 wt. %; or in the range of 0 to 1 wt. %, preferably 0 to 0.1 wt. %, and more preferably 0 to 0.01 wt. %. The oriented porous film may contain a residual extractant less than 100, 10, 1, 0.1, or 0.001 ppm; or in the range of 0 to 10 ppm (parts per million) and preferably 0 to 0.1 ppm. The content of the residual solvent may be determined according to EPA Method 8260 B.

### 3-7 Treatment and Coating

At least a portion of at least one of the outer surfaces of the oriented porous film may be treated at any stage during manufacture, to provide surfaces with chemical species or high energy for crosslinking, coating, lamination, deposition and the like. The surface treatment may be carried out according to any method suitable or known in the art, such as corona discharge, plain and polarized flame treatment, plasma treatment, chemical treatment, radiation treatment, grafting, polymerization, or combinations thereof.

The coating may provide a desired function, e.g., such as heat and solvent resistance, low shutdown, conductivity, permittivity, stability, wettability, adhesion, barrier, reaction, selectivity, sorption, separation, permeation, sealability, printability, protection, transition, or combinations thereof. Preferred include low shutdown, high meltdown, permittivity, conductivity, or protection against dendrites. The coating may be applied with any means convenient or known in the art, e.g., such as roll coating, gravure coating, die coating, extrusion coating, spraying, dipping, solution casting, deposition, and the like. The applied coating may be dried by hot air, radiant heat, or any other convenient means. The film may preferably be in-line coated and/or crosslinked during any stage between the casting 30 and winding 90 processes.

In some embodiments, at least a portion of one or both outer surfaces of the porous film is coated once or more with at least one primer and/or at least one polymer, e.g., as described in U.S. Pat. Nos. 3,753,769, 4,058,645, 4,439,493, and 7,713,636. The coatings may have a thickness less than 20, 15, 10, 5, 1, or 0.1 μm; or in the range of 0.01 to 20 μm, preferably 0.05 to 10 μm, and more preferably 0.1 to 5 μm. In other embodiments, the coatings have a thickness of 0.1 to 10 nm, 10 to 100 nm, 100 to 500 nm, or 500 nm to 1 μm. A thin or ultrathin coating may be obtained via physical (PVD) and/or chemical vapor deposition (CVD), e.g., such as thermal or electron beam evaporation, sputtering, reactive PVD, low or atmosphere-pressure CVD, plasma-enhanced CVD, metal-organic CVD, atomic or molecular layer deposition, and etc.

In some embodiments, the coated films comprise at least one oriented porous film of this disclosure comprising the matrix polymer having Tm greater than 180, 200 or 220° C.; and at least one coating comprising a PO-based binder greater than 50, 60 or 70 wt. %; or in the range of 50 to 100 wt. % based on the total weight of the dry coating. In some embodiments, the coated films comprise at least one oriented porous film of this disclosure comprising the matrix polymer having Tm less than 180, 170, 150, or 140° C.; and at least one coating comprising the aforesaid solid particles greater than 50, 60 or 70 wt. %; or in the range of 50 to 100 wt. %.

### 3-8 Lamination

The porous film may be laminated to each other or to other substrates comprising nonwovens. The lamination can be conveniently done by any suitable or known method including, e.g., adhesive lamination, extrusion lamination, impulse and ultrasound bonding, heat and pressure technique, etc. Preferred is the heat and pressure technique. In some embodiments, the laminate comprises at least one oriented porous film of this disclosure comprising the matrix polymer having a Tm greater than 180, 200 or 220° C., bonded thermally to a PO-based porous film or nonwoven.

The lamination may be carried out by passing two or more porous films under pressure between pairs of heated rolls or pairs of a heated roll and a plate. An embossed or flat roll may be employed. The process conditions may not be critically important, as long as the laminate develops a proper level of peel strength greater than 50 g/cm, measured according to the procedure disclosed, e.g., in U.S. Pat. Nos. 7,713,636 and 8,142,893. The lamination temperature may be 5 to 100° C. below Tm or Tf of the matrix polymer. The lamination pressure may range anywhere from 0.1 to 100 MPa or 1 to 50 MPa. If desired, the laminate can further be calendered under the similar process conditions.

### 4. Industrial Application

The oriented porous film of this disclosure finds a wide variety of divergent utility as a product or as a component and substrate of an article for application in energy harvesting and storage, filtration, separation and purification of gases and fluids, CO₂ and volatile capture, electronics, devices, structural supports, packaging, labeling, printing, clothing, drug delivery systems, bioreactor, and the like. The porous film may thus be termed, described or recited differently, e.g., such as membrane, film, filter, separator, support, and etc., depending on properties and/or applications where it is used.

Preferably, the porous film of this disclosure is used as a separator of energy storage devices, to provide an electrochemical cell with superior performance in safety, capacity, rate capability, reliability, life cycle, and the like. Examples of such devices may include, but not limited to, primary and secondary batteries, Li-ion and Li-sulfur batteries, Li- and metal-air batteries, alkaline batteries, nonaqueous electrolyte batteries, capacitors, supercapacitors, fuel cells, and the like.

### EXAMPLES

The oriented porous films of the present invention are further described below with reference to the nonlimiting examples. The Example films were characterized by the following test methods.

### 1. Test Method

Particle Properties: Mastersizer 3000 of Malvern Instrument was used to measure an average particle size and a particle size distribution of the raw materials. The intrinsic porosity of particulate materials were measured according to ASTM D 6556 with a nitrogen adsorption porosimetry (Micromeritics ASAP 2020), by characterizing a pore volume, a pore size distribution and a Brunauer-Emmett-Teller surface area (S_{BET}). The recovery (Rφ) of particles' initial porosity incorporated into the film was calculated via Rφ (%)=(φₐ/φ_{b})×100, wherein φₐ and φ_{b} are respectively the particle porosities after and before processing.

Thickness (t, μm): The average thickness of the film was measured by a caliper and a dial gauge thickness meter at 1 cm interval along the MD and TD of a 10 cm×10 cm specimen. Five measurements on each film sample were averaged. The dial gauge thickness meter had a resolution of 1 μm with a maximum reading error 3 μm. An optical microscopy and a scanning electron microscope were also used to measure the overall and layer thicknesses of the samples.

Porosity (φ, %): The film porosity was measured by measuring the specimen density: φ=100×(d_{O}−d_{M})/d_{O}, wherein d_{O} and d_{M} are respectively the calculated and measured density. The specimen density was measured by measuring the specimen yield and volume. Yield is the measure of the specimen coverage per unit weight, measured according to ASTM D 4321. The volume and size of the interconnecting pores were also measured according to the mercury intrusion method.

Pore Size (S_{P}, μm): The pore size of the film was measured with a PMI porometer according to ASTM F 316-03 of the bubble point and mean flow path test. The pore size of each film layer was measured with SEM and an image analysis.

Gurley Air Permeability (NG, sec/100 cc): The air permeability of the film was measured according to ASTM D 726-58. The Gurley number is a time required for 100 cc of air to pass through a specimen area of 6.45 cm² at a pressure of 3.04 kPa. When the porosity and thickness of the specimen are fixed, the NG is then to measure the tortuosity of a porous structure.

Phase Morphology: The micrographic images of scanning electron microscopy (SEM) were taken with Jeol JSM 6400. Fresh cross-section surfaces were prepared by freeze fracturing the specimen perpendicular and parallel to MD at −130° C. using liquid nitrogen. The fresh surfaces were subsequently coated with platinum, and the images were then taken at an acceleration voltage of 25 KV. The SEM images were used to measure the morphology and dimensions of the continuous and disperse phases.

Crystallinity (Xc, %): The relative amount of the β-crystal (Xβ) present in a β-nucleated PP cast sheet or layer was measured by wide angle X-ray diffraction (WAXS) and DSC. A diffraction peak at 2θ around 16° in a WAXS diffractogram is assigned to the (300)β reflection and used to compute the β-crystallinity: Xβ (%)=100×Iβ/[Iβ+(Iα₁+Iα₂+Iα₃)], wherein Iβ is the intensity of the (300)β peak; and Iα₁, Iα₂ and Iα₃ are respectively the intensities of the (110)a, (040)α and (130)α peaks. In a DSC thermogram, on the other hand, the α and β melting peaks occur respectively around 160 and 140° C. The relative content of the β-crystal was thus calculated: Xβ (%)=100×ΔHβ/(ΔHβ+ΔHα), wherein ΔHβ and ΔHα are respectively the heats of fusion for the α and β crystals.

Tensile Properties: Tensile modulus (Ey, GPa), strength (σ, MPa) and elongation (%) were measured in the MD and TD with an Instron 4400 machine in accordance with ASTM D 882. An average of five measurements on each sample was reported.

Puncture Strength (S_{P}, gf): The puncture strength of the film was measured with an Instron universal tester at a crosshead speed of 500 mm/min. The puncture pin used was 1.9 mm in diameter. The puncture force was obtained in unit of gram force (gf).

Shrinkage Ratio (%): The heat shrinkage ratios in the MD and TD were measured after exposing the film for 1 hour at temperatures of 90 to 200° C. in a hot air oven. An averaged value of three measurements was used.

Shutdown Temperature (Tsd): The impedance of a cell was measured with an alternating current (5 mV) of 1 kHz. The cell, consisting of a separator placed between two graphite electrodes and soaked with an electrolyte of 1M LiPF₆ solution in a mixture of 1/1/1 vol. % ethylene carbonate (EC)/dimethyl carbonate (DMC)/ethyl methyl carbonate (EMC), was heated from 25 to 400° C. at a rate of 5° C./min. The shutdown temperature was defined as a temperature at which the electrical resistance increased abruptly from a few ohm (Ω) to several thousand Ω.

Meltdown Temperature (Tmd): A thermomechanical analyzer (TMA) of TA Instruments Q800 DMA was used to measure the length change of a film according to the NASA method NASA/TM-2010-216099. The film of 10×3 mm in the MD and TD was held with a constant 0.02 N load, while ramping up the temperature at a rate of 5° C./min from 30 to 400° C. The film was shrunk initially and then elongated abruptly. The meltdown temperature was defined as a temperature at which the film ruptured.

MacMullin Number (N_{M}): The MacMullin number measures a ratio of the specific conductivities between an electrolyte-soaked separator (C) and the free electrolyte (C_{O}), i.e., N_{M}=C/Co. The C is calculated according to Ohmic Law: C=t/(R×A), wherein t is the thickness, R the resistance and A the tested area of the separator. Electrochemical impedance spectroscopy (EIS) was used to measure the cell resistance by using a 2016 coin cell with Li metal electrodes and an electrolyte of 1 M LiPF₆ solution in a mixture of 1/1/1 vol. % EC/DMC/EMC. The bulk conductivity (C_{O}) of the electrolyte was 8.5±0.5 mS/cm.

### 2. Feedstock Material

The raw materials used for the Examples were all commercially available products. TABLE 1 gives the density (ρ), Tg and Tm of the polymers used. For polymers having multiple transitions, the highest Tm or Tg value was presented. The polymers used included HDPE, UHMWPE (UPE), PP, polyester, poly(ester-b-ether) (PEBE), PA, poly(amide-b-ether) (PABE), PK, PEEK, PEI and PCTFE. Master batches of maleated PP (m-PP), m-PVDF, and β-PP comprising a calcium suberate as a β-NA were produced, which all then let down to the final concertation of 0.2 wt. %. Bio-based renewable polymers used were HDPE, PP, PTT, PEF, PA410 and PK.

TABLE 1

| Polymer | ρ (g/cc) | Tg (° C.) | Tm (° C.) |
|---|---|---|---|
| HDPE | 0.95 | −100 | 135 |
| UHMWPE | 0.9 | 0 | 165 |
| PP | 0.9 | 0 | 165 |
| m-PP | 0.9 | 0 | 165 |
| PET | 1.4 | 77 | 255 |
| PTT | 1.32 | 65 | 230 |
| PBT | 1.31 | 60 | 225 |
| PEF | 1.43 | 88 | 240 |
| PCT | 1.23 | 90 | 290 |
| LCP | 1.4 | / | 280 |
| PEBE | 1.28 | 50 | 225 |
| PA66 | 1.14 | 65 | 260 |
| PA9T | 1.17 | 125 | 300 |
| PA410 | 1.05 | 70 | 250 |
| PABE | 1.15 | / | 205 |
| PK | 1.24 | 20 | 230 |
| PEEK | 1.3 | 145 | 343 |
| PEI | 1.28 | 225 | / |
| PCTFE | 2.15 | 45 | 210 |

The porogent materials used included: i) immiscible polymers of m-PP, LCP, HDPE, and PEEK; ii) porogent particles and fibers of SiO₂, mesoporous SiO₂ (m-SiO₂), mesoporous silicate MCM-41, cellulose nanocrystals (CNC), cellulose nanofibers (CNF), ZSM5, zeolite 13X, Al₂O₃, and Ba₂SO₄; iii) β-NA of Ca suberate, and iv) diluents of vegetable oil (VTO), N,N-dimethyl-9-decenamide (DMDA), diphenyl sulfone (DPS), liquid paraffin (LP), dibutyl phthalate (DBP), and polycaprolactone (PCL). The porogent particles had an average particle size of 0.5 to 1 μm, a porosity of 0.2 to 1.5 cc/g, a BET specific area of 50 to 1,300 m²/g, and a bulk density of 0.1 to 0.7 g/cc. The CNF was 50 nm thick and 1,000 nm long. The VTO was a genetically modified high oleic soybean oil, having 80% oleic acid and an oxidation stability index (OSI) greater than 60 hours. The bioporogens were CNC, CNF, VTO, DMDA, and PCL.

### 3. Film Processing

The Example films were produced with a coextrusion film line equipped with three co-rotating twin screw extruders (TSE). The main TSE had 25 mm screws of a 40 L/D, and two satellite TSEs had 16 mm screws of a 35 L/D. Prior to extrusion, hydrophilic polymers and additives were dried at 50 to 200° C. for about 5 hrs to a moisture level below 100 ppm. The extrusion and stretching conditions were adjusted as required for each Example, according to properties of the layer-forming compositions. The TSEs ran at 200 to 400° C. and 100 to 1,500 rpm with a total output of 5 to 30 Kg/hr. A monolayer film was produced with the main TSE, while a multilayer film with the main and satellite TSEs.

The powder feedstocks of polymers, porogens and additives were pre-blended with a tumbler mixer. The pre-mixture or individual powder components were then metered into the TSE with the main feeder. For the wet composition, the diluent was heated up to 150° C. and then injected into the extruder downstream via the side-feed port located prior to the first kneading section. Extrudates issuing out of the 25.4 cm wide flat-film die were cooled into a sheet on the cast roll set at 0 to 100° C., or at 100 to 150° C. for β-PP. A wet bath set at 10 to 100° C. was additionally used for some Examples, to aid cooling or coagulation. The bath composition was a water/alcohol mixture of 100/0 and 80/20 wt. %, depending on layer-forming compositions.

The cast sheet was stretched at 30 to 150° C. in the MD by 3 to 7 times and then relaxed by 5 to 10% around the MDO temperature. Subsequently, the MDO film was stretched at 100 to 250° C. in the TD by 3 to 10 times. The biaxially stretched film containing a wet layer was then extracted with CH₂Cl₂ to remove substantially all the diluents, followed by drying and further stretching in the TD around the TDO temperature by up to 2 times. However, the dry film consisting of all dry layer-forming compositions were neither extracted nor stretched secondly after the first TDO. The porous films were then annealed around the TDO temperature, while relaxing at a ratio below 10% in the TD.

Some Example films were extracted with supercritical CO₂ under the high-power sonicator running at 20 kHz. The extraction procedure was: i) a 20×20 cm diluent-laden film sample was placed inside a 1.5-liter vertical stirred high-pressure vessel and charged with 700 ml supercritical CO₂ at 50° C. and 10 MPa; ii) subsequently, the sample was extracted for 30 min and repeated once; and then iii) the extracted film was removed from the vessel and dried for 30 min at 100 to 200° C. in a hot air oven.

### Examples 1-12

TABLE 2 shows the layer structure, composition and thickness of Examples (EX) 1-12. The EXs 1-12 films were all a monolayer film with a thickness of 6 to 15 μm. EXs 1-2 had a bio-based composition, respectively a wet and dry film of HDPE/UHMWPE (UPE) and β-PP/HDPE blends. EXs 3-12 all had the first polymer as a matrix with Tm≧200° C. EXs 3-7 were a dry film containing immiscible polymers and nanosorbents, while EXs 8-12 were a wet film produced from various diluents.

TABLE 2

| | Composition | | | | Gage |
|---|---|---|---|---|---|
| EX | Layer | Matrix (M) | Porogen (P) | M/P (wt %) | (μm) |
| 1 | A | HDPE/UPE | VTO | 21/9/70 | 6 |
| 2 | | β-PP | HDPE | 85/15 | 15 |
| 3 | A | PET | m-PP/MCM-41 | 75/20/5 | 15 |
| 4 | | PET | LCP/CNC | 70/15/15 | 12 |
| 5 | | PEF | m-SiO₂/HDPE | 60/30/10 | 15 |
| 6 | | PA9T | PEEK/ZSM5 | 75/15/15 | 10 |
| 7 | | PK | m-PP/13X | 70/15/15 | 12 |
| 8 | A | PET | VTO/Al₂O₃ | 30/60/10 | 6 |
| 9 | | PTT | VTO | 40/60 | 10 |
| 10 | | PA410 | DMDA | 40/60 | 6 |
| 11 | | PEEK/PEI | DPS/Ba₂SO₄ | 28/7/60/5 | 8 |
| 12 | | PCTFE | LP/UPE | 30/60/10 | 12 |

TABLE 3 shows the properties of the Example films, i.e., porosity (φ), average pore size (dA), Gurley number (N_{G}), MacMullin number (N_{M}), tensile strengths (S_{T}) in the MD and TD, and puncture strength (S_{P}). Overall, the EX 1-2 films showed good and balanced properties, i.e., a suitable pore structure, and high S_{T} and S_{P}, despite a high N_{M} due to the PO matrix. The films also had high productivity and convertibility over the existing uniaxial separator films. The EXs 3-12 films had significantly better properties, i.e., a suitable pore structure, high S_{T} and S_{P}, and low N_{M}.

TABLE 3

| | φ | d_{A} | N_{G} | | S_{T} (MPa) | | S_{P} |
|---|---|---|---|---|---|---|---|
| EX | (%) | (nm) | (sec) | N_{M} | MD | TD | (gf) |
| 1 | 55 | 51 | 250 | 11.5 | 114 | 106 | 390 |
| 2 | 65 | 59 | 310 | 13.2 | 102 | 97 | 365 |
| 3 | 62 | 85 | 300 | 8.3 | 125 | 131 | 450 |
| 4 | 55 | 87 | 290 | 7.1 | 133 | 128 | 510 |
| 5 | 61 | 76 | 260 | 8 | 127 | 130 | 480 |
| 6 | 59 | 65 | 210 | 6.5 | 123 | 138 | 630 |
| 7 | 57 | 84 | 205 | 5.9 | 114 | 126 | 490 |
| 8 | 53 | 65 | 195 | 5.5 | 135 | 129 | 530 |
| 9 | 62 | 61 | 270 | 6.7 | 122 | 135 | 570 |
| 10 | 55 | 67 | 290 | 5.3 | 107 | 111 | 610 |
| 11 | 61 | 61 | 310 | 5.1 | 144 | 137 | 650 |
| 12 | 56 | 68 | 330 | 6.5 | 95 | 101 | 350 |

### Examples 13-24

TABLE 4 shows the layer structure, composition and thickness of EXs 13-24. All the films had multiple layers with a total thickness of 7 to 20 μm. The EX 13 film was a dry 3-layer film of unfilled PO (U-PO), consisting of a PP/HDPE blend core coextruded with two β-PP skins. The EX 14 film was a 3-layer film of filled PO (F-PO) having two wet skins of 30 wt. % Al₂O₃. EXs 15 and 16 were a 2-layer film, consisting of the EX 8 film coated (C) or laminated (L) on one side. The wet coating contained 50 wt. % solids dispersed finely in water, comprising p-m-HDPE and Al₂O₃ both having an average particle size of 0.5 and 0.8 μm, respectively. The coating was applied with a gravure coater, and dried at 100° C. in a hot air oven. EX 17 was a 3-layer laminate, EXs 18 to 23 a coextruded 3-layer film, and EX 24 a 5-layer film having two maleated tie layers respectively to bond adjacent core-skin layers together. The porogens included metal oxides, zeolites, nanomaterials, immiscible polymers, and diluents.

TABLE 5 shows the properties of the EXs 13-24 films. No films were found delaminating or curling during manufacture or converting. The EXs 13-14 films had well balanced properties, i.e., a suitable pore structure producing high S_{T}, S_{P} and low N_{M}. Overall, all the Example films had excellent properties, i.e., high conductivity and high strengths.

TABLE 4

| | Composition | | | | Gage |
|---|---|---|---|---|---|
| EX | Layer | Matrix (M) | Porogen (P) | M/P (wt %) | (μm) |
| 13 | B | β-PP | Al₂O₃ | 85/15 | 12 |
| | A | PP | HDPE/Al₂O₃ | 50/35/15 | |
| | B | β-PP | Al₂O₃ | 85/15 | |
| 14 | B | HDPE/UPE | Al₂O₃/LP | 10/10/30/50 | 12 |
| | A | PP | HDPE/Al₂O₃ | 50/35/15 | |
| | B | HDPE/UPE | Al₂O₃/LP | 10/10/30/50 | |
| 15 | B | HDPE | Al₂O₃ | 85/15 | 7 |
| | A | EX 8 | / | / | |
| 16 | B | EX 1 | / | / | 12 |
| | A | EX 8 | | | |
| 17 | B | EX 13 | / | / | 20 |
| | A | EX 11 | | | |
| | B | EX 13 | | | |
| 18 | B | PET | PEBE/ZSM5 | 60/10/30 | 12 |
| | A | β-m-PP | ZSM5 | 80/20 | |
| | B | PET | PEBE/ZSM5 | 60/10/30 | |
| 19 | B | PEEK | PEBE/LCP | 70/10/20 | 12 |
| | A | PCT | | | |
| | B | PEEK | | | |
| 20 | B | m-PP | VTO/SiO₂ | 30/60/10 | 12 |
| | A | PBT | | | |
| | B | m-PP | | | |
| 21 | B | PEEK | PCL/Al₂O₃ | 35/55/10 | 12 |
| | A | PET | | | |
| | B | PEEK | | | |
| 22 | B | PK | VTO | 40/60 | 12 |
| | A | β-PP | SiO₂ | 80/20 | |
| | B | PK | VTO | 40/60 | |
| 23 | B | PEI | DBP/SiO₂ | 35/55/10 | 10 |
| | A | PET | LCP/SiO₂ | 65/15/20 | |
| | B | PEI | DBP/SiO₂ | 35/55/10 | |
| 24 | B | PVDF | DBP | 30/70 | 12 |
| | C | m-PVDF | PABE/CNF | 60/10/30 | |
| | A | PA66 | PABE/CNF | | |
| | C | m-PVDF | PABE/CNF | | |
| | B | PVDF | DBP | 30/70 | |

TABLE 5

| | φ | d_{A} | N_{G} | | S_{T} (MPa) | | S_{P} |
|---|---|---|---|---|---|---|---|
| EX | (%) | (nm) | (sec) | N_{M} | MD | TD | (gf) |
| 13 | 55 | 56 | 290 | 6.5 | 106 | 113 | 410 |
| 14 | 63 | 71 | 240 | 5.5 | 115 | 107 | 360 |
| 15 | 54 | 63 | 195 | 5.2 | 135 | 129 | 530 |
| 16 | 52 | 61 | 320 | 4.5 | 125 | 123 | 570 |
| 17 | 49 | 59 | 330 | 5.2 | 128 | 134 | 620 |
| 18 | 59 | 75 | 196 | 4.2 | 125 | 128 | 560 |
| 19 | 54 | 97 | 191 | 5.5 | 136 | 131 | 610 |
| 20 | 61 | 55 | 251 | 3.9 | 115 | 111 | 570 |
| 21 | 57 | 73 | 203 | 2.5 | 121 | 130 | 590 |
| 22 | 52 | 77 | 198 | 4.2 | 114 | 121 | 530 |
| 23 | 49 | 69 | 258 | 2.6 | 127 | 119 | 550 |
| 24 | 53 | 92 | 201 | 3.1 | 119 | 113 | 510 |

FIG. 4 shows the meltdown temperature (Tmd) and shutdown temperature (Tsd) of the coextruded (Coex), coated (C) and laminated (L) Example films as a function of the higher Tm (Tm,h) of their matrix polymers. In general, the Tmd was found higher by up to 30° C. than the Tm,h, depending mainly on the levels of crystallization, orientation and/or solid particulates present in the porous film. The coextruded Example films had a very high Tmd, registering above 250 and 350° C. respectively for the polyester and PEEK matrices. These were significantly higher than the Tmd of 200° C. or less for any of existing PO-based monolayer, coextruded or coated separator films. The Tsd, on the other hand, was much lower for PO-based or PO-layered Example films, registering below their Tm's of 135 or 165° C. In particular, the Example films made out of a single matrix polymer were ruptured around their Tm without revealing a discernable Tsd.

When a high Tm polymer was coextruded with a low Tm polymer, the multilayer films were unstable disrupting often the extrusion and orientation processes. Also, the A/B/A layer structure was found more resistant than the B/A/B layer structure to high temperatures and solvents under an electrochemical environment. All the Example films were found dissolved little or none in electrolyte, except for a minor change in the PA-based films, when measured a weight change after immersing the film samples for 30 days in an electrolyte at 50° C. The electrolyte used was a 1/1/1 mixture by weight of ethylene carbonate/dimethyl carbonate/ethyl methyl carbonate.

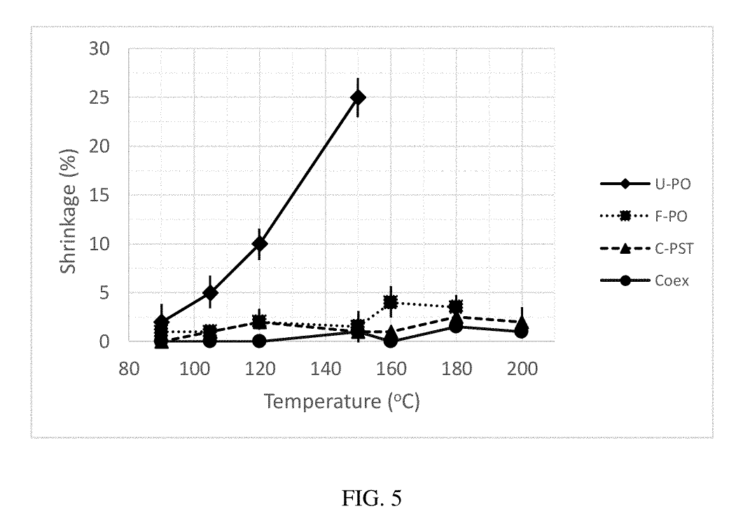

FIG. 5 shows the shrinkage ratio (%) in the MD and TD of the Example films as a function of aging temperatures from 90 to 200° C. The differences between the MD and TD shrinkage ratios were found minor. As seen, the results were generally consistent with the Tmd trend of FIG. 4. The unfilled PO film (U-PO) shrank to a relatively high degree at temperatures above 120° C. The other films all had substantially low shrinkage ratios, i.e., filled PO films (F-PO), coated polyester films (C-PST) and coextruded high Tm films (Coex), recording below 5% at temperatures up to 180° C. The C-PST and Coex films shrank little even at 200° C. or up to around their Tm.

All documents described herein are incorporated by reference, including any priority documents and/or testing procedures. While various specific embodiments have been illustrated and described, various modifications can be made without departing from the spirit and scope of the disclosure. Accordingly, it is not intended that the disclosure be limited thereby.

What is claimed is:

1. An oriented multilayer porous film comprising at least one layer comprising a first polymer, a plurality of interconnecting pores, and a porosity less than 90%,
wherein each layer of the oriented multilayer porous film comprises 5 to 100 wt. % of a matrix polymer comprising: a) the first polymer or b) a second polymer having a crystalline melting temperature (Tm) or a glass transition temperature (Tg) less than 180° C.; the matrix polymer being selected from the group consisting of a petroleum-based polymer, a biopolymer and combinations thereof; and
wherein the first polymer comprises a heat resistant polymer having a Tm or Tg greater than 180° C. or a polypropylene comprising a β-crystal nucleating agent (β-PP).

2. The film of claim 1, wherein the matrix polymer has a molecular weight characterized by: a) a weight average molecular weight (Mw) of 5,000 to 50,000,000 g/mole and b) a unimodal or multimodal molecular weight distribution comprising at least one of: i) an ultrahigh molecular weight component of 0 to 70 wt. % having an Mw greater than 1,000,000 g/mole; ii) a high molecular weight component of 30 to 100 wt. % having an Mw of 10,000 to 1,000,000 g/mole; or iii) a low molecular weight component of 0 to 70 wt. % having an Mw less than 10,000 g/mole.

3. The film of claim 1, wherein the first polymer is the heat resistant polymer selected from the group consisting of:
a) polyester comprising polyethylene terephthalate (PET), polytrimethylene terephthalate (PTT), polybutylene terephthalate (PBT), polyethylene naphthalate (PEN), polytrimethylene naphthalate (PTN), polybutylene naphthalate (PBN), polyethylene furanoate (PEF) polytrimethylene furanoate (PTF), polybutylene furanoate (PB F), polycyclohexylenedimethylene terephthalate (PCT), liquid crystalline polymers (LCP), polycarbonate (PC), or combinations thereof;
b) polyketone (PK);
c) polyaryletherketone (PAEK) comprising polyether ether ether ketone (PEEEK), polyether ether ketone (PEEK), polyether ketone (PEK), polyether ether ketone ether ketone (PEEKEK), polyether ether ketone ketone (PEEKK), polyether ketone ketone (PEKK), polyether ketone ether ketone ketone (PEKEKK), or combinations thereof;
d) polyimide (PI)-type polymers comprising polyimide (PI), polyetherimide (PEI), polyamide imide (PAI), polybenzimidazole (PBI), or combinations thereof;
e) fluoropolymers comprising polychlorotrifluoroethylene (PCTFE), polyethylenechlorotrifluoroethylene (ECTFE), copolymers of tetrafluoroethylene and ethylene (ETFE), perfluorinated ethylene-propylene copolymer (FEP), tetrafluoroethylene-perfluorovinyl ether copolymer (PFA), polytetrafluoroethylene (PTFE), or combinations thereof;
f) polyamide (PA) comprising PA6, PA11, PA46, PA66, PA410, PA610, PA612, PA1010, PA1012, PA MXD6, PA6T, PAST, PA10T, PA6T/DT (D: 2-methyl pentamethylene diamine), polyphthalamide (PPA), or combinations thereof; and
g) ionomers thereof, copolymers thereof, and derivatives thereof.

4. The film of claim 1, wherein the first polymer is the polypropylene (β-PP) comprising the β-nucleating agent (β-NA) less than 3 wt. %.

5. The film of claim 1, wherein the second polymer comprises polyolefin (PO), polyacrylates (PAc), polyvinylidene fluoride (PVDF), copolymers thereof, or derivatives thereof.

6. The film of claim 1, wherein the first polymer and/or the second polymer are the biopolymer.

7. The film of claim 1, wherein at least one of the outer surfaces of the film has an average pore size characterized by a size ratio of 0.001 to 1,000 relative to an average pore size of an inner layer of the film.

8. The film of claim 1, wherein one or more layers of the film are uniaxially or biaxially oriented.

9. The film of claim 1, wherein the each layer of the film further comprises a porogent material of 0 to 95 wt. %, a compatibilizer of 0 to 95 wt. %, and an additive of 0 to 20 wt. %,
wherein the porogent material comprises a sorbent material, a solid-state ionically conductive material, a polymer immiscible with the matrix polymer, a nucleating agent (NA), a diluent material, or combinations thereof;
wherein the compatibilizer comprises functional polymers, functionalized polymers, copolymers, nanoparticles, or combinations thereof; and
wherein the additive comprises antioxidants, stabilizers, flame retardants, surfactants, viscosity modifiers, dispersing agents, solubility promoters, heat or current conductors, catalysts, crosslinking agents, anti-fouling agents, moisture barriers, pigments, or combinations thereof.

10. The film of claim 9, wherein:
a) the sorbent material is selected from the group consisting of inorganic carbonates, inorganic sulfates, metal oxides, siliceous and carbonaceous materials, zeolites, celluloses, inorganic-organic hybrids, metal-organic frameworks (MOF), porous and sorbent polymers, and combinations thereof;
b) the solid-state ionically conductive material is selected from the group consisting of lithium and sodium superionic conductors, argyrodites, garnets, perovskites, lithium salts, polymer electrolytes, and combinations thereof;
c) the immiscible polymer has a melt viscosity characterized by a viscosity ratio of 0.0001 to 10,000 relative to a melt viscosity of the matrix polymer with which it is mixed;
d) the nucleating agent (NA) is selected from the group consisting of glasses, micas, talcs, kaolinites, wollastonites, clays, amides, imides, esters of a diol, pigments, waxes, nanocrystalline celluloses, alkali and alkaline earth metal salts of monocarboxylates or polycarboxylates, rapidly crystallizing polymers, and combinations thereof; and
e) the diluent material is selected from the group consisting of hydrocarbons, mineral oils, liquid paraffin, renewable oils, genetically modified soybean oils, genetically modified renewable oils, esters, ethers, amides, sulfones, alcohols, ketones, aldehydes, oligomers of the matrix polymers, derivatives thereof, and combinations thereof.

11. The film of claim 9, wherein:
a) the functional polymers comprise polyethers, polycaprolactones (PCL), or PI-type polymers;
b) the copolymers comprise copolyolefins, olefin block copolymers (OBC), styrenic block copolymers (SBC), copolyesters, copolyamides, or thermoplastic elastomers (TPE);
c) the functionalized polymers comprise polar modified PO (p-m-PO), maleic anhydride grafted PO (MAH-g-PO), p-m-OBCs, MAH-g-OBCs, p-m-SBCs, MAH-g-SBCs, polar modified fluoropolymers, MAH-g-fluoropolymers, or combinations thereof; and
d) the nanoparticles are selected from the group consisting of the porogent material, Janus particles, and combinations thereof.

12. The film of claim 9, wherein the porogent material and the compatibilizer are inorganic and/or organic solid particles, the solid particles having an average particle size of 1 nm to 1 μm, an average aspect ratio of length to thickness of 0.01 to 2,000, an average pore volume less than 6.0 cc/g, a Brunauer-Emmett-Teller surface area of 0.1 to 5,000 m²/g, or combinations thereof.

13. The film of claim 9, wherein one or more layers of the film comprise the porogent material other than the immiscible polymer.

14. The film of claim 9, wherein one or more layers of the film comprise the immiscible polymer as the porogent material.

15. The film of claim 14, wherein the immiscible polymer is selected in combination with the matrix polymer and the compatibilizer,
wherein: a) the immiscible polymer comprises polypropylene (PP), cyclic olefin copolymer (COC), polymethylpentene (PMP), syndiotactic polystyrene (sPS), PK, polyester, PA, polyphenylene sulfide (PPS), PAEK, or combinations thereof; b) the matrix polymer comprises polyester, PK or PA; and c) the compatibilizer comprises the copolymers, the functionalized polymers, the solid particles, poly(ester-b-ether) (PEBE), poly(amide-b-ether) (PABE), PI-type polymers, or combinations thereof;
wherein: a) the immiscible polymer comprises COC, PCT, LCP, PPA, PPS, or combinations thereof; b) the matrix polymer comprises PAEK or PI-type polymers; and c) the compatibilizer comprises the copolymers, the functionalized polymers, the solid particles, PI-type polymers, or combinations thereof; or
wherein: a) the immiscible polymer comprises PP, COC, PMP, sPS, PK, polyoxymethylene (POM), polyester, PA, or combinations thereof; b) the matrix polymer comprises fluoropolymers or PO; and c) the compatibilizer comprises the copolymers, the functionalized polymers, the solid particles, or combinations thereof.

16. The film of claim 9, consisting essentially of:
a) one layer consisting of the at least one layer;
b) two layers consisting of a first layer and a second layer disposed on a side of the first layer, wherein each layer has a thickness of 1 to 99% based on the total film thickness;
c) three layers consisting of the first layer, the second layer, and a third layer disposed on a side of the first layer opposite the second layer; wherein each layer has a thickness of 1 to 98% based on the total film thickness;
d) four layers consisting of the first layer, the second layer, the third layer, and a fourth layer disposed between the first layer and the second layer; wherein each layer has a thickness of 1 to 97% based on the total film thickness; or
e) five layers consisting of the first layer, the second layer, the third layer, the fourth layer and a fifth layer disposed between the first layer and the third layer; wherein each layer has a thickness of 1 to 96% based on the total film thickness.

17. The film of claim 16, having: a thickness of 3 to 30 μm, a porosity of 20 to 90%, an average pore size of 1 nm to 1 μm, a Gurley air permeability of 10 to 1,000 sec/100 cc, a MacMullin number of 1 to 15, a meltdown temperature greater than 180° C., a shutdown temperature less than 180° C., a tensile strength greater than 50 MPa in the machine direction and/or the transverse direction, a puncture strength greater than 200 gf, or combinations thereof.

18. The film of claim 17, wherein the film is: a) a monolayer film consisting essentially of the at least one layer (A), b) a two-layer film comprising a second layer (B) and a layer structure of B/A, c) a three-layer film comprising two outer layers of the same composition (B) and a layer structure of B/A/B or A/B/A, d) a four-layer film comprising a fourth layer (C) and a layer structure of B/C/A/B or A/C/B/A, or e) a five-layer film comprising a layer structure of B/C/A/C/B or A/C/B/C/A; wherein the A and B layers differ from each other in matrix polymer or composition.

19. The film of claim 18, wherein the film is the monolayer film comprising the matrix polymer selected from the group consisting of polyester, polyketone (PK), polyaryletherketone (PAEK), polyimide (PI)-type polymers, fluoropolymers, polyarylene sulfide (PAS), polyarylsulfone, vinyl polymers, cellulose esters, polyamide (PA), the polypropylene (β-PP) comprising the β-crystal nucleating agent (β-NA), ionomers thereof, copolymers thereof, derivatives thereof, and combinations thereof.

20. The film of claim 19, wherein the polyester comprises polyethylene terephthalate (PET), polybutylene terephthalate (PBT), polytrimethylene terephthalate (PTT), polyethylene naphthalate (PEN), polybutylene naphthalate (PBN), polyethylene furanoate (PEE) polycyclohexylenedimethylene terephthalate (PCT), polycarbonate (PC), or combinations thereof.

21. The film of claim 18, wherein: a) the matrix polymer of the A layer is polyester; and b) the matrix polymer of the B layer is PK, PAEK, PI-type polymers, fluoropolymers, PAS, PA, polyolefin (PO), derivatives thereof, or copolymers thereof.

22. The film of claim 21, wherein: a) the polyester is PET, PBT, PTT, PEF, PBN, PC, or combinations thereof; and b) the matrix polymer of the B layer is the PK.

23. The film of claim 21, wherein: a) the polyester is PET, PEN, PBN, PCT, PC, or combinations thereof; and b) the matrix polymer of the B layer is the PAEK comprising polyether ether ketone (PEEK), the PI-type polymers comprising polyetherimide (PEI), or combinations thereof.

24. The film of claim 21, wherein: a) the polyester is PET, PBT, PTT, PEF, PBN, PC, or combinations thereof; and b) the matrix polymer of the B layer is the PO comprising polypropylene (PP) comprising: isotactic PP (iPP), high crystalline PP (HCPP), high melt strength PP (HMS-PP), ultrahigh molecular weight PP (UHMWPP), the β-PP, or combinations thereof.

25. The film of claim 18, wherein the matrix polymers of the A and B layers are polyester.

26. The film of claim 25, wherein: a) the polyester of the A layer matrix polymer is PET, PEN, PEF, or combinations thereof; and b) the polyester of the B layer matrix polymer is PTT, PBT, PBN, PCT, PC, polylactic acid (PLA), or combinations thereof.

27. The film of claim 25, wherein the polyester has a molecular weight characterized by: a) an intrinsic viscosity (IV) of 0.1 to 5 dl/g and b) a unimodal or multimodal molecular weight distribution comprising at least one of: i) an ultrahigh IV component of 0 to 70 wt. % having an IV greater than 1.5 dl/g; ii) a high IV component of 30 to 100 wt. % having an IV of 0.5 to 1.5 dl/g; or iii) a low IV component of 0 to 70 wt. % having an IV less than 0.5 dl/g.

28. The film of claim 18, wherein: a) the matrix polymer of the A layer is PK; and b) the matrix polymer of the B layer is PAEK, PI-type polymers, PA, PO, derivatives thereof, or copolymers thereof.

29. The film of claim 28, wherein the matrix polymer of the B layer is the PO.

30. The film of claim 28, wherein the matrix polymer of the B layer is the PAEK comprising PEEK, the PI-type polymers comprising PEI, or combinations thereof.

31. The film of claim 18, wherein: a) the matrix polymer of the A layer is PAEK; and b) the matrix polymer of the B layer is PI-type polymers, PA, PO, derivatives thereof, or copolymers thereof.

32. The film of claim 31, wherein: a) the PAEK is PEEK; and b) the matrix polymer of the B layer is the PI-type polymers comprising PEI.

33. The film of claim 18, wherein: a) the matrix polymer of the A layer is fluoropolymers; and b) the matrix polymer of the B layer is PK, PA, PO, derivatives thereof, or copolymers thereof.

34. The film of claim 18, wherein: a) the matrix polymer of the A layer is PA; and b) the matrix polymer of the B layer is PO, derivatives thereof, or copolymers thereof.

35. The film of claim 34, wherein the PA is PA6, PA11, PA46, PA66, PA410, PA610, PA612, PA1010, PA1012, PA MXD6, PA9T, PPA, or combinations thereof.

36. The film of claim 18, wherein the matrix polymers of the A and B layers are PA.

37. The film of claim 36, wherein: a) the PA of the A layer matrix polymer is PA6T, PA9T, PA10T, PPA, PA6T/DT, or combinations thereof; and b) the PA of the B layer matrix polymer is PA6, PA11, PA12, PA46, PA66, PA410, PA610, PA612, PA1010, PA1012, PA MXD6, or combinations thereof.

38. The film of claim 18, wherein: a) the matrix polymer of the A layer is the β-PP; and b) the matrix polymer of the B layer is PO comprising polyethylene (PE), ultrahigh molecular weight PE (UHMWPE), PP, UHMWPP, the β-PP, copolymers thereof, derivatives thereof, or combinations thereof.

39. The film of claim 18, wherein at least one of the matrix polymers is the biopolymer comprising PO, polyester, PA, PK, PAEK, PI-type polymers, derivatives thereof, or copolymers thereof.

40. The film of claim 39, wherein the biopolymer is the PO comprising PE, UHMWPE, PP, UHMWPP, the β-PP, copolymers thereof, derivatives thereof, or combinations thereof.

41. The film of claim 18, wherein one or more layers of the film comprise the compatibilizer.

42. The film of claim 18, wherein at least one of the outer layers of the film comprises the solid particles less than 95 wt. %.

43. The film of claim 42, wherein the solid particles comprise MgO, ZnO, SiO₂, SiOx (1≦x≦3), TiO₂, ZrO₂, CaCO₃, BaTiO₃, Al₂O₃, AlOx (1≦x≦3), B₂O₃, BaSO₄, Nb₂O₅, Ta₂O₅, silicates, zeolites, graphenes, organic-inorganic hybrids, MOF, lithium superionic conductors, argyrodites, perovskites, derivatives thereof, or combinations thereof.

44. The film of claim 18, further comprising a porous layer of a coating and/or a laminate disposed on at least one of the outer surfaces of the film,
wherein the porous layer has a thickness less than 50% of the total film thickness; and
comprises a binder polymer and less than 99 wt. % of the solid particles; and
wherein the binder polymer is polyolefin (PO), polar modified PO (p-m-PO), olefin block copolymers (OBCs), p-m-OBCs, polyvinyl alcohol (PVOH), polyacrylate (PAc), polyacrylonitrile (PAN), polyvinylidene fluoride (PVDF), celluloses, porous polymers, derivatives thereof, ionomers thereof, or copolymers thereof.

45. An electrolyte battery, comprising the film of claim 18 as a separator.

46. An electrolyte battery, comprising the film of claim 9 as a separator.

47. An article, battery, capacitor, supercapacitor, fuel cell, or energy storage device comprising the film of claim 1 as a separator.
